(19) United States
(12) Patent Application Publication
(10) Pub. No.: US 2024/0241020 A1
(43) Pub. Date: Jul. 18, 2024

(54) PROCESS FOR PREPARING EXTRACELLULAR VESICLES

(71) Applicant: Lonza Sales AG, Basel (CH)

(72) Inventors: Andrew WOOD, Concord, MA (US); Michael DOHERTY, Somerville, MA (US); Aaron NOYES, Melrose, MA (US)

(73) Assignee: Lonza Sales AG, BASEL (CH)

(21) Appl. No.: 18/246,301

(22) PCT Filed: Sep. 23, 2021
(86) PCT No.: PCT/US2021/051777

§ 371 Date: Mar. 22, 2023

Related U.S. Application Data
(60) Provisional application No. 63/083,034, filed on Sep. 24, 2020.
(60) Provisional application No. 63/082,434, filed on Sep. 23, 2020.

(51) Int. Cl. G01N 1/34; B01D 15/12; B01D 15/18; B01D 15/36; B01D 15/38; B01D 15/42

(52) U.S. Cl. CPC G01N 1/34; B01D 15/125; B01D 15/1864; B01D 15/363; B01D 15/3847; B01D 15/424

(57) ABSTRACT

The present disclosure relates to methods for preparing extracellular vesicles (EVs). In particular, the methods provided herein comprise contacting a sample, which comprises EVs and one or more impurities, with a depth filter, wherein the depth filter is selected from a LA media grade depth filter, a SP media grade depth filter, or both. In some aspects, the methods further comprise one or more chromatography steps. The methods enable preparation of EVs for therapeutic and diagnostic applications, and isolation and/or sub-fractionation of EVs with desired properties for specific use.

### CROSS-REFERENCE TO RELATED APPLICATION

This PCT application claims the priority benefit of U.S. Provisional Application No. 63/082,434, filed on Sep. 23, 2020; and U.S. Provisional Application No. 63/083,034, filed on Sep. 24, 2020; each of which is herein incorporated by reference in its entirety.

### REFERENCE TO SEQUENCE LISTING SUBMITTED ELECTRONICALLY VIA EFS-WEB

The content of the electronically submitted sequence listing (Name: 0132-0295US1_Seqlisting_ST25.txt, Size: 393,656 bytes; and Date of Creation: Dec. 13, 2023) submitted in this application is incorporated herein by reference in its entirety.

### FIELD OF DISCLOSURE

The present disclosure provides methods for preparing purified extracellular vesicles (EVs). In some aspects, the methods provided herein comprise a depth filter-based clarification step using LA (low aluminum and contains diatomaceous earth) and/or SP (contains diatomaceous earth and perlite inorganic filter aid) media grade depth filters. In some aspects, the depth filter-based clarification step can be performed at any time during the purification process, e.g., prior to chromatography. The methods provided herein are effective in preparing high-quality EVs on a large scale.

### BACKGROUND OF DISCLOSURE

Extracellular vesicles (EVs) are important mediators of intercellular communication. They are also important biomarkers in the diagnosis of many diseases, such as cancer. As drug delivery vehicles, EVs offer many advantages over traditional drug delivery methods, especially for gene therapy. The use of EVs for therapeutic purposes requires that EVs be free or mostly free of impurities including, but not limited to, undesirable host cell proteins, DNA, carbohydrates, and lipids. Current purification methods do not offer sufficient selectivity to remove significant amounts of these impurities so additional processes are desired to improve purity.

Furthermore, synthetic nano- and/or micro-carriers such as EVs often struggle to meet clinical expectations because of heterogeneity in their physicochemical parameters that confer targeting efficiency, immune evasion, and controlled drug release. This is mainly due to the complexity of nanoparticle properties (composition, size, shape, rigidity, surface charge, hydrophilicity, stability, and ligand type and density), payload properties (drug type, solubility, loading, potency, dosing, immune response, and release kinetics), and in vivo physiological barriers to nanoparticle trafficking (immune surveillance, particle extravasation, tissue targeting, tissue penetration, and cellular uptake). Although a considerable amount of effort has been made, effective methods for isolating discrete sub-populations of EVs (especially at scale) are not yet readily available.

In addition, therapeutic use of EVs requires larger-scale production and preparation of EVs. The heterogeneity and complexity of EVs make it difficult and costly to provide EVs in a large amount, while ensuring their quality. Inherent variability of the production and preparation process make it both expensive and unpredictable.

Therefore, effective and efficient methods for large-scale production, isolation and/or sub-fractionation of EVs are needed to enable use of EVs for therapeutic purposes.

### SUMMARY OF DISCLOSURE

Certain aspects of the present disclosure are directed to a method of preparing purified extracellular vesicles (EVs) from a sample, which comprises EVs and one or more impurities, comprising (i) contacting the sample with a depth filter selected from a low aluminum (LA) media grade depth filter, a SP media grade depth filter, or both; and (ii) collecting the filtrate.

Certain aspects of the present disclosure are directed to a method of reducing one or more impurities of an extracellular vesicle (EV) preparation obtained with chromatography, comprising (i) contacting a sample, which comprises EVs and one or more impurities, with a depth filter selected from a low aluminum (LA) media grade depth filter, a SP media grade depth filter, or both; and (ii) collecting the filtrate prior to the chromatography.

In some aspects, the one or more impurities of the EV preparation is decreased compared to one or more impurities of a reference EV preparation, wherein the reference EV preparation was obtained from a corresponding sample that was not contacted with the 60LA depth filter prior to the chromatography. In some aspects, the one or more impurities of the EV preparation is decreased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the reference EV preparation.

Certain aspects of the present disclosure are directed to a method of increasing a dynamic binding capacity of a chromatography resin for purifying extracellular vesicles (EVs) from a sample, which comprises the EVs and one or more impurities, comprising (i) contacting the sample with a depth filter selected from a low aluminum (LA) media grade depth filter, a SP media grade depth filter, or both; and (ii) collecting the filtrate, wherein contacting the sample with the depth filter allows for greater binding of EVs present in the filtrate to the chromatography resin when the filtrate is subsequently contacted with the chromatography resin.

In some aspects, the dynamic binding capacity of the chromatography resin is increased compared to a reference dynamic binding capacity (e.g., dynamic binding capacity of a chromatography resin that is contacted with a corresponding sample that has not been contacted with the depth filter).

In some aspects, the dynamic binding capacity is increased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the reference dynamic binding capacity.

In some aspects, the above methods comprise subjecting the sample (comprising the EV and one or more impurities) to a pre-treatment prior to contacting the sample with the depth filter, wherein the pre-treatment is capable of increasing the filterability of the sample. In some aspects, the pre-treatment comprises an agent selected from an acid (e.g., acetic, acid, citric acid, carboxylic acid, sialic acid, polyaspartic acid, polyglutamic acid), a salt (e.g., [NH₄]₂SO₄, K₂SO₄, or KH₂PO₄), a cationic polymer (e.g., chitosan, pDADMAC, or PEI), an ethylene glycol, a propylene glycol, a polyethylene glycol, a polypropylene glycol, an urea, an arginine-HCL, a lysine, a glycine, a histidine, a calcium, a sodium, a lithium, a potassium, an iodide, a magnesium, an iron, a zinc, a manganese, an aluminum, an ammonium, guanidium polyethylene glycol, a protease inhibitor (e.g., EDTA or EGTA), an anti-oxidant (e.g., cysteine or N-acetyl cysteine), a detergent, a chloride, a sulfate, a phosphate, an acetate, a borate, a formate, a perchlorate, a bromine, a nitrate, a dithiothreitol, a beta mercaptoethanol, a tri-n-butyl phosphate, a polyanion, a polyarginine, a polylysine, a polyhistidine, or a combination thereof.

In some aspects, the depth filter has a pore size of less than about 2 μm, less than about 1.9 μm, less than about 1.8 μm, less than about 1.7 μm, less than about 1.6 μm, less than about 1.5 μm, less than about 1.4 μm, less than about 1.3 μm, less than about 1.2 μm, less than about 1.1 μm, less than about 1 μm, less than about 0.9 μm, less than about 0.8 μm, less than about 0.7 μm, less than about 0.6 μm, less than about 0.5 μm, less than about 0.4 μm, less than about 0.3 μm, less than about 0.2 μm, less than about 0.1 μm, or less than about 0.05 μm.

In some aspects, the filtrate comprises at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the EVs present in the sample prior to the contacting.

In some aspects, a turbidity of the filtrate is reduced by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to a reference filtrate (e.g., filtrated collected from a corresponding sample that was not contacted with the 60LA depth filter). In some aspects, the amount of the one or more impurities present in the filtrate is reduced by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the amount of the one or more impurities present in the sample prior to the contacting with the depth filter.

In some aspects, the one or more impurities comprise a nucleic acid molecule, a protein, or both, and wherein the nucleic acid molecule and the protein are not associated with the EVs. In some aspects, the one or more impurities comprise residual host-cell proteins, host-cell nucleotides, or both. In some aspects, the one or more impurities comprise a histone aggregate, a scaffold moiety aggregate, a beta-actin binding protein, or any combination thereof.

In some aspects, the method further comprises (iii) contacting the filtrate with a chromatography resin, wherein the contacting results in one or more EVs of the filtrate to attach to the chromatography resin. In some aspects, the chromatography resin comprises a cation exchange (CEX) chromatography resin, an anion exchange (AEX) chromatography resin, a mixed mode chromatography (MMC) resin, an affinity chromatography resin, a pseudo affinity chromatography resin, a hydrophobic interaction resin, a ceramic hydroxyapatite resin, a fluoro hydroxyapatite resin, or any combination thereof. In some aspects, the chromatography resin comprises a CEX chromatography resin, an AEX chromatography resin, a MMC chromatography resin, or a combination thereof.

In some aspects, the filtrate is contacted with the chromatography resin in a loading buffer, which comprises a salt. In some aspects, the salt of the loading buffer comprises NaCl, KCl, PO₄, CaCl₂, MgCl₂, Mg2SO4, ZnCl2, MnCl2, MnSO4, NaSCN, KSCN, LiCl, NaPO4, K2HPO4, Na2SO4, K2SO4, NaAcetate, sodium bromide, lithium chloride, sodium iodide, potassium bromide, lithium bromide, sodium fluoride, potassium fluoride, lithium fluoride, lithium iodide, sodium acetate, potassium acetate, lithium acetate, potassium iodide, calcium sulfate, sodium sulfate, chromium trichloride, chromium sulfate, sodium citrate, iron (III) chloride, yttrium (III) chloride, potassium phosphate, potassium sulfate, sodium phosphate, ferrous chloride, calcium citrate, magnesium phosphate, ferric chloride, arginine-HCl, or any combination thereof.

In some aspects, the method further comprises (iv) contacting the chromatography resin with a wash buffer, wherein (iv) occurs after (iii) (i.e., contacting the filtrate with the chromatography resin). In some aspects, the wash buffer comprises a nuclease. In some aspects, the wash buffer does not comprise a nuclease. In some aspects, the nuclease comprises an endonuclease, exonuclease, or both. In some aspects, the nuclease comprises a salt active nuclease (SAN), Benzonase, Denarase, Kryptonase, or any combination thereof. In some aspects, the nuclease is SAN.

In some aspects, the wash buffer further comprises a cation. In some aspects, the cation comprises a monovalent cation, a divalent cation, or both. In some aspects, the wash buffer further comprises an anion.

In some aspects, the wash buffer further comprises an excipient. In some aspects, the excipient is selected from an acid (e.g., acetic, acid, citric acid, carboxylic acid, sialic acid, polyaspartic acid, polyglutamic acid), a salt (e.g., [NH₄]₂SO₄, K₂SO₄, or KH₂PO₄), a cationic polymer (e.g., chitosan, pDADMAC, or PEI), an ethylene glycol, a propylene glycol, a polyethylene glycol, a polypropylene glycol, an urea, an arginine-HCL, a lysine, a glycine, a histidine, a calcium, a sodium, a lithium, a potassium, an iodide, a magnesium, an iron, a zinc, a manganese, an aluminum, an ammonium, guanidium polyethylene glycol, a protease inhibitor (e.g., EDTA or EGTA), an anti-oxidant (e.g., cysteine or N-acetyl cysteine), a detergent, a chloride, a sulfate, a phosphate, an acetate, a borate, a formate, a perchlorate, a bromine, a nitrate, a dithiothreitol, a beta mercaptoethanol, a tri-n-butyl phosphate, a polyanion, a polyarginine, a polylysine, a polyhistidine, or a combination thereof.

In some aspects, the chromatography resin is contacted with the wash buffer at least 2 times, at least 3 times, at least 4 times, or at least 5 times. In some aspects, one or more of the wash buffers do not comprise a nuclease.

In some aspects, the method further comprises (v) contacting the chromatography resin with an elution buffer, wherein (v) occurs after (iv) (i.e., contacting the chromatography resin with a wash buffer). In some aspects, the contacting of the chromatography resin with the elution buffer releases one or more of the attached EVs from the chromatography resin. In some aspects, the method further comprises (vi) collecting an eluent after (v) (i.e., contacting the chromatography resin with the elution buffer). In some aspects, the eluent comprises EVs.

In some aspects, a concentration of the EVs present in the eluent is increased compared to a reference concentration (e.g., concentration of the EVs present in an eluent from a corresponding chromatography but where the sample was not contacted with the depth filter prior to the chromatography). In some aspects, the concentration of the EVs present in the eluent is increased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the reference concentration.

In some aspects, an amount of one or more impurities present in the eluent is decreased compared to a reference amount (e.g., amount of the one or more impurities present in an eluent from a corresponding chromatography but where the sample was not contacted with the depth filter prior to the chromatography). In some aspects, the amount of the one or more impurities present in the eluent is decreased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the reference amount.

In some aspects, a mean particle size of the eluent is reduced compared to a reference mean particle size (e.g., mean particle size of an eluent from a corresponding chromatography step but where the sample was not contacted with the depth filter prior to the chromatography step). In some aspects, the mean particle size of the eluent is reduced by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the reference mean particle size. In some aspects, the mean particle size of the eluent is between about 20 nm to about 300 nm. In some aspects, the mean particle size of the eluent is about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, or about 300 nm.

In some aspects, a polydispersity index of the eluent is reduced compared to a reference polydispersity index (e.g., polydispersity index of an eluent from a corresponding chromatography but where the sample was not contacted with the depth filter prior to the chromatography). In some aspects, the polydispersity index of the eluent is reduced by at least about 10%, at least about 20%, at least about 30%, at least about 40%, at least about 50%, at least about 60%, at least about 70%, at least about 80%, or at least about 90% or more, compared to the reference polydispersity index.

In some aspects, the method further comprises contacting the eluent with one or more additional chromatography resins. In some aspects, the one or more additional chromatography resins comprises an anion exchange chromatography (AEX) resin, a cation exchange chromatography (CEX) resin, a mixed mode chromatography (MMC) resin, a hydrophobic charge induction chromatography resin, a hydrophobic interaction chromatography resin, or any combination thereof. In some aspects, the additional chromatography resins are an AEX resin, a CEX resin, a MMC resin, or a combination thereof.

In some aspects, the methods provided herein comprises a first chromatography step and a second chromatography step, wherein the first chromatography step comprises contacting the filtrate with a AEX chromatography resin, and wherein the second chromatography step comprises contacting the eluent from the first chromatography step with a MMC chromatography resin. In some aspects, the methods comprise a third chromatography step, comprising contacting the eluent from the second chromatography stem with an additional MMC chromatography resin.

In some aspects, the sample is contacted with the chromatography resin and/or the additional chromatography resin at least two times, at least three times, at least four times, at least five times, at least six times, at least seven times, at least eight times, at least nine times, at least eight times, at least nine times, at least ten times, at least 11 times, at least 12 times, at least 13 times, at least 14 times, at least 15 times, at least 16 times, at least 17 times, at least 18 times, at least 19 times, at least 20 times, at least 21 times, at least 22 times, at least 23 times, at least 24 times, or at least 25 times.

In some aspects, the sample is contacted with: (a) an AEX resin; (b) a CEX resin; (c) a MMC resin; (d) an affinity chromatography resin; (e) a HIC resin; (f) a ceramic hydroxyapatite resin; (g) an IMAC resin; (h) a HCIC resin; or (i) any combination thereof.

In some aspects, the EV is an exosome.

Certain aspects of the present disclosure are directed to a composition comprising extracellular vesicles (EVs) prepared any method disclosed herein.

In some aspects, the composition further comprises: (a) a saccharide, (b) sodium chloride, (c) potassium phosphate, (d) sodium phosphate, (e) tris, (f) magnesium chloride, or (g) any combination thereof. In some aspects, the sodium chloride is present at a concentration of between about 0.01 M to about 2 M. In some aspects, the sodium chloride is present at a concentration of about 0.01 M, about 0.05 M, about 0.1 M, about 0.15 M, about 0.2 M, about 0.25 M, about 0.3 M, about 0.35 M, about 0.4 M, about 0.45 M, about 0.5 M, about 0.6 M, about 0.7 M, about 0.8 M, about 0.9 M, about 1.0 M, about 1.1 M, about 1.2 M, about 1.3 M, about 1.4 M, about 1.5 M, about 1.6 M, about 1.7 M, about 1.8 M, about 1.9 M, or about 2.0 M. In some aspects, the tris is present at a concentration of about 0.01 M to about 0.1 M. In some aspects, the tris is present at a concentration of about 0.01 M, about 0.02 M, about 0.03 M, about 0.04 M, about 0.05 M, about 0.06 M, about 0.07 M, about 0.08 M, about 0.09 M, or about 0.1 M. In some aspects, the magnesium chloride is present at a concentration of about 0.0001 M to about 1 M.

In some aspects, the composition described above is in a solution having a pH of about 4.0, about 4.5, about 5.0, about 5.5, about 6.0, about 6.5, about 7.0, about 7.5, about 8.0, about 8.5, about 9.0, about 9.5, or about 10.0. In some aspects, the composition is in a solution at a conductivity of about 1 mS/cm, about 5 mS/cm, about 10 mS/cm, about 15 mS/cm, about 20 mS/cm, about 25 mS/cm, about 30 mS/cm, about 35 mS/cm, about 40 mS/cm, about 45 mS/cm, about 50 mS/cm, about 55 mS/cm, about 60 mS/cm, about 65 mS/cm, about 70 mS/cm, about 75 mS/cm, or about 80 mS/cm. In some aspects, the conductivity is about 7.2 mS/cm

In some aspects, the composition is in a solution at a pH of 7.2 and at a conductivity of 8.8 mS/cm+/−10%.

Certain aspects of the present disclosure are directed to a method of treating a disease or condition in a subject in need thereof comprising administering any composition disclosed herein.

### BRIEF DESCRIPTION OF THE FIGURES

FIG. 1 is a schematic of an exemplary large-scale purification process of EVs comprising a filter-based clarification step prior to the anion exchange chromatography (AEX) step. As described herein, the process can further comprise one or more additional chromatography steps (e.g., mixed mode chromatography (MMC)) after the AEX step. In some aspects, the process can comprise a nucleic acid digestion step (e.g., treating the eluent from the AEX chromatography step with a nuclease). In some aspects, after the depth-filter based clarification step and/or the chromatography step, the sample comprising the EVs can be further subjected to an ultrafiltration/diafiltration (UF/DF) step.

FIGS. 2A, 2B, 2C, and 2D show the effect of the filter-based clarification step (using different SP media grade depth filters) on the product quality of the AEX load. The different SP media grade depth filters tested included: 90SP depth filter (“90SP”), 60SP depth filter (“60SP”), 50SP depth filter (“50SP”), and 30SP depth filter (“30SP”). A multi-layer 0.45 μm PES filter was used as a control. FIG. 2A shows the filter throughput for the multi-layer 0.2 μm filter for each of the different filtration groups. FIGS. 2B, 2C, and 2D show the mean particle size, EV recovery (%), and turbidity of the AEX loads, respectively, from the different filtration groups. In FIG. 2B, the gray area shown is representative of the size distribution observed in purified exosome final product.

FIGS. 3A, 3B, 3C, 3D, and 3E show the effect of conductivity on the filter-based clarification step described herein and its product quality impact on the AEX load. Samples comprising EVs after 0.65 μm glass fiber depth filtration were subjected to one of the following filter-based clarification steps: (1) a multi-layer 0.45 μm PES filter followed by a multi-layer 0.2 μm PES filter at 14 mS/cm (i.e., control); (2) 60SP adsorptive depth filter followed by a multi-layer 0.2 μm membrane filter at 14 mS/cm; (3) 90SP adsorptive depth filter followed by a multi-layer 0.2 μm membrane filter at 14 mS/cm; (4) 60SP adsorptive depth filter followed by a multi-layer 0.2 μm membrane filter at 50 mS/cm; and (5) 90SP adsorptive depth filter followed by a multi-layer 0.2 μm membrane filter at 50 mS/cm. FIG. 3A shows the filter throughput (at 30 psi) for the multi-layer 0.2 μm filter for the different groups. FIGS. 3B and 3C show the mean particle size and particle recovery, respectively, for each of the AEX loads. FIGS. 3D and 3E show the mean particle size and particle recovery, respectively, for each of the AEX pools. In FIGS. 3B and 3D, the gray box represents the size distribution observed in purified exosome final product.

FIGS. 4A, 4B, 4C, and 4D show the effect of the filter-based clarification step (using different LA media grade depth filters) on the product quality of the AEX load. The different LA media grade depth filters tested included: 90LA depth filter (“90LA”), 60LA depth filter (“60LA”), 50LA depth filter (“50LA”), and 30LA depth filter (“30LA”). A multi-layer 0.45 μm PES filter was used as a control. FIG. 4A shows the filter throughput for the multi-layer 0.2 μm filter for each of the different filtration groups. FIGS. 4B, 4C, and 4D show the mean particle size, EV recovery (%), and turbidity of the AEX loads, respectively, from the different filtration groups. In FIG. 4B, the gray box represents the size distribution observed in purified exosome final product.

FIGS. 5A, 5B, 5C, 5D, and 5E show the ability of the adsorptive depth filters described herein to remove impurities in a sample comprising EVs. FIG. 5A provides a schematic of the experimental design. As further described in Example 4, samples comprising EVs were subjected to one of the following clarification steps: (1) 0.65 μm glass fiber depth filtration alone (i.e., control); (2) 0.65 μm glass fiber depth filtration followed by a multi-layer 0.2 μm membrane filter: (3) 0.65 μm glass fiber depth filtration, followed by a depth filtration with the 60LA depth filter, and then followed by a multi-layer 0.2 μm membrane filter; and (4) 0.65 μm glass fiber depth filtration (in the presence of 20 U/mL Benzonase), followed by a depth filtration with the 60LA depth filter, and then followed by a multi-layer 0.2 μm membrane filter. In clarification groups (3) and (4), the filtrate from the glass fiber depth filtration was spiked with sodium chloride to achieve a final concentration of 0.5 M NaCl prior to the filtration with the 60LA depth filters. FIGS. 5B, 5C, 5D, and 5E provide anion exchange chromatograms of EVs purified from samples subjected to clarification steps (1), (2), (3), and (4), respectively. Asterisks denote breakthrough of product as demonstrated by inflection of UV260 (top line) and UV280 (bottom line) signals.

FIGS. 6A, 6B, 6C, and 6D show the effect of the depth filter-based clarification step on the product quality of the AEX load. Samples comprising EVs were subjected to the same filter-based clarification steps described in FIG. 5A. FIG. 6A shows the total protein present in the AEX load as measured by SDS-PAGE. Major bands at approximately 120 kD and 42 kD are representative of PTGFRN and beta-actin, respectively. FIG. 6B and FIG. 6C show the mean particle size and particle counts, respectively, of the AEX Loads. The grey area shown in FIG. 6B is representative of the size distribution observed in purified exosome product. FIG. 6D shows the absorbance at 405 nm of each AEX load as a surrogate for solution turbidity.

FIGS. 7A, 7B, and 7C show the effect of a depth filter-based clarification step described herein (using 60LA adsorptive depth filters) on residual impurity in AEX eluates. Samples comprising EVs were subjected to the same depth filter-based clarification steps described in FIG. 5A. FIG. 7A provides a qualitative comparison of residual protein present in the AEX eluates from the different groups as measured by SDS-PAGE. FIG. 7B provides a quantitative comparison of residual protein present in the AEX eluates as measured using BCA. FIG. 7C provides a quantitative comparison of residual DNA present in the AEX eluates.

FIGS. 8A and 8B show the effect of a depth filter-based clarification step described herein (using 60LA adsorptive depth filter) on the size and polydispersity index, respectively, of the eluent collected after AEX chromatography. Prior to AEX chromatography, samples comprising EVs were subjected to the same filter-based clarification steps described in FIG. 5A. The grey area shown in FIG. 8A is representative of the size distribution observed in purified exosome final product.

FIGS. 9A and 9B compares filtration performance of glass-fiber (GF) depth filtered cell culture harvest as compared to non-GF filtered harvest. Each of the groups were filtered using a 60LA depth filter operated in series with a multi-layer 0.2 μm membrane. FIG. 9A provide a schematic of the experimental design. FIG. 9B provides a comparison of pressure drop observed across the 60LA and multi-layer 0.8/0.2 μm device with (circle) or without GF filtration (square)

FIGS. 10A, 10B, 10C, and 10D show the effect of glass-fiber (GF) depth filtration on product quality after LA media grade depth filter-based clarification and AEX chromatography. As described in FIGS. 9A and 9B, prior to the 60LA depth filter-based clarification, samples comprising EVs were either subject to the GF depth filtration (“GF+”) or not subject to the GF depth filtration (“noGF+”). FIG. 10A provides a comparison of the particle yield. FIG. 10B provides a comparison of the mean particle size. FIG. 10C provides a comparison of the residual DNA present, as measured by qPCR. FIG. 10D provides a comparison of residual HCP, as measured using a HEK HCP ELISA.

### DETAILED DESCRIPTION OF DISCLOSURE

The present disclosure provides a large-scale purification process of extracellular vesicles (EVs), wherein the process comprises a depth filter-based clarification step using LA and/or SP media grade depth filters. In some aspects, the purification process can additionally comprise a chromatography step, wherein a sample comprising the EVs are initially filtered (or clarified) (i.e., the depth filter-based clarification step) using a depth filter described herein (e.g., LA media grade depth filter, SP media grade depth filter, or both) prior to the chromatography step. In some aspects, the depth filter-based clarification step can occur elsewhere during the purification process (e.g., after the chromatography step). As disclosed herein, such filtration/clarification step can allow for the production of highly purified and improved extracellular vesicles (e.g., exosomes).

### 1. Definitions

In order that the present description can be more readily understood, certain terms are first defined. Additional definitions are set forth throughout the detailed description.

It is to be noted that the term “a” or “an” entity refers to one or more of that entity; for example, “a nucleotide sequence,” is understood to represent one or more nucleotide sequences. As such, the terms “a” (or “an”), “one or more,” and “at least one” can be used interchangeably herein. It is further noted that the claims can be drafted to exclude any optional element. As such, this statement is intended to serve as antecedent basis for use of such exclusive terminology as “solely,” “only” and the like in connection with the recitation of claim elements, or use of a negative limitation.

Furthermore, “and/or” where used herein is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C: A (alone); B (alone); and C (alone).

It is understood that wherever aspects are described herein with the language “comprising,” otherwise analogous aspects described in terms of “consisting of” and/or “consisting essentially of” are also provided.

Unless defined otherwise, all technical and scientific terms used herein have the same meaning as commonly understood by one of ordinary skill in the art to which this disclosure is related. For example, the Concise Dictionary of Biomedicine and Molecular Biology, Juo, Pei-Show, 2nd ed., 2002, CRC Press; The Dictionary of Cell and Molecular Biology, 3rd ed., 1999, Academic Press; and the Oxford Dictionary Of Biochemistry And Molecular Biology, Revised, 2000, Oxford University Press, provide one of skill with a general dictionary of many of the terms used in this disclosure.

Units, prefixes, and symbols are denoted in their Système International de Unites (SI) accepted form. Numeric ranges are inclusive of the numbers defining the range. Where a range of values is recited, it is to be understood that each intervening integer value, and each fraction thereof, between the recited upper and lower limits of that range is also specifically disclosed, along with each subrange between such values. The upper and lower limits of any range can independently be included in or excluded from the range, and each range where either, neither or both limits are included is also encompassed within the disclosure. Thus, ranges recited herein are understood to be shorthand for all of the values within the range, inclusive of the recited endpoints. For example, a range of 1 to 10 is understood to include any number, combination of numbers, or sub-range from the group consisting of 1, 2, 3, 4, 5, 6, 7, 8, 9, and 10.

Where a value is explicitly recited, it is to be understood that values, which are about the same quantity or amount as the recited value are also within the scope of the disclosure. Where a combination is disclosed, each sub-combination of the elements of that combination is also specifically disclosed and is within the scope of the disclosure. Conversely, where different elements or groups of elements are individually disclosed, combinations thereof are also disclosed. Where any element of a disclosure is disclosed as having a plurality of alternatives, examples of that disclosure in which each alternative is excluded singly or in any combination with the other alternatives are also hereby disclosed; more than one element of a disclosure can have such exclusions, and all combinations of elements having such exclusions are hereby disclosed.

Nucleotides are referred to by their commonly accepted single-letter codes. Unless otherwise indicated, nucleotide sequences are written left to right in 5′ to 3′ orientation. Nucleotides are referred to herein by their commonly known one-letter symbols recommended by the IUPAC-IUB Biochemical Nomenclature Commission. Accordingly, A represents adenine, C represents cytosine, G represents guanine, T represents thymine, and U represents uracil.

Amino acid sequences are written left to right in amino to carboxy orientation. Amino acids are referred to herein by either their commonly known three letter symbols or by the one-letter symbols recommended by the IUPAC-IUB Biochemical Nomenclature Commission.

The term “about” is used herein to mean approximately, roughly, around, or in the regions of. When the term “about” is used in conjunction with a numerical range, it modifies that range by extending the boundaries above and below the numerical values set forth. In general, the term “about” can modify a numerical value above and below the stated value by a variance of, e.g., 10 percent, up or down (higher or lower).

As used herein, the term “large scale” refers to a production scale that is larger than an experimental or laboratory use for research purposes only. Large scale purification is the final production step, prior to product formulation, in the manufacture of therapeutic products, e.g., EVs. Large-scale purification requires a scale-up from laboratory scale techniques to satisfy the need for larger amounts of extremely pure test quantities of the product for analysis, characterization, testing of efficacy, clinical or field trials, and, finally, full scale commercialization. The uncompromising standards for product quality, as well as rigorous quality control of manufacturing practices embodied in current good manufacturing practices (cGMP's), provide further challenges to the scale-up of EV purification. Analysis of electrokinetic, chromatographic, adsorptive, and membrane separation techniques suggests that if yield recovery is paramount, documented purity is critical, and both must ultimately be attained within certain cost constraints. The term “large scale” as used herein indicates that the final product is for use in clinical settings and commercial sales of the purified EV products. The term “large scale” purification means a purification process of at least about 200 L, at least about 250 L, at least about 300 L, at least about 350 L, at least about 400 L, at least about 450 L, at least about 500 L, at least about 550 L, at least about 600 L, at least about 650 L, at least about 700 L, at least about 750 L, at least about 800 L, at least about 850 L, at least about 900 L, at least about 950 L, at least about 1,000 L, at least about 1,500 L, or at least about 2,000 L cell culture harvest. In some aspects, the term “large scale” purification means a purification process of at least about 2000 L cell culture harvest. In some aspects, the term “large scale” purification means a purification process of at least about 3,000 L, at least about 4,000 L, at least about 5,000 L, at least about 6,000 L, at least about 7,000 L, at least about 8,000 L, at least about 9,000 L, at least about 10,000 L, at least about 11,000 L, at least about 12000 L, at least about 13,000 L, at least about 14,000 L, or at least about 15,000 L cell culture harvest.

As used herein, the terms chromatography “resin” and “matrix” are used interchangeably, and refer to the stationary (e.g., solid) phase of chromatography (e.g., a column chromatography). Non-limiting examples of such resins include: beaded resin, gels, monoliths, membranes, non-woven supports, and combinations thereof. The methods disclosed herein can be applied to any form of chromatography suitable for the purification of EVs, e.g., exosomes. In certain aspects, the chromatography resin comprises an “affinity” chromatography resin, which refers to a chromatography resin that interacts with one or more molecules present in the mobile phase of the chromatography. An affinity chromatography can be used in a “bind-and-elute” mode, wherein the desired molecules interact with the stationary phase until certain conditions are created that cause the desired molecules to release from the stationary phase and elute from the chromatography resin; or in a “pass through” mode, wherein one or more impurities present in the mobile phase, but not the desired molecules, interact with the chromatography resin, allowing the desired molecules to “pass through” the chromatography resin, while the impurities remain associated with the chromatography resin. In some aspects, the chromatography resin comprises an anion exchange (AEX) resin, a cation exchange (CEX) resin, a pseudo affinity chromatography resin, a hydrophobic interaction resin, a ceramic hydroxyapatite resin, a fluoro hydroxyapatite resin, and any combination thereof. In some aspects, the chromatography resin comprises a mixed-mode chromatography (MMC) resin.

As used herein, the term “depth filtration” refers to a type of purification method which uses a porous filtration medium (i.e., “depth filter” or “adsorptive depth filter”) that retains contaminants throughout the medium rather than just on the medium's surface and thus can retain a larger number of contaminants before becoming clogged. Depth filtration relies on adsorption and/or mechanical entrapment throughout the depth filter medium. In some aspects, depth filter medium that can be used with the present disclosure comprises a LA media grade depth filter, a SP media grade depth filter, or both.

As used herein, the term “filterability” refers to the ability to increase a material's volumetric throughput (L of feed filterable per m2 of filter area).

As used herein, the term “extracellular vesicle” or “EV” refers to a cell-derived vesicle comprising a membrane that encloses an internal space. Extracellular vesicles comprise all membrane-bound vesicles (e.g., exosomes, microvesicles, microsomes, extracellular bodies, apoptotic bodies, and/or nanovesicles) that have a smaller diameter than the cell from which they are derived. In some aspects, extracellular vesicles comprise a population of exosomes and/or microvesicles. In some aspects, extracellular vesicles range in diameter from 20 nm to 1000 nm, and can comprise various macromolecular molecules either within the internal space (i.e., lumen), displayed on the external surface and/or the luminal surface of the EV, and/or spanning the membrane. In some aspects, the molecules in the EVs can comprise nucleic acids, proteins, carbohydrates, lipids, small molecules, and/or combinations thereof. In certain aspects, an EV comprises a scaffold moiety. By way of example and without limitation, EVs include apoptotic bodies, fragments of cells, vesicles derived from cells by direct or indirect manipulation (e.g., by serial extrusion or treatment with alkaline solutions), vesiculated organelles, and vesicles produced by living cells (e.g., by direct plasma membrane budding or fusion of the late endosome with the plasma membrane). EVs can be derived from a living or dead organism, explanted tissues or organs, prokaryotic or eukaryotic cells, and/or cultured cells. In some aspects, the EVs are produced by cells that express one or more transgene products. The EVs that can be purified by the present methods include exosomes, microsomes, microvesicles, extracellular bodies, apoptotic bodies, nanovesicles, or any combination thereof.

As used herein, the term “exosome” refers to an extracellular vesicle with a diameter between 20-300 nm (e.g., between 40-200 nm). Exosomes comprise a membrane that encloses an internal space (i.e., lumen), and, in some aspects, can be generated from a cell (e.g., producer cell) by direct plasma membrane budding or by fusion of the late endosome with the plasma membrane. As described infra, an exosome can be derived from a producer cell, and isolated from the producer cell based on its size, density, biochemical parameters, or a combination thereof.

In some aspects, the EVs (e.g., exosomes) described herein are engineered by associating (e.g., linking, e.g., covalently linking) at least one moiety, e.g., payload, e.g., a biologically active molecule (e.g., a protein such as an antibody or ADC, a RNA or DNA such as an antisense oligonucleotide, a small molecule drug, a toxin, a STING agonist, a cell penetrating peptide, or PROTAC) to the exosome, directly or indirectly, e.g., via a linker, a scaffold moiety, or any combination thereof.

As used herein, the term “payload” refers to an agent that acts on a target (e.g., a target cell) that is contacted with the EV (e.g., exosome). In some aspects, unless indicated otherwise, the term payload can be used interchangeably with the term “biologically active molecules.” Non-limiting examples of payload that can be included on the EV, e.g., exosome, are an antigen, an adjuvant, and/or an immune modulator. Payloads that can be introduced into an EV, e.g., exosome, and/or a producer cell include agents such as, nucleotides (e.g., nucleotides comprising a detectable moiety or a toxin or that disrupt transcription), nucleic acids (e.g., DNA or mRNA molecules that encode a polypeptide such as an enzyme, or RNA molecules that have regulatory function such as miRNA, dsDNA, lncRNA, siRNA, antisense oligonucleotide, a phosphorodiamidate morpholino oligomer (PMO), a peptide-conjugated phosphorodiamidate morpholino oligomer (PPMO), or combinations thereof), amino acids (e.g., amino acids comprising a detectable moiety or a toxin or that disrupt translation), polypeptides (e.g., enzymes and cell penetrating peptides), lipids, carbohydrates, and small molecules (e.g., small molecule drugs and toxins). In certain aspects, a payload comprises an antigen.

In some aspects, the payload is a protein, a peptide, a glycolipid, or a glycoprotein.

In certain aspects, the payload is a polynucleotide. In some of these aspects, the polynucleotide includes, but is not limited to, an mRNA, a miRNA, an siRNA, an antisense oligonucleotide (e.g., antisense RNA or antisense DNA), a phosphorodiamidate morpholino oligomer (PMO), a peptide-conjugated phosphorodiamidate morpholino oligomer (PPMO), an shRNA, a lncRNA, a dsDNA, and combinations thereof. In some aspects, the polynucleotide is an RNA (e.g., an mRNA, a miRNA, an siRNA, an antisense oligonucleotide (e.g., antisense RNA), an shRNA, or an lncRNA). In some aspects, the polynucleotide can target a transcription factor. In some of these aspects, when the polynucleotide is an mRNA, it can be translated into a desired polypeptide. In some aspects, the polynucleotide is a microRNA (miRNA) or pre-miRNA molecule. In some of these aspects, the miRNA is delivered to the cytoplasm of the target cell, such that the miRNA molecule can silence a native mRNA in the target cell. In some aspects, the polynucleotide is a small interfering RNA (siRNA) or a short hairpin RNA (shRNA) capable of interfering with the expression of an oncogene or other dysregulating polypeptides. In some of these aspects, the siRNA is delivered to the cytoplasm of the target cell, such that the siRNA molecule can silence a native mRNA in the target cell. In some aspects, the polynucleotide is an antisense oligonucleotide (e.g., antisense RNA) that is complementary to an mRNA. In some aspects, the polynucleotide is a long non-coding RNA (lncRNA) capable of regulating gene expression and modulating diseases. In some aspects, the polynucleotide is a DNA that can be transcribed into an RNA. In some of these aspects, the transcribed RNA can be translated into a desired polypeptide.

As used herein, the term “nanovesicle” refers to an extracellular vesicle with a diameter between 20-250 nm (e.g., between 30-150 nm) and is generated from a cell (e.g., producer cell) by direct or indirect manipulation such that the nanovesicle would not be produced by the cell without the manipulation. Appropriate manipulations of the cell to produce the nanovesicles include but are not limited to serial extrusion, treatment with alkaline solutions, sonication, or combinations thereof. In some aspects, production of nanovesicles can result in the destruction of the producer cell. In some aspects, population of nanovesicles described herein are substantially free of vesicles that are derived from cells by way of direct budding from the plasma membrane or fusion of the late endosome with the plasma membrane. Nanovesicles, once derived from a producer cell, can be isolated from the producer cell based on its size, density, biochemical parameters, or a combination thereof. EVs can be derived from a living or dead organism, explanted tissues or organs, prokaryotic or eukaryotic cells, and/or cultured cells.

The term “microvesicle” or “microparticle,” as used herein, is a type of EV, which is between 50 and 1,000 nanometers (nm) in diameter, and which is found in many types of body fluids as well as the interstitial space between cells. Microvesicles are membrane-bound vesicles containing phospholipids, ranging from 100 nm to 1000 nm shed from almost all cell types. Microvesicles play a role in intercellular communication and can transport mRNA, miRNA, and proteins between cells. They originate directly from the plasma membrane of the cell and reflect the antigenic content of the cells from which they originate. They remove misfolded proteins, cytotoxic agents and metabolic waste from the cell.

The term “microsome,” as used herein, refers to heterogeneous vesicle-like artifacts (˜20-200 nm diameter) re-formed from pieces of the endoplasmic reticulum (ER) when eukaryotic cells are broken-up in the laboratory; microsomes are not present in healthy, living cells. Microsomes can be concentrated and separated from other cellular debris by differential centrifugation. Unbroken cells, nuclei, and mitochondria sediment out at 10,000 g, whereas soluble enzymes and fragmented ER, which contains cytochrome P450 (CYP), remain in solution (g is the Earth's gravitational acceleration). Microsomes have a reddish-brown color, due to the presence of the heme.

As used herein, the terms “isolate,” “isolated,” and “isolating” or “purify,” “purified,” and “purifying” as well as “extracted” and “extracting” are used interchangeably and refer to the state of a preparation (e.g., a plurality of known or unknown amount and/or concentration) of desired EVs, that have undergone one or more processes of purification, e.g., a selection or an enrichment of the desired EV preparation. In some aspects, isolating or purifying as used herein is the process of removing, partially removing (e.g., a fraction) the EVs from a sample containing producer cells. In some aspects, an isolated EV composition has no detectable undesired activity or, alternatively, the level or amount of the undesired activity is at or below an acceptable level or amount. In some aspects, an isolated EV composition has an amount and/or concentration of desired EVs at or above an acceptable amount and/or concentration. In some aspects, the isolated EV composition is enriched as compared to the starting material (e.g., producer cell preparations) from which the composition is obtained. This enrichment can be by about 10%, about 20%, about 30%, about 40%, about 50%, about 60%, about 70%, about 80%, about 90%, about 95%, about 96%, about 97%, about 98%, about 99%, about 99.9%, about 99.99%, about 99.999%, about 99.9999%, or greater than about 99.9999% compared to the starting material. In some aspects, isolated EV preparations according to the present disclosure are substantially free of residual contaminating products, including residual biologic products. In some aspects, the isolated EV preparations according to the present disclosure are 100% free, about 99% free, about 98% free, about 97% free, about 96% free, about 95% free, about 94% free, about 93% free, about 92% free, about 91% free, or about 90% free of any contaminating biological matter. Residual contaminating products can include abiotic materials (including chemicals) or unwanted nucleic acids, proteins, lipids, or metabolites. Substantially free of residual biological products can also mean that the EV composition contains no detectable producer cells and that only EVs are detectable.

The term “excipient” refers to an inert substance added to assist in the purification of the EVs. Excipients can modulate the structure of the EV, modulate the adsorption rate of the EVs or the impurities, alter the polarity of the solution being purified, and perform other functions to provide an increase in the purity of the EVs. In some aspects, an excipient that can be used with the present disclosure comprises an acid (e.g., acetic, acid, citric acid, carboxylic acid, sialic acid, polyaspartic acid, polyglutamic acid), a salt (e.g., [NH₄]₂SO₄, K₂SO₄, or KH₂PO₄), a cationic polymer (e.g., chitosan, pDADMAC, or PEI), an ethylene glycol, a propylene glycol, a polyethylene glycol, a polypropylene glycol, an urea, an arginine-HCL, a lysine, a glycine, a histidine, a calcium, a sodium, a lithium, a potassium, an iodide, a magnesium, an iron, a zinc, a manganese, an aluminum, an ammonium, guanidium polyethylene glycol, a protease inhibitor (e.g., EDTA or EGTA), an anti-oxidant (e.g., cysteine or N-acetyl cysteine), a detergent, a chloride, a sulfate, a phosphate, an acetate, a borate, a formate, a perchlorate, a bromine, a nitrate, a dithiothreitol, a beta mercaptoethanol, a tri-n-butyl phosphate, a polyanion, a polyarginine, a polylysine, a polyhistidine, or a combination thereof. Additional suitable excipients are provided elsewhere in the present disclosure.

As used herein, the term “substantially free” means that a purified composition comprising EVs comprise less than about 10% (m/v) of macromolecules by mass/volume percentage concentration. Some fractions can contain less than about 0.001%, less than about 0.01%, less than about 0.05%, less than about 0.1%, less than about 0.2%, less than about 0.3%, less than about 0.4%, less than about 0.5%, less than about 0.6%, less than about 0.7%, less than about 0.8%, less than about 0.9%, less than about 1%, less than about 2%, less than about 3%, less than about 4%, less than about 5%, less than about 6%, less than about 7%, less than about 8%, less than about 9%, or less than about 10% (m/v) of macromolecules.

As used herein, the term “macromolecule” means a molecule containing a very large number of atoms, such as nucleic acids, proteins, lipids, carbohydrates, metabolites, and/or a combination thereof. In some aspects, “macromolecules” are part of impurities that can be removed during purification as described herein.

The term “nucleic acid molecule” refers to any nucleotide or nucleoside or any polymer or analog thereof, including but not limited to deoxyribonucleic acid (DNA) molecules, ribonucleic acid (RNA) molecules, peptide nucleic acid molecules, locked nucleic acid (LNA) molecules, morpholino nucleic acid molecules, glycol nucleic acid molecules, threose nucleic acid molecules, and any polymers, analogs, or combinations thereof. The term “polynucleotide,” as used herein, refers to a nucleic acid molecule comprising at least two individual nucleotide units.

The term “nuclease” as used herein refers to a protein, e.g., an enzyme that is capable of catalyzing the cleavage of a nucleic acid molecule. In some aspects, the nuclease is an “endonuclease,” which refers to a nuclease that catalyzes cleavage of a nucleic acid molecule between two adjacent nucleotides, wherein at neither of the adjacent nucleotides are at the terminus of the nucleic acid molecule, e.g. an endonuclease catalyzes cleavage between the 5′ and 3′ end of a nucleic acid molecule. Conversely, in some aspects, the nuclease comprises an “exonuclease,” which catalyzes the cleavage of a nucleic acid molecule by removing one or more nucleotides at one or both ends of the nucleic acid molecule, e.g., by removing the 5′ or 3′ nucleotide from the nucleic acid molecule. In some aspects, a nucleic acid molecule is said to be “degraded” following cleavage by a nuclease. Any nuclease known in the art can be used in the methods disclosed herein. In certain aspects, the nuclease is selected from a salt active nuclease (SAN), a Benzonase, a Denarase, a Kryptonase, and any combination thereof. In some aspects, more than one nuclease is applied to the chromatography resins disclosed herein. When more than one nuclease is used, each nuclease can applied to the chromatography resins together, e.g., in a single wash buffer, or each nuclease can be applied to the chromatography resin sequentially.

The terms “anion” and “cation” refer to negatively and positively charged ions, respectively. A “divalent” cation refers to a cation with a valence of 2+. Examples of divalent cations include, but are not limited to, Ca²⁺, Mg²⁺, Co²⁺, Ni²⁺, Zn²⁺, Ba²⁺, Sr²⁺, Al²⁺, Ag²⁺, Cu²⁺, and Mn²⁺. A “monovalent cation refers to a cation with a valence of 1+. Examples of monovalent cations include, but are not limited to, Li⁺, K⁺, Na⁺, NH4⁺, Cu⁺. Examples of anions include, but are not limited to, SCN⁻, Cl⁻, SO4⁻, and PO₄. In some aspects, the anion and/or the cation (e.g., monovalent cation or divalent cation) can be present in a salt, e.g., a mixture of at least one anion and at least one cation of complementary valences. Any salt comprising an anion or a cation disclosed herein can be used in the methods disclosed herein, e.g., in a nuclease wash buffer disclosed herein. In some aspects, the salt is selected from NaCl, KCl, PO₄, CaCl₂, MgCl₂, Mg2SO4, ZnCl2, MnCl2, MnSO4, NaSCN, KSCN, LiCl, NaPO4, K2HPO4, Na2SO4, K2SO4, NaAcetate, sodium chloride, potassium chloride, sodium bromide, lithium chloride, sodium iodide, potassium bromide, lithium bromide, sodium fluoride, potassium fluoride, lithium fluoride, lithium iodide, sodium acetate, potassium acetate, lithium acetate, potassium iodide, calcium sulfate, sodium sulfate, magnesium sulfate, chromium trichloride, chromium sulfate, sodium citrate, iron (III) chloride, yttrium (III) chloride, potassium phosphate, potassium sulfate, sodium phosphate, ferrous chloride, calcium citrate, magnesium phosphate, ferric chloride, or a combination thereof. Additional examples of suitable salts are provided elsewhere in the present disclosure.

The terms “polypeptide,” “peptide,” and “protein” are used interchangeably herein to refer to polymers of amino acids of any length. The polymer can comprise modified amino acids. The terms also encompass an amino acid polymer that has been modified naturally or by intervention; for example, disulfide bond formation, glycosylation, lipidation, acetylation, phosphorylation, or any other manipulation or modification, such as conjugation with a labeling component. Also included within the definition are, for example, polypeptides containing one or more analogs of an amino acid (including, for example, unnatural amino acids such as homocysteine, ornithine, p-acetylphenylalanine, D-amino acids, and creatine), as well as other modifications known in the art. In some aspects of the present disclosure, the biologically active molecule attached to the EV is a polypeptide, e.g., an antibody or an antigen binding portion thereof, a fusion protein, a cytokine, a cell penetrating peptide, or an enzyme. A polypeptide can be a single polypeptide or can be a multi-molecular complex such as a dimer, trimer or tetramer. They can also comprise single chain or multi-chain polypeptides. Most commonly, disulfide linkages are found in multi-chain polypeptides. The term polypeptide can also apply to amino acid polymers in which one or more amino acid residues are an artificial chemical analog of a corresponding naturally occurring amino acid. In some aspects, a “peptide” can be less than or equal to 50 amino acids long, e.g., about 5, 10, 15, 20, 25, 30, 35, 40, 45, or 50 amino acids long.

A “recombinant” polypeptide or protein refers to a polypeptide or protein produced via recombinant DNA technology. Recombinantly produced polypeptides and proteins expressed in engineered host cells are considered isolated for the purpose of the disclosure, as are native or recombinant polypeptides, which have been separated, fractionated, or partially or substantially purified by any suitable technique. The polypeptides disclosed herein can be recombinantly produced using methods known in the art. Alternatively, the proteins and peptides disclosed herein can be chemically synthesized. In some aspects of the present disclosure, the Scaffold X and/or Scaffold Y proteins present in EVs are recombinantly produced by overexpressing the scaffold proteins in the producer cells, so that levels of scaffold proteins in the resulting EVs are significantly increased with respect to the levels of scaffold proteins present in EVs of producer cells not overexpressing such scaffold proteins.

As used herein, the term “scaffold moiety” refers to a molecule, e.g., a protein such as Scaffold X or Scaffold Y, that can be used to anchor a molecule, e.g., a biologically active molecule, to the EV either on the luminal surface or on the exterior surface of the EV. In certain aspects, a scaffold moiety comprises a synthetic molecule. In some aspects, a scaffold moiety comprises a non-polypeptide moiety. In some aspects, a scaffold moiety comprises, e.g., a lipid, carbohydrate, protein, or combination thereof (e.g., a glycoprotein or a proteolipid) that naturally exists in the EV. In some aspects, a scaffold moiety comprises a lipid, carbohydrate, or protein that does not naturally exist in the EV. In some aspects, a scaffold moiety comprises a lipid or carbohydrate, which naturally exists in the EV but has been enriched in the EV with respect to basal/native/wild type levels. In some aspects, a scaffold moiety comprises a protein which naturally exists in the EV but has been engineered to be enriched in the EV, e.g., by recombinant overexpression in the producer cell, with respect to basal/native/wild type levels. In certain aspects, a scaffold moiety is Scaffold X. In some aspects, a scaffold moiety is Scaffold Y. In further aspects, a scaffold moiety comprises both Scaffold X and Scaffold Y.

As used herein, the term “Scaffold X” or “PrX” refers to EV proteins that have been identified on the surface of EVs. See, e.g., U.S. Pat. No. 10,195,290, which is incorporated herein by reference in its entirety. Non-limiting examples of Scaffold X proteins include: prostaglandin F2 receptor negative regulator (“PTGFRN”); basigin (“BSG”); immunoglobulin superfamily member 2 (“IGSF2”); immunoglobulin superfamily member 3 (“IGSF3”); immunoglobulin superfamily member 8 (“IGSF8”); integrin beta-1 (“ITGB1”); integrin alpha-4 (“ITGA4”); 4F2 cell-surface antigen heavy chain (“SLC3A2”); and a class of ATP transporter proteins (“ATP1A1,” “ATP1A2,” “ATP1A3,” “ATP1A4,” “ATP1B3,” “ATP2B1,” “ATP2B2,” “ATP2B3,” “ATP2B”). In some aspects, a Scaffold X protein can be a whole protein or a fragment thereof (e.g., functional fragment, e.g., the smallest fragment that is capable of anchoring another moiety on the exterior surface or on the luminal surface of the EV). In some aspects, a Scaffold X can anchor a moiety, e.g., a biologically active molecule to the external surface or the luminal surface of the EV. Non-limiting examples of other Scaffold X proteins include e.g., CD13 (aminopeptidase N), MME (membrane metalloendopeptidase), ENPP1 (ectonucleotide pyrophosphatase/phosphodiesterase family member 1), NRP1 (neuropilin-1), CD9, CD63, CD81, PDGFR, GPI anchor proteins, lactadherin, LAMP2, and LAMP2B.

As used herein, the term “Scaffold Y” refers to EV proteins that have been identified within the lumen of EVs. See, e.g., International Publ. Nos. WO/2019/099942 (or its US equivalent—US 2020/0347112) and WO 2020/101740, each of which is incorporated herein by reference in its entirety. Non-limiting examples of Scaffold Y proteins include: myristoylated alanine rich Protein Kinase C substrate (“MARCKS”); myristoylated alanine rich Protein Kinase C substrate like 1 (“MARCKSL1”); and brain acid soluble protein 1 (“BASP1”). In some aspects, a Scaffold Y protein can be a whole protein or a fragment thereof (e.g., functional fragment, e.g., the smallest fragment that is capable of anchoring a moiety on the luminal surface of the EV). In some aspects, a Scaffold Y can anchor a moiety on the luminal surface of the EV. In some aspects of the present disclosure, a moiety can be covalently attached to a Scaffold Y. In some aspects, the moiety can be attached to Scaffold Y on the luminal surface of the EV.

As used herein the term “surface-engineered EV” (e.g., Scaffold X-engineered EV) refers to an EV with the membrane or the surface of the EV modified in its composition so that the surface of the engineered EV is different from that of the EV prior to the modification or of the naturally occurring EV. The engineering can be on the surface of the EV or in the membrane of the EV so that the exterior surface of the EV is changed. For example, the membrane can be modified in its composition of, e.g., a protein, a lipid, a small molecule, a carbohydrate, or a combination thereof. The composition can be changed by a chemical, a physical, or a biological method or by being produced from a cell previously or concurrently modified by a chemical, a physical, or a biological method. Specifically, the composition can be changed by a genetic engineering or by being produced from a cell previously modified by genetic engineering. In some aspects, a surface-engineered EV comprises an exogenous protein (i.e., a protein that the EV does not naturally express) or a fragment or variant thereof that can be exposed to the surface of the EV or can be an anchoring point (attachment) for a moiety exposed on the exterior surface of the EV. In some aspects, a surface-engineered EV comprises a higher expression (e.g., higher number) of a natural EV protein (e.g., Scaffold X) or a fragment or variant thereof that can be exposed to the surface of the EV or is capable of being an anchoring point (attachment) for a moiety exposed on the surface of the EV.

As used herein the term “lumen-engineered exosome” (e.g., Scaffold Y-engineered exosome) refers to an exosome with the membrane or the lumen of the exosome modified in its composition so that the lumen of the engineered exosome is different from that of the exosome prior to the modification or of the naturally occurring exosome. The engineering can be directly on the luminal surface or in the membrane of the exosome so that the lumen of the exosome is changed. For example, the membrane is modified in its composition of a protein, a lipid, a small molecule, a carbohydrate, etc. so that the lumen of the exosome is modified. The composition can be changed by a chemical, a physical, or a biological method or by being produced from a cell previously modified by a chemical, a physical, or a biological method. Specifically, the composition can be changed by a genetic engineering or by being produced from a cell previously modified by genetic engineering. In some aspects, a lumen-engineered exosome comprises an exogenous protein (i.e., a protein that the exosome does not naturally express) or a fragment or variant thereof that can be exposed on the luminal surface of the exosome or can be an anchoring point (attachment) for a moiety exposed on the inner layer of the exosome. In some aspects, a lumen-engineered exosome comprises a higher expression of a natural exosome protein (e.g., Scaffold X or Scaffold Y) or a fragment or variant thereof that can be exposed to the lumen of the exosome or can be an anchoring point (attachment) for a moiety exposed on the luminal surface of the exosome.

As used herein the term “linked to,” “fused,” or “conjugated to” are used interchangeably and refer to a covalent or non-covalent bond formed between a first moiety and a second moiety, e.g., Scaffold X and an antigen, e.g., a scaffold moiety expressed in or on the extracellular vesicle and an antigen, e.g., Scaffold X (e.g., a PTGFRN protein), respectively, in the luminal surface of or on the external surface of the extracellular vesicle. In some aspects, a payload disclosed herein can be directly linked to the exterior surface and/or the luminal surface of an EV (e.g., exosome). As used herein, the term “directly linked,” “directly fused,” or “directly conjugated to” refer to the process of linking (fusing or conjugating) a moiety (e.g., a payload and/or targeting moiety) to the surface of an EV (e.g., exosome) without the use of a scaffold moiety disclosed herein.

As used herein, the term “fusion protein” refers to two or more proteins that are linked or conjugated to each other. For instance, in some aspects, a fusion protein that can be expressed in an EV (e.g., exosome) disclosed herein comprises (i) a payload (e.g., antigen, adjuvant, and/or immune modulator) and (ii) a scaffold moiety (e.g., Scaffold X and/or Scaffold Y). In some aspects, a fusion protein that can be expressed in an EV (e.g., exosome) useful for the present disclosure comprises (i) a targeting moiety and (ii) a scaffold moiety (e.g., Scaffold X and/or Scaffold Y). As described herein, in some aspects, EVs (e.g., exosomes) of the present disclosure can express multiple fusion proteins, wherein a first fusion protein comprises (i) a payload (e.g., antigen, adjuvant, and/or immune modulator) and (ii) a scaffold moiety (e.g., Scaffold X and/or Scaffold Y), and wherein a second fusion protein comprises (i) a targeting moiety and (ii) a scaffold moiety (e.g., Scaffold X and/or Scaffold Y).

### 2. Methods of the Present Disclosure

Certain aspects of the present disclosure relate to isolation, purification and/or sub-fractionation of EVs by chromatographic purification methods. As is apparent from the present disclosure, unless indicated otherwise, such purification methods comprise a depth filter-based clarification step as described herein. Accordingly, in some aspects, the present disclosure provides methods of preparing purified EVs (e.g., exosomes) from a sample, which comprises EVs and one or more impurities, wherein the method comprises contacting the sample with a depth filter. In some aspects, the contacting of the sample with the depth filter results in one or more of the impurities present in the sample to bind and/or associate with the depth filter. In some aspects, the depth filter comprises a low aluminum (LA) media grade depth filter, a SP media grade depth filter, or both. As used herein, “LA media grade depth filters” are low aluminum and primarily comprise cellulose fibers and diatomaceous earth. As used herein, “SP media grade depth filters” comprise cellulose fibers, diatomaceous earth, and perlite inorganic filter aid).

In some aspects, the depth filter comprises a LA media grade depth filter. Non-limiting examples of such filters include: (i) LA media grade 30 adsorptive depth filter (“30LA depth filter”); (ii) LA media grade 50 adsorptive depth filter (“50LA depth filter”); (iii) LA media grade 60 adsorptive depth filter (“60LA depth filter”); (iv) LA media grade 90 adsorptive depth filter (“90LA depth filter”); and (v) any combination thereof. In some aspects, the depth filter comprises a SP media grade depth filter. Non-limiting examples of such filters include: (i) SP media grade 30 adsorptive depth filter (“30SP depth filter”); (ii) SP media grade 50 adsorptive depth filter (“50SP depth filter”): (iii) SP media grade 60 adsorptive depth filter (“60SP depth filter”); (iv) SP media grade 90 adsorptive depth filter (“90SP depth filter”); and (v) any combination thereof.

As used herein, a “30LA or 30SP depth filter” has a pore rating of between about 1.5 μm to about 5 μm. As used herein, a “60LA or 60SP depth filter” has a pore size of between about 0.2 μm to about 0.8 μm. As used herein, a “90LA or 90SP depth filter” has a pore size of between about 0.5 μm to about 0.1 μm.

Accordingly, in some aspects, a depth filter useful for the present disclosure has a pore size between about 0.03 μm to about 2 μm. In certain aspects, an adsorptive depth filter that can be used with the present disclosure has a pore size of less than about 2 μm, less than about 1.9 μm, less than about 1.8 μm, less than about 1.7 μm, less than about 1.6 μm, less than about 1.5 μm, less than about 1.4 μm, less than about 1.3 μm, less than about 1.2 μm, less than about 1.1 μm, less than about 1.0 μm, less than about 0.09 μm, less than about 0.8 μm, less than about 0.7 μm, less than about 0.6 μm, less than about 0.5 μm, less than about 0.4 μm, less than about 0.3 μm, less than about 0.2 μm, or less than about 0.1 μm. In some aspects, the depth filter useful for the present method is a 60LA depth filter (pore size of between about 0.05 μm to about 0.7 μm) In some aspects, the depth filter useful for the present disclosure is a 60SP depth filter.

As used herein, the term “impurities” refers to any components of a mixture or solution that is not desirable in producing the EVs disclosed herein. For instance, in certain aspects, impurities comprise a nucleic acid molecule, a protein, or both, wherein the nucleic acid molecule and the protein are not associated with the EVs (i.e., not linked to a surface of the EV nor encapsulated in the lumen of the EV). In some aspects, the impurities can be process-related and comprise residual host-cell protein (HCPs) and/or host-cell DNA. As used herein, the term “residual host-cell protein” and “residual host-cell DNA” refer to process impurities that remain in a drug product following purification.

As described herein, compared to a reference filter, the depth filters disclosed herein (e.g., LA and/or SP media grade depth filters) are much more effective in removing one or more impurities present in a sample comprising EVs. As used herein, the term “reference filter” refers to a membrane that is generally comprised of a hydrophilic polymer, such as PES or PVDF. Unlike the depth filters described herein (LA media grade and/or SP media grade depth filters), a reference filter does not use adsorption to remove impurity and/or particles. Instead, a reference filter removes such material based on the size of its pore structure. In some aspects, a reference filter comprises a multi-layer 0.45 μm PES filter. In some aspects, with the depth filters disclosed herein, the amount of impurities present in a sample comprising EVs is reduced by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the amount of impurities present in the sample prior to the depth filter-based clarification step (i.e., prior to contacting the sample with a LA and/or SP media grade depth filter of the present disclosure). Similarly, in some aspects, the amount of one or more impurities present in a sample contacted with a depth filter described herein (i.e., depth filter-based clarification step) is less than about 5%, less than about 10%, less than about 20%, less than about 30%, less than about 40%, less than about 50%, less than about 60%, less than about 70%, less than about 80%, less than about 90%, or less than about 100%, compared to the amount of one or more impurities present in a reference sample (e.g., not contacted with a depth filter described herein and/or contacted with a different filter (e.g., a multi-layer 0.45 μm PES filter)).

Not to be bound by any one theory, in some aspects, the reduced amount of one or more impurities present in the sample after the depth filter-based clarification step described herein can improve the overall purification process. For instance, as demonstrated herein, contacting a sample comprising the EV with a LA media grade depth filter (e.g., the 60LA depth filter) prior to chromatography can extend or increase the dynamic binding capacity of the chromatography resin. Similarly, in some aspects, contacting a sample comprising the EV with a SP media grade depth filter prior to chromatography can extend or increase the dynamic binding capacity of the chromatography resin. As used herein, the term “dynamic binding capacity” refers to the amount of absorbents that bind to the resin under operational conditions (i.e., in a packed chromatography column during sample application) before partial saturation of the resin can occur (which can result in the loss of recovery, as molecules of interest (e.g., EVs) can unintentionally flow through the column. Therefore, in some aspects, by extending or increasing the binding capacity of a chromatography resin, it would be possible to improve recovery of the EVs.

Accordingly, in some aspects, the present disclosure provides methods of increasing a dynamic binding capacity (DBC) of a chromatography resin, comprising contacting the sample (comprising EVs and one or more impurities) with a depth filter described herein, wherein contacting the sample with the depth filter allows for greater binding of EVs present in the filtrate (i.e., material that passes through the depth filter) to the chromatography resin, when the filtrate is subsequently contacted with the chromatography resin. In some aspects, the depth filter comprises a LA media grade depth filter (e.g., 60LA depth filter). In some aspects, the depth filter comprises a SP media grade depth filter. In some aspects, the depth filter comprises both a LA media grade depth filter and a SP media grade depth filter.

In some aspects, the dynamic binding capacity of the chromatography resin is increased compared to a reference dynamic binding capacity (e.g., dynamic binding capacity of a chromatography resin that is contacted with a corresponding sample that has not been contacted with a depth filter described herein, e.g., the 60LA depth filter). In certain aspects, the dynamic binding capacity is increased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the reference dynamic binding capacity.

As described herein, in some aspects, an increase in dynamic binding capacity can result in greater recovery of the EVs from the samples. Accordingly, in some aspects, compared to a corresponding recovery, in which the samples were not contacted with a depth filter described herein (e.g., LA media grade and/or SP media grade depth filters, e.g., the 60LA depth filter) prior to the chromatography (e.g., contacted with the more conventional 0.2 μm filter), the recovery of the EVs is increased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more. As used herein, the term “recovery” refers to the amount of EVs from the starting sample that were obtained after the purification process (e.g., after the chromatography). In certain aspects, using the methods disclosed herein (e.g., contacting the sample with a LA media grade and/or SP media grade depth filters (e.g., the 60LA depth filter) prior to the chromatography), at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or at least about 100% of the starting EVs are recovered.

As is apparent from the present disclosure, using the methods provided herein, it is possible to produce purified EV (e.g., exosomes) preparations with one or more of the properties described herein. For instance, in some aspects, contacting the initial sample (i.e., comprising the EVs and one or more impurities) with a depth filter described herein (e.g., the 60LA filter) prior to a chromatography step can reduce the amount of one or more impurities present in the EV preparation obtained after the chromatography step.

While the present disclosure describes the depth filter-based clarification step as taking place prior to a chromatography step, it will be apparent from the present disclosure that the depth filter-based clarification step can occur anywhere during the EV preparation/purification process. For instance, in some aspects, the depth filter-based clarification step can be performed after a chromatography step, such that any residual impurities present in the eluent collected from the chromatography step can be further removed. In some aspects, the methods described herein can comprise multiple depth filter-based clarification steps. For instance, in some aspects, a first depth filter-based clarification step can be performed prior to a chromatography step, and a second depth filter-based clarification step can be performed after the chromatography step. In some aspects, the depth-filter based clarification step described herein (e.g., using a LP media grade depth filter, a SP media grade depth filter, or both) can be performed further downstream of the purification process, e.g., prior to the virus removal filtration to increase the throughput.

Where multiple depth filter-based clarification steps are performed, in some aspects, each of the multiple depth filter-based clarification steps comprise a different depth filter (e.g., the first depth filter-based clarification step can be performed with a 60LA depth filter, and the second depth filter-based clarification step can be performed with a 60SP depth filter). In some aspects, each of the multiple depth filter-based clarification steps comprise the same depth filter. In some aspects, some of the multiple depth filter-based clarification steps comprise the same depth filter, while the other multiple depth filter-based clarification steps comprise different depth filters.

Accordingly, in some aspects, the present disclosure provides methods of reducing one or more impurities in an EV preparation obtained with chromatography, comprising contacting a sample, which comprises EVs and one or more impurities, with a depth filter described herein (e.g., LA media grade, SP media grade, or both; e.g., 60LA depth filter”) prior to the chromatography. In some aspects, with such a method, the amount of one or more impurities in the EV preparation after the chromatography is decreased compared to the amount of the one or more impurities in a reference EV preparation, wherein the reference EV preparation was obtained from a corresponding sample that was not contacted with the depth filter (e.g., 60LA depth filter) prior to the chromatography. In some aspects, the amount of one or more impurities of the EV preparation is decreased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the reference EV preparation.

In some aspects, with the depth filters described herein (e.g., LA media grade, SP media grade, or both), the throughput (i.e., amount of the sample comprising EVs and one or more impurities that can be processed) is increased compared to a reference filter (e.g., a multi-layer 0.45 μm PES filter) such that purified EVs can be prepared on a large scale. In some aspects, with the depth filters described herein, the throughput is increased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the reference filter.

As will be apparent from the present disclosure, in some aspects, methods described herein further comprises collecting the resulting filtrate after contacting the initial sample (comprising the EV and one or more impurities) with the depth filter (LA media grade, SP media grade, or both) (e.g., 60LA depth filter). In some aspects, the amount of the one or more impurities present in the filtrate is reduced by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to a reference amount of the one or more impurities. In some aspects, the reference amount comprises amount of the impurities present in the sample prior to the contacting with the depth filter (e.g., 60LA depth filter). In some aspects, the reference amount comprises amount of the impurities present in a reference filtrate collected after contacting the sample with a different filter (e.g., having a pore size of 0.2 μm).

Not to be bound by any one theory, in some aspects, the reduced amount of impurities present in the filtrate collected using depth filter described herein (e.g., the 60LA filter) can be associated with reduced turbidity of the filtrate. As used herein, the term “turbidity” refers to the cloudiness or haziness of a fluid caused by large numbers of individual particles that are generally invisible to the naked eye. In some aspects, turbidity of the filtrate is reduced by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to a reference filtrate (e.g., filtrate collected from a corresponding sample that was not contacted with a depth filter described herein, e.g., the 60LA depth filter).

In some aspects, methods described herein (e.g., method of preparing purified EV preparation) further comprises contacting the filtrate (e.g., collected after the depth filter-based clarification step described herein) with a chromatography resin, wherein the contacting results in one or more EVs of the filtrate to attach to the chromatography resin. In some aspects, any chromatography resins that are suitable for purifying EVs from a sample can be used. Non-limiting examples of such resins include: a cation exchange (CEX) chromatography resin, an anion exchange (AEX) chromatography resin, a mixed mode chromatography (MMC) resin, an affinity chromatography resin, a pseudo affinity chromatography resin, a hydrophobic interaction resin, a ceramic hydroxyapatite resin, a fluoro hydroxyapatite resin, or any combination thereof. In certain aspects, the chromatography resin is an anion exchange (AEX) chromatography resin. In some aspects, the chromatography resin is a cation exchange a cation exchange (CEX) chromatography resin. In some aspects, the chromatography resin is a mixed mode chromatography (MMC) resin.

In some aspects, the filtrate (e.g., collected after the depth filter-based clarification step described herein) is contacted with the chromatography resin in a loading buffer, which comprises a salt. Non-limiting examples of salts that can be included in the loading buffer include: NaCl, KCl, PO₄, CaCl₂, MgCl₂, Mg2SO4, ZnCl2, MnCl2, MnSO4, NaSCN, KSCN, LiCl, NaPO4, K2HPO4, Na2SO4, K2SO4, NaAcetate, sodium chloride, potassium chloride, sodium bromide, lithium chloride, sodium iodide, potassium bromide, lithium bromide, sodium fluoride, potassium fluoride, lithium fluoride, lithium iodide, sodium acetate, potassium acetate, lithium acetate, potassium iodide, or any combination thereof. In certain aspects, the salt present in the loading buffer is NaCl. In some aspects, the salt present in the loading buffer comprises a divalent salt, trivalent salt, or both. In some aspects, the divalent and/or trivalent salt is selected from the group consisting of calcium chloride, magnesium chloride, calcium sulfate, sodium sulfate, magnesium sulfate, chromium trichloride, chromium sulfate, sodium citrate, iron (III) chloride, yttrium (III) chloride, potassium phosphate, potassium sulfate, sodium phosphate, ferrous chloride, calcium citrate, magnesium phosphate, ferric chloride, and a combination thereof.

In some aspects, after a chromatography resin is contacted with the filtrate, the chromatography resin is subsequently contacted with a wash buffer (i.e., “washing step”). Accordingly, in some aspects, the methods provided herein for preparing purified EVs comprises (i) contacting a sample, which comprises EVs and one or more impurities, with a depth filter described herein (i.e., “depth filter-based clarification step”), (ii) collecting the filtrate from the depth filter-based clarification step, (iii) contacting the filtrate with a chromatography resin, such that one or more EVs of the filtrate bind to the chromatography resin (i.e., “loading step”), and (iv) contacting the chromatography resin with a wash buffer, wherein (iv) occurs after (iii) (i.e., contacting the filtrate with the chromatography resin). In certain aspects, the wash buffer comprises a nuclease. Non-limiting examples of nucleases include both endonuclease and exonuclease, such as a salt active nuclease (SAN), Benzonase, Denarase, Kryptonase, or any combination thereof. In some aspects, the wash buffer can further comprise an anion, cation (e.g., monovalent cation and/or divalent cation), or both. In some aspects, the wash buffer does not comprise a nuclease.

In some aspects, the chromatography resin is contacted with the wash buffer one time. In some aspects, the chromatography resin is contacted with the wash buffer multiple times (e.g., at least 2 times, at least 3 times, at least 4 times, or at least 5 times). Where multiple wash buffers are used, in some aspects, all of the wash buffers can comprise a nuclease. In some aspects, all of the wash buffers do not comprise a nuclease. In some aspects, some of the wash buffers comprise a nuclease while others do not.

In some aspects, after the one or more wash steps (i.e., contacting the chromatography resin with a wash buffer described herein), the EV purification methods disclosed herein further comprise contacting the chromatography resin with an elution buffer. In certain aspects, contacting of the chromatography resin with the elution buffer releases one or more of the attached EVs from the chromatography resin. In certain aspects, the methods provided herein further comprise collecting an eluent after contacting the chromatography resin with the elution buffer. Accordingly, in some aspects, an EV preparation method provided herein comprises: (i) contacting a sample, which comprises EVs and one or more impurities, with a depth filter described herein (e.g., a LA grade media depth filter (e.g., 60LA depth filter), a SP grade media depth filter, or both) (“depth filter-based clarification step”), (ii) collecting the filtrate from the depth filter-based clarification step, (iii) contacting the filtrate with a chromatography resin, such that one or more EVs of the filtrate bind to the chromatography resin, (iv) contacting the chromatography resin with a wash buffer (e.g., does not comprise a nuclease), and (v) eluting an eluent from the chromatography resin, wherein the eluent comprises the EVs. In some aspects, the method further comprises contacting the eluent with a nuclease treatment. In some aspects, the method further comprises subjecting the eluent to an additional depth filter-based clarification step. In some aspects, the additional depth filter-based clarification step comprises the same depth filter as in the earlier depth filter-based clarification step. In some aspects, the additional depth filter-based clarification step comprises a different depth filter. In some aspects, the eluent can be subjected to one or more additional chromatography steps (e.g., contacting the eluent with one or more additional chromatography resins).

As is apparent from the disclosure, the methods disclosed herein can greatly improve the purity of the EV preparation produced. Accordingly, in certain aspects, concentration of the EVs present in the eluent is increased compared to the concentration of the EVs present in a reference eluent (e.g., an eluent from a corresponding chromatography but where the sample was not contacted with a depth filter described herein (e.g., the 60LA depth filter) prior to the chromatography and/or any other time during the purification process).

In some aspects, the concentration of the EVs present in the eluent is increased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the concentration of the EVs present in the reference eluent. In some aspects, the amount of one or more impurities present in the eluent is decreased compared to the amount of the one or more impurities present in the reference eluent. In some aspects, the amount of the one or more impurities present in the eluent is decreased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the amount of the one or more impurities present in the reference eluent.

As described elsewhere in the present disclosure, a product's particle size and polydispersity index can depend on the purification level of the product. Accordingly, in some aspects, using the methods disclosed herein, a mean particle size of the eluent is reduced compared to a reference mean particle size (e.g., mean particle size of the reference eluent). In some aspects, the mean particle size of the eluent is reduced by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the reference mean particle size. In some aspects, the mean particle size of the eluent is between about 20 nm to about 300 nm (e.g., between about 40 nm to about 200 nm). In some aspects, the mean particle size of the eluent is about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, or about 300 nm. In some aspects, a polydispersity index of the eluent is reduced compared to a reference polydispersity index (e.g., polydispersity index of the reference eluent). In some aspects, the polydispersity index of the eluent is reduced by at least about 10%, at least about 20%, at least about 30%, at least about 40%, at least about 50%, at least about 60%, at least about 70%, at least about 80%, or at least about 90% or more, compared to the reference polydispersity index.

In some aspects, EV preparation produced using the methods described above can be further purified by subjecting the preparation to one or more additional chromatography steps (e.g., by contacting the EV preparation to one or more additional chromatography resins). In certain aspects, the one or more additional chromatography resins comprise an anion exchange chromatography (AEX) resin, a cation exchange chromatography (CEX) resin, a mixed mode chromatography (MMC) resin, hydrophobic charge induction chromatography resin, a hydrophobic interaction chromatography resin, or any combination thereof.

Additional disclosure relating to the different aspects of the present methods are provided below.

### II.A. Buffers (e.g., Wash Buffers, Loading Buffers, Elution Buffers)

In some aspects, EV preparation methods provided herein comprise the use of one or more buffers. As described further below, in some aspects, methods provided herein comprise contacting a chromatography resin with a wash buffer. In some aspects, methods provided herein comprise contacting a sample comprising EVs (e.g., filtrate collected after the depth filter-based clarification step) with a chromatography resin, wherein the contacting is performed in a loading buffer. In some aspects, methods provided herein comprise contacting a chromatography resin (e.g., which was previously contacted with a sample comprising EVs) with an elution buffer. Unless indicated otherwise, disclosures relating to one type of buffers can equally apply to the other buffers described herein.

Certain aspects of the present disclosure are directed to a method comprising contacting a chromatography resin with a wash buffer (e.g., after contacting the filtrate collected from the depth filter-based clarification step to the chromatography resin) (i.e., “wash step”). In some aspects, the wash buffers used herein comprise (i) a nuclease and (ii) a cation. In some aspects, the wash buffer comprises a cation but does not comprise a nuclease.

In some aspects, the chromatography resin is contacted with the wash buffer one time (i.e., single wash step). In some aspects, the chromatography resin is contacted with the wash buffer at least two times, e.g., the method comprises contacting the chromatography resin with a wash buffer, allowing the wash buffer to pass through the chromatography resins, and then contacting the chromatography resin with a wash buffer a second time (i.e., multiple wash steps). In some aspects, the chromatography resin is contacted with the wash buffer at least three times. In some aspects, the chromatography resin is contacted with the wash buffer at least four times. In some aspects, the chromatography resin is contacted with the wash buffer at least five times. In some aspects, where multiple wash steps are involved, each of the multiple wash buffers are the same. In some aspects, one or more of the multiple wash buffers are different. In some aspects, each of the wash buffers is different. For instance, in some aspects, each of the multiple wash buffers do not comprise a nuclease. In some aspects, some of the wash buffers comprise a nuclease while other wash buffers do not comprise a nuclease. Where each of the wash buffers do not comprise a nuclease (e.g., but comprises a salt, such as a magnesium salt), in some aspects, the eluent (resulting from contacting chromatography resin with an elution buffer) can be collected and subsequently treated with a nuclease (e.g., those described herein). In some aspects, the flow through (resulting from contacting the wash buffer with the chromatography resin) can be collected and subsequently treated with a nuclease (e.g., those described herein). In some aspects, the nuclease-treated flow through and/or eluent can be contacted with one or more additional chromatography resins (e.g., either the same chromatography resin or a different chromatography resin).

In some aspects, the wash buffer is contacted with the chromatography resin, and the flow through is blocked, wherein the wash buffer remains in contact with the chromatography resin for a period of time.

In some aspects, the wash buffer is contacted with the chromatography resin, and the flow through is collected and contacted again with the chromatography resin. In some aspects, the flow through is circulated back to contact the chromatography resin a second time.

As is apparent from at least the above disclosure, in some aspects, a method provided herein (e.g., method of preparing purified EVs) comprises (i) contacting the filtrate (i.e., obtained after contacting the sample comprising the EVs with a depth filter described herein (e.g., the 60LA filter)) with a chromatography resin, and (ii) contacting the chromatography resin with a wash buffer (i.e., washing); wherein the (ii) washing follows (i) (i.e., contacting the filtrate with the chromatography resin).

As described herein, in some aspects, a sample comprising EVs (e.g., the sample prior to the depth filter-based clarification step described herein, the filtrate collected after the depth filter-based clarification step, flow through collected after the chromatography resin is contacted with a wash buffer, and/or eluent collected after the chromatography resin is contacted with an elution buffer) is contacted with a nuclease treatment at one or more stages of the purification process. In some aspects, a sample comprising the EVs (e.g., filtrate collected after the depth filter-based clarification step) is contacted with a nuclease treatment prior to contacting the sample with a chromatography resin. In some aspects, a sample comprising the EVs is contacted with a nuclease treatment during a chromatography step (e.g., washing the chromatography resin with a wash buffer comprising a nuclease). In some aspects, a sample comprising the EVs is contacted with a nuclease treatment after the chromatography step (e.g., collecting the eluent from the chromatography step and contacting the eluent with a nuclease treatment). In some aspects, any combination of the samples described above can be contacted with a nuclease treatment. For instance, in some aspects, an EV preparation method provided herein comprises: (i) contacting a sample, which comprises EVs and one or more impurities, with a depth filter described herein (a LA grade media depth filter (e.g., 60LA depth filter), a SP grade media depth filter, or both) (“depth filter-based clarification step”), (ii) collecting the filtrate from the depth filter-based clarification step, (iii) contacting the filtrate with a chromatography resin, such that one or more EVs of the filtrate bind to the chromatography resin, (iv) contacting the chromatography resin with a nuclease wash buffer, (vi) eluting an eluent from the chromatography resin, wherein the eluent comprises the EVs, and (vii) contacting the eluent with a second nuclease treatment. In some aspects, the second nuclease treatment and the nuclease wash buffer comprise the same nuclease. In some aspects, the second nuclease treatment and the nuclease wash buffer comprises different nucleases.

As described herein, in some aspects, a wash buffer (or any other buffers described herein) that can be used with the methods provided herein comprises a cation. Any cation can be used in the wash buffers disclosed herein. In some aspects, the cation is a monovalent cation. In some aspects, the monovalent cation is selected from Li⁺, K⁺, Na⁺, NH4⁺, Cu⁺, and any combination thereof. In some aspects, the cation is a divalent cation. In some aspects, the divalent cation is selected from Ca²⁺, Mg²⁺, Co²⁺, Ni²⁺, Zn²⁺, Ba²⁺, Sr²⁺, Al²⁺, Ag²⁺, Cu²⁺, Mn²⁺, and any combination thereof.

In some aspects, the cation is associated with an anion, e.g., in a salt. Accordingly, in some aspects, the wash buffer comprises a salt, wherein the salt comprises a cation disclosed herein and an anion. In some aspects, the salt comprises a cation disclosed herein and an anion selected from SCN⁻, Cl⁻, SO₄⁻, PO₄⁻, and any combination thereof.

In some aspects, the wash buffer (or any other buffers described herein, e.g., loading buffer and/or elution buffer) comprises MgCl₂, Mg(SCN)₂, Mg(SO₄)₂, Mg(PO₄)₂, or any combination thereof. In some aspects, the buffer comprises MgCl₂. In some aspects, the wash buffer comprises SAN and MgCl₂. In some aspects, the wash buffer comprises SAN and CaCl₂. Non-limiting examples of other salts that can be included in the different buffers described herein include: NaCl, KCl, PO₄, CaCl₂, ZnCl2, MnCl2, MnSO4, NaSCN, KSCN, LiCl, NaPO4, K2HPO4, Na2SO4, K2SO4, NaAcetate, sodium chloride, potassium chloride, sodium bromide, lithium chloride, sodium iodide, potassium bromide, lithium bromide, sodium fluoride, potassium fluoride, lithium fluoride, lithium iodide, sodium acetate, potassium acetate, lithium acetate, potassium iodide, calcium sulfate, sodium sulfate, magnesium sulfate, chromium trichloride, chromium sulfate, sodium citrate, iron (III) chloride, yttrium (III) chloride, potassium phosphate, potassium sulfate, sodium phosphate, ferrous chloride, calcium citrate, magnesium phosphate, ferric chloride, and any combination thereof.

### II.B. Chromatography Resins

As described herein, certain aspects of the present disclosure are directed to methods of preparing purified EVs from a sample comprising EVs and one or more impurities, comprising: (i) contacting a filtrate collected after contacting the sample with a depth filter (e.g., LA grade media depth filter or SP grade media depth filter) (e.g., a 60LA filter) (i.e., “loading step”) with a chromatography resin, and (ii) contacting the chromatography resin with a wash buffer (i.e., “washing step”), wherein the (ii) washing step follows the (i) loading step. As demonstrated herein, these methods are useful for reducing the level of impurities in a sample comprising EVs. As such, the methods disclosed herein can be performed using any chromatography resin.

In some aspects, the chromatography resin comprises an ion exchange chromatography resin. In certain aspects, the chromatography resin comprises an anion exchange (AEX) resin. In some aspects, the chromatography resin comprises a cation exchange (CEX) resin. In some aspects, the chromatography resin comprises a mixed-mode chromatography (MMC) resin. In some aspects, the chromatography resin comprises a hydrophobic interaction resin. In some aspects, the chromatography resin comprise a ceramic hydroxyapatite resin. In some aspects, the chromatography resin comprise a fluoro hydroxyapatite resin. In some aspects, the chromatography resin comprise a combination of one or more chromatography resin disclosed herein.

In certain aspects, the method provided herein comprises (i) contacting a sample comprising EVs (e.g., filtrate collected after the depth filter-based clarification step) with an AEX chromatography resin and (ii) contacting the AEX chromatography resin with a nuclease wash buffer. In some aspects, the method provided herein comprises (i) contacting a sample comprising EVs (e.g., filtrate collected after the depth filter-based clarification step) with an AEX chromatography resin and (ii) contacting the AEX chromatography resin with a wash buffer, which does not comprise a nuclease. In some aspects, the method further comprises subjecting a sample comprising EVs (e.g., eluent from the first chromatography step) to one or more additional chromatography resins. In some aspects, the one or more additional chromatography resins comprise an additional AEX resin, a CEX resin, a MMC resin, a hydrophobic charge induction chromatography resin, a hydrophobic interaction chromatography resin, or any combination thereof.

For instance, in some aspects, after the contacting with an AEX resin, the sample comprising EVs (e.g., eluent collected after contacting with the AEX resin) is contacted with a CEX resin. In some aspects, after the contacting with the CEX resin, the sample comprising EVs (e.g., eluent collected after contacting with the CEX resin) is contacted with a MMC resin. In some aspects, after the contacting with an AEX resin, the sample comprising EVs (e.g., eluent collected after contacting with the AEX resin) is contacted with one or more MMC resins. In certain aspects, the sample comprising EVs is contacted with (i) the AEX resin, (ii) a CEX resin, and (iii) a MMC resin, in the sequence (i), (ii), then (iii). In some aspects, the sample comprising EVs is contacted with (i) the AEX resin, (ii) a first MMC resin, and (iii) a second MMC resin, in the sequence of (i), (ii), and (iii).

In some aspects, the sample comprising EVs is contacted with (a) an AEX resin, (b) a CEX resin, and (c) a MMC resin; wherein after the sample is contacted with the AEX resin, the AEX resin is contacted with a wash buffer (e.g., lacking nuclease or nuclease wash buffer). In some aspects, the sample comprising EVs is contacted with (a) an AEX resin, (b) a CEX resin, and (c) a MMC resin; wherein after the sample is contacted with the CEX resin, the CEX resin is contacted with a wash buffer (e.g., lacking nuclease or nuclease wash buffer). In some aspects, the sample comprising EVs is contacted with (a) an AEX resin, (b) a CEX resin, and (c) n MMC resin; wherein after the sample is contacted with the MMC resin, the MMC resin is contacted with a wash buffer (e.g., lacking nuclease or nuclease wash buffer).

In some aspects, the sample comprising EVs (e.g., filtrate collected after the depth filter-based clarification step described herein) is contacted with (a) an AEX resin, (b) a CEX resin, and (c) n MMC resin; wherein (i) after the sample is contacted with the AEX resin, the AEX resin is contacted with a wash buffer (e.g., lacking nuclease and/or nuclease wash buffer); and wherein (ii) after the sample is contacted with the CEX resin, the CEX resin is contacted with a wash buffer (e.g., lacking nuclease and/or nuclease wash buffer). In some aspects, the sample comprising EVs (e.g., filtrate collected after the depth filter-based clarification step described herein) is contacted with (a) an AEX resin, (b) a CEX resin, and (c) a MMC resin; wherein (i) after the sample is contacted with the AEX resin, the AEX resin is contacted with a wash buffer (e.g., lacking nuclease and/or nuclease wash buffer): and wherein (ii) after the sample is contacted with the MMC resin, the MMC resin is contacted with a wash buffer (e.g., lacking nuclease and/or nuclease wash buffer). In some aspects, the sample comprising EVs (e.g., filtrate collected after the depth filter-based clarification step described herein) is contacted with (a) an AEX resin, (b) a CEX resin, and (c) a MMC resin; wherein (i) after the sample is contacted with the CEX resin, the CEX resin is contacted with a wash buffer (e.g., lacking nuclease and/or nuclease wash buffer); and wherein (ii) after the sample is contacted with the MMC resin, the MMC resin is contacted with a wash buffer (e.g., lacking nuclease and/or nuclease wash buffer). In some aspects, the sample comprising EVs (e.g., filtrate collected after the depth-filter based clarification step described herein) is contacted with (a) an AEX resin, (b) a CEX resin, and (c) a MMC resin; wherein (i) after the sample is contacted with the AEX resin, the AEX resin is contacted with a wash buffer (e.g., lacking nuclease and/or nuclease wash buffer); wherein (ii) after the sample is contacted with the CEX resin, the CEX resin is contacted with a wash buffer (e.g., lacking nuclease and/or nuclease wash buffer); and wherein (iii) after the sample is contacted with the MMC resin, the MMC resin is contacted with a wash buffer (e.g., lacking nuclease and/or nuclease wash buffer).

In some aspects, the one or more chromatography steps of an EV purification method comprise: (i) CEX-AEX-MMC; (ii) CEX-MMC-AEX; (iii) CEX-AEX-AEX; (iv) CEX-MMC-MMC; (v) CEX-CEX-CEX; (vi) AEX-CEX-MMC; (vii) AEX-MMC-CEX; (viii) AEX-CEX-CEX; (ix) AEX-MMC-MMC; (x) AEX-AEX-AEX; (xi) MMC-CEX-AEX; (xii) MMC-AEX-CEX, (xiii) MMC-CEX-CEX; (xiv) MMC-AEX-AEX; (xv) MMC-MMC-MMC; or (xvi) any combination thereof. In some aspects, the one or more chromatography steps of a method provided herein comprise CEX-AEX-MMC. In some aspects, the one or more chromatography steps comprise CEX-MMC-AEX. In some aspects, the one or more chromatography steps comprise CEX-AEX-AEX. In some aspects, the one or more chromatography steps comprise CEX-MMC-MMC. In some aspects, the one or more chromatography steps comprise CEX-CEX-CEX. In some aspects, the one or more chromatography steps of a method provided herein comprise AEX-CEX-MMC. In some aspects, the one or more chromatography steps comprise AEX-MMC-CEX. In some aspects, the one or more chromatography steps comprise AEX-CEX-CEX. In some aspects, the one or more chromatography steps comprise AEX-MMC-MMC. In some aspects, the one or more chromatography steps comprise AEX-AEX-AEX. In some aspects, the one or more chromatography steps comprise MMC-CEX-AEX. In some aspects, the one or more chromatography steps comprise MMC-AEX-CEX. In some aspects, the one or more chromatography steps comprise MMC-CEX-CEX. In some aspects, the one or more chromatography steps comprise MMC-AEX-AEX. In some aspects, the one or more chromatography steps comprise MMC-MMC-MMC.

For each chromatography (e.g., CEX, AEX, and MMC), various buffers (loading buffer, elution buffer, wash buffer, etc.) and conditions can be used to maximize the yield while removing the impurities as much as possible. In some aspects, each of the chromatography comprises a loading buffer, an elution buffer, and/or a wash buffer. In some aspects, the loading buffer and the elution buffer can be the same. In some aspects, the elution buffer and the wash buffer can be the same. In some aspects, the loading and wash buffers can be the same. In some aspects, the loading and wash buffers can be the same, but the elution buffer is different from the loading and wash buffers. In some aspects, the loading buffer, the elution buffer, and the wash buffer are the same.

In some aspects, CEX elution conditions can be designed to be the same as the AEX load conditions enabling straight through operation. In some aspects, CEX elution conditions can be designed to be the same as the AEX load conditions enabling straight through operation while the CEX loading conditions (e.g., a lower pH than the elution buffer) are different from the CEX elution conditions. In some aspects, AEX elution conditions can be designed to be the same as the MMC load conditions enabling straight through operation. Straight through processing can also be accomplished by integrated dilution or in-line titration of an elution and/or a load. In some aspects, CEX and AEX columns can be duplexed (placed inline in series) to enable operation of both columns in a single unit operation; the CEX column operated in flow-through or weak partitioning mode with the flow-through directly binding to the downstream AEX column. In some aspects, the product can be eluted from the AEX with a separate elution. In some aspects, to prevent fouling and maximize reuse of the downstream column, the two columns can be separated for strips and/or other phases.

In some aspects, selective loading, capture, elution, and/or wash can be achieved by changing salt, phosphate, or calcium concentrations, changing pH, altering temperature, adding organic modifiers, organic solvents, small molecules, detergents, zwitterions, amino acids, polymers, polyols (sucrose, glucose, trehalose, mannose, sorbitol, mannitol, glycerol, etc.), anti-oxidants (e.g., methionine), EDTA, EGTA, Polysorbate 20, Polysorbate 80, ethylene glycol, propylene glycol, polyethylene glycol, polypropylene glycol, and/or urea, adding excipients that alter the surface tension of the solution, adding excipients that alter the polarity of the solution, altering the residence time to take advantage of differential desorption rates between impurities and EVs, adding excipients that modulate the structure of the EVs, or any combination of the above.

In some aspects, substantial EV purity can be achieved by flowing through impurities during the column loading phase, eluting impurities during selective excipient washes, and/or by selectively eluting a target during elution while leaving additional impurities bound to the column. Absorbance measurements of column eluates can suggest changes (e.g., a significant reduction) in concentrations of proteins and nucleic acids. In some aspects, the interaction between the chromatographic resins (e.g., CEX, AEX, and/or MMC) and EVs is sufficient to enable direct capture from cell culture, clarified cell culture, concentrated cell culture, or partially purified in-process pools.

In some aspects, excipients can be used for the washing step for one or more chromatography processes (e.g., CEX, AEX, and/or MMC). Excipient washes can improve purity or further aid in enriching, depleting, or isolating sub-populations of EVs. In some aspects, the excipient can be a solution having specific pH ranges, salts, organic solvents, small molecules, detergents, zwitterions, amino acids, polymers, and any combination of the above.

In some aspects, the excipient can comprise arginine, lysine, glycine, histidine, calcium, sodium, lithium, potassium, iodide, magnesium, iron, zinc, manganese, urea, propylene glycol, aluminum, ammonium, guanidinium polyethylene glycol, EDTA, EGTA, a detergent, chloride, sulfate, carboxylic acids, sialic acids, phosphate, acetate, glycine, borate, formate, perchlorate, bromine, nitrate, dithiothreitol, beta mercaptoethanol, or tri-n-butyl phosphate.

In some aspects, the excipient can also comprise a detergent. In some aspects, the detergent is selected from cetyl trimethylammonium chloride, octoxynol-9, TRITON™ X-100 (i.e., polyethylene glycol p-(1,1,3,3-tetramethylbutyl)-phenyl ether) and TRITON™ CG-110 available from Sigma-Aldrich; sodium dodecyl sulfate; sodium lauryl sulfate; deoxycholic acid; Polysorbate 80 (i.e., Polyoxyethylene (20) sorbitan monooleate); Polysorbate 20 (i.e., Polyoxyethylene (20) sorbitan monolaurate); alcohol ethoxylate; alkyl polyethylene glycol ether; decyl glucoside; octoglucosides; SafeCare; ECOSURF™ EH9, ECOSURF™ EH6, ECOSURF™ EH3, ECOSURF™ SA7, and ECOSURF™ SA9 available from DOW Chemical; LUTENSOL™ M5, LUTENSOL™ XL, LUTENSOL™ XP and APG™ 325N available from BASF; TOMADOL™ 900 available from AIR PRODUCTS; NATSURF™ 265 available from CRODA; SAFECARE™ 1000 available from Bestchem, TERGITOL™ L64 available from DOW; caprylic acid; CHEMBETAINE™ LEC available from Lubrizol; Mackol DG, and mixtures thereof.

In some aspects, any unit operation (i.e., any step in the EV preparation process described herein) can be run in batch, semi-batch, semi-continuous, or continuous mode. In some aspects, surge tanks can be employed to enable semi-continuous or continuous processing.

In some aspects, the sequence of the chromatography process (e.g., AEX-MMC-MMC, CEX-AEX-MMC, or AEX-CEX-MMC) can be repeated at least two times, at least three times, at least four times, at least five times, at least six times, at least seven times, at least eight times, at least nine times, at least ten times, at least 11 times, at least 12 times, at least 13 times, at least 14 times, at least 15 times, at least 16 times, at least 17 times, at least 18 times, at least 19 times, or at least 20 times.

In some aspects, AEX and/or MMC columns (also referred to herein as “resins”) are duplexed (placed inline in series) to enable operation of both columns in a single until operation; the AEX column is operated in bind/elute mode with the elution loaded directly onto the MMC column operation in flow-through or weak partitioning mode. For instance, as described herein, in some aspects, a method of preparing purified EVs of the present disclosure comprises AEX-MMC-MMC chromatography steps, wherein the two MMC chromatography resins are duplexed. In some aspects, to prevent fouling and maximize reuse of the downstream column, the two columns can be separated for strips or other phases.

In some aspects, the methods of the present disclosure comprises two or more processes (e.g., two or more chromatography steps) connected for continuous manufacturing (e.g., purification). In some aspects, the continuous manufacturing (e.g., purification) processes are integrated with the bioreactor that produces the EVs.

### II.B.1. CEX Chromatography Resins

As described herein, in some aspects, a chromatography resin which can be used with the present methods comprises a CEX chromatography resin. As is apparent from the present disclosure, in some aspects, the CEX chromatography resin can be used alone or in combination with other chromatography resins (e.g., AEX-CEX-CEX). The CEX process is a form of ion exchange chromatography that separates samples based on their net surface charge. CEX specifically uses negatively charged ligands having affinity to targets having positive surface charges. Without being bound to any one theory, EVs can be amphoteric and have positive surface charges that can be exploited for CEX purification under certain purification conditions. Accordingly, in some aspects, the purification methods described herein can rely on positive charges of the surface proteins on the EVs that contain basic amino acids such as lysine and arginine and/or are complexed with bivalent positively charged metals. In addition, the presence of chromatin can offer an array of basic histone proteins for CEX binding.

Interactions between the ligands and EVs are influenced by several factors, such as cation exchangers, flow rate, particle size of the resin, binding capacity, or any combination thereof. In certain aspects, the present disclosure further provides conditions where EVs can be effectively isolated, purified or sub-fractionated with cation exchange ligands. In some aspects, the binding of EVs to CEX ligands (which can occur when the filtrate from the depth filter-based clarification step is contacted with a CEX chromatography resin) is strengthened in lower pH. In some aspects, the pH of the CEX loading buffer is from about 5.0 to about 7.0. In some aspects, the pH is from about 5.0 to about 8.5. In some aspects, the pH is about 5.0, about 5.5, about 6.0, about 6.5, about 7.0, about 7.5, about 8.0, or about 8.5. In some aspects, the binding of EVs to CEX ligands is strengthened in lower salt concentrations.

In some aspects, CEX is performed in a bind-elute mode. In some aspects, CEX is performed in a flow-through mode. In some aspects, CEX is performed in a weak-partitioning mode, where the EVs are bound more weakly that impurities which bind more strongly to the CEX resin.

In the weak-partitioning mode, at least some desired EVs and at least some undesired EVs or impurities, both bind to the chromatographic medium. However, undesired EVs or impurities bind more tightly to the medium. Unbound, desired EVs pass through the medium and are recovered from the column effluent. The binding between EVs and the chromatographic medium is intermediate in comparison to bind-elute and flow-through modes.

In some aspects, a loading phase (i.e., contacting of a sample comprising EVs with a chromatography resin) can be followed by a wash phase (i.e., contacting a chromatography resin with a wash buffer described herein) to increase recovery of the desired product. Washing can be done with a washing buffer identical to or different from the loading buffer. When different, the wash buffer is different from the loading buffer in terms of composition (e.g., presence or absence of a nuclease) and/or pH.

In some aspects, the pH of the CEX wash buffer is higher than the pH of the CEX loading buffer.

In certain aspects, various weak-partitioning purification methods, well-known in the art, can be combined with the methods disclosed in this application. For example, in some aspects, methods for identifying ideal conditions for the weak-partitioning mode or purification methods disclosed in the U.S. Publication No. 2007/0060741, which is incorporated by reference in its entirety herein, can be used

In certain aspects the CEX process is repeated multiple times.

### II.B.2. Anion Exchange Chromatography (AEX) Chromatography Resins

In some aspects, the chromatography resin that can be used with the present disclosure comprises an AEX chromatography resin. As is apparent from the present disclosure, in some aspects, the AEX chromatography resin can be used alone or in combination with other chromatography resins (e.g., AEX-MMC-MMC). AEX is another form of ion exchange chromatography that separates samples based on their surface charge. AEX uses positively charged ligands having affinity to targets having negative surface charges. In some aspects, the AEX can be performed on the sample comprising EVs after the sample has been subjected to a CEX (e.g., collecting the eluent from the CEX chromatography step and contacting the eluent to the AEX chromatography resin). In some aspects, the AEX can be performed on the sample comprising EVs before the sample has been subjected to a CEX. In some aspects, the AEX can be performed on the sample comprising EVs before the sample has been subjected to a MMC. In some aspects, the AEX can be performed on the sample comprising EVs after the sample has been subjected to a MMC (e.g., collecting the eluent from the MMC chromatography step and contacting the eluent to the AEX chromatography resin).

In some aspects, AEX is performed in a weak-partitioning mode. In some aspects, AEX is performed in flow-through mode. In some aspects, AEX is performed in a bind-elute mode.

In bind-elute mode, desired EVs bind to chromatographic medium and are eluted from the medium by elution buffers. These methods generally comprise the steps of applying or loading a sample comprising EVs, optionally washing away unbound sample components using appropriate buffers that maintain the binding interaction between EVs and affinity ligands and eluting (dissociating and recovering) EVs from the immobilized ligands by altering buffer conditions so that the binding interaction no longer occurs.

In some aspects, exchange resin can be eluted with a particular elution buffer and selected fractions of the eluate can be concentrated (e.g., by dialysis) to provide an enriched EV preparation. In certain aspects, the AEX resin used in the scalable method is of a sufficient size to accommodate large scale volumes of conditioned culture media. In some aspects, a second elution of the collected fractions from a first passage over an anion exchange column can be performed. In some aspects, the AEX is repeated multiple times. In some aspects, the AEX is repeated at least three times. In some aspects, the AEX is repeated at least four times. In some aspects, the AEX is repeated at least five times. In some aspects, the AEX is repeated at least six times.

AEX resin refers to a solid phase which is positively charged, e.g. having one or more positively charged ligands. In some aspects, the ligands are selected from diethylaminopropyl, diethylaminoethyl, quaternary aminoethyl, quaternary ammonium, carboxymethyl, carboxylic acid, glutamic acid, aspartic acid, histidine, hydroxyl, phosphate, tertiary amines, quaternary amines, diethaminoethyl, dimethylaminoethyl, trimethylaminoethyl, an amino acid ligand, or combinations thereof. Commercially available anion exchange resins include DEAE cellulose, QAE SEPHADEX and FAST Q SEPHAROSE (Pharmacia). In certain aspects the chromatography ligands can be bound to a base matrix. In some aspects, the base matrix can comprise monoliths, hydrogels, porous devices, nanofibers, composite resins, beaded resins, beaded resin with inert porous shells, and/or any other solid or porous support. In some aspects, the base matrix can comprise cellulose, agarose, polystyrene derivatives, polyvinyl ether, silica, methacrylate derivatives, glass, ceramic hydroxyapatite, acrylamide, and/or other backbones commonly used in chromatography.

In some aspects, binding of EVs to AEX ligands is strengthened in higher pH compared to the CEX process as described herein. In some aspects, binding of EVs to AEX ligands is strengthened in lower salt conditions compared to one or more chromatography processes, (e.g., CEX and/or MMC). Accordingly, the methods can further comprise the step of changing (raising or lowering) the salt concentration or pH of the sample before loading the sample to the AEX resin. In some aspects, the pH and the salt concentration for the AEX process are selected for inducing precipitation of contaminant proteins. In some aspects, the AEX chromatography is conducted at a pH from about 7 to about 10. In some aspects, the pH is about 7.0, about 7.5, about 8.0, about 8.5, about 9.0, about 9.5, or about 10.0. In some aspects, the pH of the AEX loading buffer is about 7.4.

### II.B.3. Multi-Modal Chromatography (MMC)

In some aspects, the chromatography resin that can be used with the methods described herein comprises a mixed mode chromatography (“MMC”) resin. As described herein, in some aspects, the MMC chromatography resin can be used alone or in combination with other chromatography resins (e.g., AEX or CEX). In some aspects, samples comprising EVs are purified by MMC after being purified by AEX (e.g., contacting the eluent from the AEX chromatography step with the MMC chromatography resin). In some aspects, samples comprising EVs are purified by MMC before being purified by AEX. In some aspects, samples comprising EVs are purified by MMC after being purified by CEX (e.g., contacting the eluent from the CEX chromatography step with the MMC chromatography resin). In some aspects, samples comprising EVs are purified by MMC before being purified by CEX.

As described herein, a depth filter-based clarification step described herein (e.g., contacting a sample comprising EVs to a depth filter selected from a LA media grade depth filter, a SP media grade depth filter, or both) can be performed at various time points of the purification process. For instance, in some aspects, samples purified by AEX or CEX are processed by depth filtration before further being processed by MMC (e.g., eluent from the AEX or CEX chromatography step is contacted with a depth filter described herein, and then the resulting filtrate is contacted with the MMC chromatography resin). In some aspects, adsorptive depth filter is used. In some aspects, an AEX-processed sample further processed by depth filtration is applied to MMC for purification.

Mixed mode chromatography employs chromatographic resins containing ligands possessing more than one type of functional groups. This unique property of mixed mode resin enables binding through multiple chromatographic modes in a single resin. Most resins in this class comprise a ligand containing a hydrophobic group (e.g. phenyl, benzyl, propyl, butyl, etc.) and a charged group (e.g. cation: sulfate, carboxylic acid, methyl carboxylic acid; or an anion: quaternary amine, diethylaminoethyl, diethylaminopropyl, or quaternary ammonium). However, some resins can also contain a hydrophilic group in place of the hydrophobic group, (e.g., silica, urea, polyethyleneimine, amino or amide groups, cyanopropyl, diol, or aminopropyl).

In some aspects, MMC resins comprises conventional chromatography ligands. In some aspects, the ligands are selected from tertiary amines, quaternary amines, diethaminoethyl, ceramic hydroxyapatite, ceramic fluoroapatite, butyl, hexyl, ether, hydroxyl, polypropylene glycol, phenyl, benzyl, sulfate, sulfopropyl, sulfobutyl, sulfoisobutyl, sulfoethyl, sulfonate, sulfonic acid, carboxymethyl, carboxylic acid, glutamic acid, aspartic acid, histidine, hydroxyl, phosphate ligands, and mixtures thereof.

In some aspects, the resins used in MMC comprise anion-exchange/reversed-phase (AEX/RP), cation-exchange/reversed phase (CEX/RP), anion-exchange/cation-exchange/reversed phase (AEX/CEX/RP), AEX/hydrophilic (AEX/HILIC), CEX-hydrophilic (CEX/HILIC), or AEX/CEX hydrophilic (AEX/CEX/HILIC).

In some aspects, mixed mode ligands can be immobilized on the base matrix. In some aspects, the base matrix comprises membranes, monoliths, beaded resins, nanofibers, and/or other absorptive or convective media. In some aspects, the base matrix comprises cellulose, agarose, polystyrene derivatives, silica, methacrylate derivatives, glass, ceramic hydroxyapatite, PVDF, PTFE, polyethersulfone, polypropylene, polyethylene, acrylamide, and/or any mixtures or derivatives thereof.

Mixed mode media comprising a single or plurality of ligands and a base matrix can be classified into four categories based on the arrangement of the ligand substrates on the base matrix. Type I media are mixtures of separation media, each with a single chemistry, packed to form a column. Type II media comprise substrates modified with a mixture of ligands having different functionalities, such as ion exchange, reverse phase, or hydrophilic phase properties. In Type III media, the functional ligands can be “embedded” in a hydrophobic chain, or in Type IV media, the hydrophobic chain can be “tipped” with the functional group. The mixed mode resins comprising a base matrix and one or more functional groups can be comprised of any of the types of media as described herein.

In some aspects, a MMC chromatography column is generated with the resin disclosed herein. The resin can be formed in a suspension, in slurry, or can be packed into a chromatography column.

In some aspects, the MMC chromatography column can further comprise conventional chromatography ligands selected from sulfate, tertiary amines, quaternary amines, carboxy methyl, carboxylic acids, diethaminoethyl, ceramic hydroxy apatite and ceramic fluoroapatite, or any combination thereof.

In some aspects, hydrophobic, hydrophilic, and/or ionic mixed mode ligands and the conventional chromatography ligands are displayed on the same resin. For example, the hydrophobic, hydrophilic, and/or ionic mixed mode ligands and the conventional chromatography ligands are immobilized on the base matrix (e.g., membranes, monoliths, beaded resins, nanofibers, and other absorptive or convective media). In some aspects, hydrophobic, hydrophilic, and/or ionic mixed mode ligands and chromatographic ligands are intermixed. In some aspects, hydrophobic, hydrophilic, and/or ionic mixed mode ligands and chromatographic ligands are displayed on separate layers.

In some aspects, mixed mode media comprises hydrophobic ligands. Hydrophobic ligands can be used to purify EVs based on their interaction with a nonpolar surface on EVs, an amphiphilic phospholipid bilayer membrane with embedded transmembrane proteins or an outer bilayer surface that is associated with a variety of proteins, nucleic acids, lipids, and carbohydrates. Hydrophobic groups of the biomolecules that are sufficiently exposed to the surface allow interaction with hydrophobic ligands. In some aspects, the hydrophobic ligands can be hydrophobic alkyl or aryl groups. In some aspects, the hydrophobic alkyl or aryl groups are selected from phenyl, ethyl, methyl, pentyl, heptyl, benzyl, octyl, butyl, hexyl, ether, hydroxyl, polypropylene glycol, and the like.

In some aspects, mixed mode media comprises hydrophilic ligands. Hydrophilic ligands can be used to purify EVs via flow through mode, or to purify desired subgroups of EVs. The amphiphilic surface of the EVs cannot bind to the hydrophilic ligands of the column, while polar impurities or proteins in the sample interact with the hydrophilic ligands. In some aspects, the hydrophilic ligands comprise, silica, urea, amino groups, amide groups, polyethyleneimine, cyanopropyl, diol, aminopropyl, and/or zwitterions such as sulnfoalkylbetaine.

In some aspects, mixed mode media comprises CEX ligands.

In some aspects, mixed mode media comprises AEX ligands.

In some aspects, MMC chromatography is performed in a bind-elute mode. In some aspects, MMC chromatography is performed in a weak-partitioning mode.

According to the present disclosure, additional chromatography process can be used in addition to the chromatography processes disclosed herein (e.g., CEX-AEX or CEX-AEX-MMC). In some aspects, the additional chromatography can be used instead of the MMC process. In some aspects, the additional chromatography can be used in addition to the CEX, AEX, and MMC. In some aspects, a CEX, such as a CMM HYPERCEL™ chromatography column, is operated in series with a MMC, such as a CaptoCore700™ column, operated in flowthrough mode. In some aspects, a CEX-MMC is operated in series in flow-through mode. In some aspects, a MMC-CEX is operated in series in flow-through mode.

In some aspects, the present method further comprises hydrophobic interaction chromatography (“HIC”). In some aspects, the present method further comprises hydrophobic charge induction chromatography (“HCIC”)

The HIC or HCIC uses hydrophobic ligands attached to a base matrix. In some aspects the base matrix comprises membranes, monoliths, beaded resins, nanofibers, and/or other absorptive or convective media. In some aspects, the base matrix comprises cellulose, agarose, polystyrene derivatives, silica, methacrylate derivatives, glass, ceramic hydroxyapatite, PVDF, PTFE, polyethersulfone, polypropylene, polyethylene, acrylamide, and/or any mixtures or derivatives thereof.

Purification of EVs by hydrophobic ligands is based on the interaction between the ligands and a nonpolar surface on EVs, an amphiphilic phospholipid bilayer membrane with embedded transmembrane proteins or an outer bilayer surface that is associated with a variety of proteins, nucleic acids, lipids, and carbohydrates. Hydrophobic groups of the biomolecules that are sufficiently exposed to the surface can interact with hydrophobic ligands.

In some aspects, hydrophobic ligands that can be used for the present disclosure include ligands comprising hydrophobic alkyl and/or aryl groups. In some aspects the hydrophobic alkyl or aryl group are selected from phenyl, ethyl, methyl, pentyl, heptyl, benzyl, octyl, butyl, hexyl, ether, hydroxyl, polypropylene glycol, and mixtures thereof.

### II.B.4. Affinity Chromatography

In some aspects, the chromatography resin that can be used with the methods described herein comprises an affinity chromatography resin. As is apparent from the present disclosure, in some aspects, an affinity chromatography resin can be used alone or in combination with other chromatography resins (e.g., AEX, CEX, or MMC). Affinity chromatography separates target molecules from non-target molecules in a mixture by utilizing highly specific binding between the affinity chromatography resin and the target molecule. In some aspects, the affinity chromatography resin interacts with the EVs. In some aspects, the affinity chromatography resin comprises a binding moiety, wherein the binding moiety interacts with a target protein on the surface of the EV. In some aspects, the binding moiety interacts with a scaffold protein. In some aspects, the binding moiety interacts with PTGFRN. In some aspects, the binding moiety interacts with a fragment of PTGFRN. In some aspects, the binding moiety interacts with a Scaffold X protein. In some aspects, the chromatography resin comprises a pseudo affinity chromatography resin.

### II.C Samples Comprising EVs

Samples comprising EVs useful for the present methods can be obtained from a various in vitro cell culture or a harvest or a supernatant of the cell culture. In some aspects, the sample comprising EVs can be obtained from a mammalian cell, a bacterial cell, a eukaryotic cell, a prokaryotic cell, a plant cell, an insect cell, or any combination thereof. In some aspects, the sample comprising EVs can be obtained from a mammalian cell. In some aspects, the sample comprising EVs can be obtained from a HEK cell culture. In some aspects, the sample comprising EVs can be a cell culture comprising cells producing EVs.

The present disclosure provides a method for preparing EVs, which can be implemented to purify EVs in a large scale. In some aspects, the method can be applied to purify EVs from a sample with a volume larger than about 1 L, larger than about 5 L, larger than about 10 L, larger than about 15 L, larger than about 20 L, larger than about 25 L, larger than about 50 L, larger than about 100 L, larger than about 200 L, larger than about 250 L, larger than about 300 L, large than about 350 L, larger than about 400 L, larger than about 450 L, larger than about 500 L, larger than about 600 L, larger than about 700 L, larger than about 800 L. larger than about 900 L, larger than about 1,000 L, larger than about 2,000 L, larger than about 3,000 L, larger than about 4,000 L, larger than about 5,000 L, larger than about 6,000 L, larger than about 7,000 L, larger than about 8,000 L, larger than about 9,000 L, larger than about 10,000 L, larger than about 11,000 L, larger than about 12,000 L, larger than about 13,000 L, larger than about 14,000 L, or larger than about 15,000 L.

In some aspects, the method can be applied to purify EVs from a sample with a volume of about 400 L. In some aspects, the method can be applied to purify EVs from a sample with a volume of about 500 L. In some aspects, the method can be applied to purify EVs from a sample with a volume of about 600 L. In some aspects, the method can be applied to purify EVs from a sample with a volume larger than about 100 L. In some aspects, the method can be applied to purify EVs from a sample with a volume larger than about 200 L. In some aspects, the method can be applied to purify EVs from a sample with a volume of about 250 L. In some aspects, the method can be applied to purify EVs from a sample with a volume larger than about 300 L. In some aspects, the method can be applied to purify EVs from a sample with a volume of about 350 L. In some aspects, the method can be applied to purify EVs from a sample with a volume larger than about 700 L. In some aspects, the method can be applied to purify EVs from a sample with a volume larger than about 1,000 L. In some aspects, the method can be applied to purify EVs from a sample with a volume larger than about 1,500 L. In some aspects, the method can be applied to purify EVs from a sample with a volume larger than about 2,000 L.

In some aspects, the cell culture media useful for the present methods comprises 3D suspension culture comprising high-depth chemically defined media. In some aspects, the method of the present disclosure includes continuous manufacturing processes. In some aspects, the methods comprise continuous manufacturing processes at high cell density (e.g., at least about 50×10⁶ cells/ml, at least about 60×10⁶ cells/ml, at least about 70×10⁶ cells/ml, at least about 80×10⁶ cells/ml, at least about 90×10⁶ cells/ml, at least about 100×10⁶ cells/ml, at least about 110×10⁶ cells/ml, at least about 120×10⁶ cells/ml, at least about 130×10⁶ cells/ml, at least about 140×10⁶ cells/ml, at least about 150×10⁶ cells/ml, at least about 200×10⁶ cells/ml, at least about 250×10⁶ cells/ml, at least about 300×10⁶ cells/ml, at least about 350×10⁶ cells/ml, or at least about 400×10⁶ cells/ml, e.g., about 40×10⁶ cells/ml to about 200×10⁶ cell/ml, e.g., about 50×10⁶ cells/ml to about 170×10⁶ cell/ml, e.g., about 50×10⁶ cells/ml to about 150×10⁶ cell/ml).

In some aspects, each sample has a volume of about 500 L and the 500 L volume sample goes through the purification step (e.g., CEX; AEX; Affinity; CEX and AEX; CEX, AEX, and MMC; AEX, MMC, MMC; or any other combinations thereof) as described herein. In some aspects, the total amount of sample that goes through the purification step for each batch is at least about 5,000 L, at least about 6,000 L, at least about 7,000 L, at least about 8,000 L, at least about 9,000 L, at least about 10,000 L, at least about 11,000 L, at least about 12,000 L, at least about 13,000 L, at least about 14,000 L, or at least about 15,000 L. In some aspects, the total amount of sample that goes through the purification step for each batch is at least about 10,000 L. In some aspects, the total amount of sample that goes through the purification step for each batch is at least about 15,000 L. In some aspects, the total amount of sample that goes through the purification step for each batch is at least about 20,000 L.

In some aspects, the EVs that can be purified by the present methods comprise naturally-occurring EVs. In some aspects, the EVs that can be purified by the present methods comprise engineered EVs. In some aspects, the EVs that can be purified by the present methods comprise surface-engineered EVs, e.g., exosomes. In some aspects, the EVs that can be purified by the present methods comprise engineered EVs, e.g., exosomes that contain one or more (heterologous) moieties in the lumen of the EVs, e.g., exosomes (e.g., encapsulated in the EVs). In some aspects, the EVs that can be purified by the present methods comprise engineered EVs that contain one or more (heterologous) moieties linked to a moiety on the exterior surface of the EVs. In some aspects, the EVs that can be purified by the present methods comprise engineered EVs that contain one or more (heterologous) moieties linked to a moiety on the luminal surface of the EVs.

In some aspects, the EVs from the producer cell can have a longest dimension of from about 20 to about 1000 nm. In some aspects, the EVs from the producer cell can have a longest dimension of from about 20 to about 900 nm, from about 20 to about 800 nm, from about 20 to about 700 nm, from about 20 to about 600 nm, from about 20 to about 500 nm, from about 20 to about 400 nm, from about 20 to about 350 nm, from about 20 to about 300 nm, from about 20 to about 290 nm, from about 20 to about 280 nm, from about 20 to about 270 nm, from about 20 to about 260 nm, from about 20 to about 250 nm, from about 20 to about 240 nm, from about 20 to about 230 nm, from about 20 to about 220 nm, from about 20 to about 210 nm, from about 20 to about 200 nm, from about 20 to about 190 nm, from about 20 to about 180 nm, from about 20 to about 170 nm, about 20 to about 160 nm, from about 20 to about 150 nm, from about 20 to about 140 nm, about 20 to about 130 nm, from about 20 to about 120 nm, In some aspects, the EVs from the producer cell can have a longest dimension of from about 20 to about 110 nm, from about 20 to about 100 nm, from about 20 to about 90 nm, In some aspects, the EVs from the producer cell can have a longest dimension of from about 20 to about 80 nm, from about 20 to about 70 nm, from about 20 to about 60 nm, from about 20 to about 50 nm, from about 20 to about 40 nm, from about 20 to about 30 nm, from about 30 to about 300 nm, from about 30 to about 290 nm, from about 30 to about 280 nm, from about 30 to about 270 nm, from about 30 to about 260 nm, from about 30 to about 250 nm, from about 30 to about 240 nm, from about 30 to about 230 nm, from about 30 to about 220 nm, about 30 to about 210 nm, from about 30 to about 200 nm, from about 30 to about 190 nm, from about 30 to about 180 nm, from about 30 to about 170 nm, from about 30 to about 160 nm, from about 30 to about 150 nm, from about 30 to about 140 nm, from about 30 to about 130 nm, from about 30 to about 120 nm, from about 30 to about 110 nm, from about 30 to about 100 nm, from about 30 to about 90 nm, from about 30 to about 80 nm, from about 30 to about 70 nm, or from about 30 to about 60 nm.

In some aspects, EV membranes comprise lipids and/or fatty acids. In some aspects, EV membranes comprise phospholipids, glycolipids, fatty acids, sphingolipids, phosphoglycerides, sterols, cholesterols, and/or phosphatidylserines. In some of these aspects, EV membranes further comprise one or more polypeptides and/or one or more polysaccharides, such as glycan.

In some aspects, EV membranes comprise one or more molecules derived from the producer cell. In some aspects, EVs can be generated in a cell culture system and isolated from the producer cell. In some aspects, EVs can be generated from a perfusion cell culture. In some aspects, EVs can be generated from a batch cell culture. In some aspects, EVs can be generated from a fed batch cell culture. In some aspects, EVs can be generated from suspension or adherent cells. In some aspects, EVs can be generated from a HEK293 cell, a CHO cell, a BHK cell, a PERC6 cell, a Vero cell, a HeLa cell, a sf9 cell, a PC12 cell, a mesenchymal stem cell, a human donor cell, a stem cell, a dendritic cell, an antigen presenting cell, an induced pluripotent stem cell (IPC), a differentiated cell, bacteria, Streptomyces, Drosophila, Xenopus oocytes, Escherichia coli, Bacillus subtilis, yeast, S. cerevisiae, Picchia pastoris, filamentous fungi, Neurospora crassa, and/or Aspergillus nidulans. In some aspects, the producer cell is a HEK293 cell. The process of EV generation would be generally applicable to bioreactor formats including AMBR, shake flasks, SUBs, Waves, Applikons, stirred tanks, CSTRs, adherent cell culture, hollow fibers, iCELLis, microcarriers, and other methods known to those of skill in the art.

The present disclosure also includes extracellular vesicles (EVs) produced by a cell line. The production of extracellular vesicles and maintenance of cell culture conditions are important to maintain viable cell density of a cell culture process and consistently produce high-quality extracellular vesicles over the full length of a cell culture process. In some aspects, the EVs purified by the present methods are produced in a bioreactor. In some aspects, the EVs purified by the present methods are produced in a single-use bioreactor. In some aspects, the EVs purified by the present methods are produced in a perfusion bioreactor. In some aspects, the EVs purified by the present methods are produced in an alternating tangential flow filtration (ATF) perfusion bioreactor. In some aspects, the EVs purified by the present methods are produced in a tangential flow filtration (TFF) perfusion bioreactor. In some aspects, the EVs purified by the present methods are produced in a bioreactor at a viable cell density (VCD) of about 1×10⁶ cells/mL, about 5×10⁶ cells/mL, about 10×10⁶ cells/mL, about 20×10⁶ cells/mL, about 30×10⁶ cells/mL, about 40×10⁶ cells/mL, about 50×10⁶ cells/mL, or about 60×10⁶ cells/mL. In some aspects, the EVs purified by the present methods are produced in a bioreactor at a viable cell density (VCD) of about 60×10⁶ cells/mL. In some aspects, the EVs purified by the present methods are produced in a bioreactor at a viable cell density (VCD) of about 50×10⁶ cells/mL. In some aspects, the EVs purified by the present methods are produced in a bioreactor at a viable cell density (VCD) of from about 0 cells/mL to about 90×10⁶ cells/mL, e.g., from about 0 to about 60×10⁶ cells/mL, from about 1×10⁶ cells/mL to about 60×10⁶ cells/mL, from about 40×10⁶ cells/mL to about 60×10⁶ cells/mL, or from about 50×10⁶ cells/mL to about 60×10⁶ cells/mL.

In some aspects, the EVs purified by the present methods are produced in a bioreactor for about 5 days, about 10 days, about 15 days, about 20 days, about 25 days, or about 30 days. In some aspects, the EVs purified by the present methods are produced in a bioreactor for about 1-30 days, about 1-45 days, about 1-60 days, about 1-10 days, about 5-10 days, or about 1-25 days. In some aspects, the FVs purified by the present methods are produced in a bioreactor for about 1-30 days.

In some aspects, EVs are modified by altering components of the membrane of the EV. In some of these aspects, EVs are modified by altering the protein, lipid and/or glycan content of the membrane. In some aspects, EVs are engineered to express a scaffold moiety, e.g., Scaffold X, Scaffold Y, or any other moieties. In some aspects, EVs are engineered to express a higher number of one or more proteins naturally expressed on the surface of producer cells or EVs.

In some aspects, the producer cells naturally contain one or more polypeptides, and EVs derived from the producer cell also contain the one or more polypeptides. In some aspects, the producer cells are modified to contain one or more polypeptides. In some aspects, the modification comprises modulating expression of the one or more polypeptides through use of agents that alter endogenous gene expression. In some aspects, the modification comprises modulating expression of the one or more polypeptides through introduction of expression constructs or mRNAs that encode the one or more polypeptides. In some aspects, EVs produced by these cells include the one or more polypeptides as a payload.

In some aspects, the payload comprises an adjuvant. Non-limiting examples of adjuvants that can be used with the present disclosure include: Stimulator of Interferon Genes (STING) agonist, a toll-like receptor (TLR) agonist, an inflammatory mediator, RIG-I agonists, alpha-gal-cer (NKT agonist), heat shock proteins (e.g., HSP65 and HSP70), C-type lectin agonists (e.g., beta glucan (Dectin 1), chitin, and curdlan), and combinations thereof.

In some aspects, the payload comprises a cytokine or a binding partner of a cytokine. In some aspects, the cytokine is selected from (i) common gamma chain family of cytokines; (ii) IL-1 family of cytokines; (iii) hematopoietic cytokines; (iv) interferons (e.g., type I, type II, or type III); (v) TNF family of cytokines; (vi) IL-17 family of cytokines; (vii) damage-associated molecular patterns (DAMPs); (viii) tolerogenic cytokines; or (ix) combinations thereof. In certain aspects, the cytokine comprises IL-2, IL-4, IL-7, IL-10, IL-12, IL-15, IL-21, IFN-γ, IL-1α, IL-1β, IL-1ra, IL-18, IL-33, IL-36α, IL-36β, IL-36γ, IL-36ra, IL-37, IL-38, IL-3, IL-5, IL-6, IL-11, IL-13, IL-23, granulocyte-macrophage colony stimulating factor (GM-CSF), granulocyte-colony stimulating factor (G-CSF), leukemia inhibitory factor (LIF), stem cell factor (SCF), thrombopoietin (TPO), macrophage-colony stimulating factor (M-CSF), erythropoictin (EPO), Flt-3, IFN-α, IFN-β, IFN-γ, IL-19, IL-20, IL-22, IL-24, TNF-α, TNF-β, BAFF, APRIL, lymphotoxin beta (TNF-γ), IL-17A, IL-17B, IL-17C, IL-17D, IL-17F, IL-17F, IL-25, TSLP, IL-35, IL-27, TGF-β, or combinations thereof.

In some aspects, the payload comprises a chemokine. In certain aspects, chemokine comprises a (i) CC chemokine (e.g., CCL1, CCL2, CCL3, CCL4, CCL5, CCL6, CCL7, CCL8, CCL9, CCL10, CCL11, CCL12, CCL13, CCL14, CCL15, CCL16, CCL17, CCL18, CCL19, CCL20, CCL21, CCL22, CCL23, CCL24, CCL25, CCL26, CCL27, CCL28); (ii) CXC chemokine (e.g., CXCL1, CXCL2, CXCL3, CXCL4, CXCL5, CXCL6, CXCL7, CXCL8, CXCL9, CXCL10, CXCL11, CXCL12, CXCL13, CXCL14, CXCL15, CXCL16, CXCL17); (iii) C chemokine (e.g., XCL1, XCL2); (iv) CX3C chemokine (e.g., CX3CL1); (v) or combinations thereof. In some aspects, the payload is IL-12.

In some aspects, a payload is a TLR agonist. Non-limiting examples of TLR agonists include: TLR2 agonist (e.g., lipoteichoic acid, atypical LPS, MALP-2 and MALP-404, OspA, porin, LcrV, lipomannan, GPI anchor, lysophosphatidylserine, lipophosphoglycan (LPG), glycophosphatidylinositol hsp60, gH/gL glycoprotein, hemagglutinin), a TLR3 agonist (e.g., double-stranded RNA, e.g., poly(I:C)), a TLR4 agonist (e.g., lipopolysaccharides (LPS), lipoteichoic acid, β-defensin 2, fibronectin EDA, HMGB1, snapin, tenascin C), a TLR5 agonist (e.g., flagellin), a TLR6 agonist, a TLR7/8 agonist (e.g., single-stranded RNA, CpG-A, Poly G10, Poly G3, Resiquimod), a TLR9 agonist (e.g., unmethylated CpG DNA), and combinations thereof. Non-limiting examples of TLR agonists can be found at WO2008115319A2, US20130202707A1, US20120219615A1, US20100029585A1, WO2009030996A1, WO2009088401A2, and WO2011044246A1, each of which is incorporated by reference in its entirety.

In some aspects, the payload is a proteolysis-targeting chimera (PROTAC). PROTACs are heterobifunctional molecules consisting of a ligand to a target protein, a ligand to the E3 ubiquitinating ligase, and a linker connecting the two ligands. Once the target: PROTAC:E3 ternary complex is formed, E2 ubiquitin-conjugating enzymes transfer ubiquitin to lysine residues on the surface of the target protein. In some aspects, the PROTAC target is, e.g., ERα, BCR-ABL, BRD4, PDE4, ERRα, RIPK2, c-ABL, BRD2, BRD3, BRD4, FKBP12, TBK1, BRD9, EGFR, c-Met, Sirt2, CDK9, FLT3, BTK, ALK, AR, TRIM24, SMAD3, RAR, PI3K, PCAF, METAP2, HER2, HDAC6, GCN5, ERK 1/2, DHODH, CRABP-II, FLT4, or CK2. In some aspects, the PROTAC target ligand is, e.g., 4-OHT, dasatinib, JQ1, a PDE4 inhibitor, JQ1, a chloroalkane, a thiazolidinedione-based ligand, a RIPK2 inhibitor, bosutinib, a JQ1 derivative, OTX015, steel factor, a TBK1 inhibitor, BI-7273, lapatinib, gefitinib, afatinib, foretinib, Sirt2 inhibitor 3b, HJB97, SNS-032, an aminopyrazole analog, AC220, RN-486, ceritinib, an AR antagonist, IACS-7e, or an ibrutinib derivative. In some aspects, the PROTAC E3 ligand is, e.g., an LCL161 derivative, VHL1, a hydroxyproline derivative, pomalidomide, thalidomide, a HIF-1α-derived (R)-hydroxyproline, VHL ligand 2, a VH032 derivative, lenalidomide, a thalidomide derivative, or VL-269. In some aspects, the F3 ligase is, e.g., IAP, VHL, or CRBN. See, for example, An & Fu (2018) EBioMedicine 36:553-562, which is herein incorporated by reference in its entirety.

PROTACS and related technologies that can be used according to the methods disclosed herein as disclosed for example in WO2018106870, US2018155322, WO2018098288, WO2018098280, WO2018098275, WO2018089736, WO2018085247, US20180125821, US20180099940, WO2018064589, WO2018053354, WO2017223452, WO2017201449, WO2017197056, WO2017197051, WO2017197046, WO2017185036, WO2017185034, WO2017185031, WO2017185023, WO2017182418, US20170305901, WO2017176708, US20170281784, WO2017117474, WO2017117473, WO2017079723, U.S. Pat. No. 9,938,264, US20170065719, WO2017024319, WO2017024318, WO2017024317, US20170037004, US20170008904, US20180147202, WO2018051107, WO2018033556, US20160272639, US20170327469, WO2017212329, WO2017211924, US20180085465, US20160045607, US20160022642, WO2017046036, US20160058872, US20180134688, US20180118733, US20180050021, U.S. Pat. No. 9,855,273, US20140255361, U.S. Pat. No. 9,115,184, US20180093990, US20150119435, US20140356322, US20140112922, U.S. Pat. No. 9,765,019, US20180100001, U.S. Pat. No. 7,390,656, or U.S. Pat. No. 7,208,157, all of which are herein incorporated by reference in their entireties.

In some aspects, when several PROTACs are present on an EV (e.g., exosome), such PROTACs can be the same or they can be different. In some aspects, when several non-cyclic dinucleotide STING agonist are present on an EV (e.g., exosome) disclosed herein, such PROTACs can be the same or they can be different. In some aspects, an EV (e.g., exosome) composition of the present disclosure can comprise two or more populations of EVs, e.g., exosomes, wherein each population of EVs, e.g., exosomes, comprises a different PROTAC or combination thereof.

In some aspects, the EV protein is Scaffold X. In some aspects, EVs comprise one or more polypeptides on their surface. In some aspects, the one or more polypeptides can be CD47, CD55, CD49, CD40, CD133, CD59, glypican-1, CD9, CD63, CD81, integrins, selectins, lectins, cadherins and/or other similar polypeptides known to those of skill in the art. In some aspects, the one or more polypeptides can be a scaffold protein, such as PTGFRN, BSG, IGSF3, IGSF2, ITGB1, ITGA4, SLC3A2, ATP transporter or a fragment thereof. In some aspects, the payload (e.g., IL-12) is fused to Scaffold X, e.g. PTGFRN.

In some aspects, the EV protein is Scaffold Y. In some aspects, the EV protein is polypeptide is BASP1. In some aspects, the one or more polypeptides is a fusion protein comprising the scaffold protein fused to a different protein. In some aspects, the surface protein can be expressed from an exogenous polynucleotide introduced to the producer cells. In some aspects, the surface polypeptide can confer different functionalities to the EV, for example, specific targeting capabilities, delivery functions, enzymatic functions, increased or decreased half-life in vivo, and other desired functionalities known to those of skill in the art.

As previously described, producer cells can be genetically modified to comprise one or more exogenous sequences to produce EVs described herein. The genetically-modified producer cell can contain the exogenous sequence by transient or stable transfection and/or transformation. The exogenous sequence can be transformed as a plasmid. The exogenous sequences can be stably integrated into a genomic sequence of the producer cell, at a targeted site or in a random site. In some aspects, a stable cell line is generated for production of lumen-engineered EVs.

The exogenous sequences can be inserted into a genomic sequence of the producer cell, located within, upstream (5′-end) or downstream (3′-end) of an endogenous sequence encoding an EV protein. Various methods known in the art can be used for the introduction of the exogenous sequences into the producer cell. For example, cells modified using various gene editing methods (e.g., methods using a homologous recombination, transposon-mediated system, loxP-Cre system, CRISPR/Cas9 or TALEN) are within the scope of the present disclosure.

The exogenous sequences can comprise a sequence encoding a scaffold moiety disclosed herein or a fragment or variant thereof. Extra copies of the sequence encoding a scaffold moiety can be introduced to produce an engineered EV described herein (e.g., having a higher density of a scaffold moiety on the exterior surface or on the luminal surface of the EV). An exogenous sequence encoding a modification or a fragment of a scaffold moiety can be introduced to produce a lumen-engineered and/or surface-engineered EV containing the modification or the fragment of the scaffold moiety.

In some aspects, a producer cell disclosed herein is further modified to comprise an additional exogenous sequence. For example, an additional exogenous sequence can be introduced to modulate endogenous gene expression, or produce an EV including a certain polypeptide. In some aspects, the producer cell is modified to comprise two exogenous sequences, one encoding a scaffold moiety (e.g., Scaffold X and/or Scaffold Y), or a variant or a fragment thereof, and the other encoding a molecule linked to the scaffold moiety. In certain aspects, the producer cell can be further modified to comprise an additional exogenous sequence conferring additional functionalities to the EVs. In some aspects, the producer cell is modified to comprise two exogenous sequences, one encoding a scaffold moiety disclosed herein, or a variant or a fragment thereof, and the other encoding a protein conferring the additional functionalities to the EVs. In some aspects, the producer cell is further modified to comprise one, two, three, four, five, six, seven, eight, nine, or ten or more additional exogenous sequences.

In some aspects, EVs of the present disclosure (e.g., surface-engineered and/or lumen-engineered EVs) can be produced from a cell transformed with a sequence encoding a full-length, mature scaffold moiety disclosed herein. Any of the scaffold moieties described herein can be expressed from a plasmid, an exogenous sequence inserted into the genome or other exogenous nucleic acid, such as a synthetic messenger RNA (mRNA).

In certain aspects, the one or more moieties are introduced into the EVs by transfection. In some aspects, the one or more moieties can be introduced into the EVs using synthetic macromolecules such as cationic lipids and polymers (Papapetrou et al., Gene Therapy 12: S118-S130 (2005)). In certain aspects, chemicals such as calcium phosphate, cyclodextrin, or polybrene, can be used to introduce the one or more moieties to the EVs.

In some aspects, one or more scaffold moieties are expressed in the membrane of the EVs by recombinantly expressing the scaffold moieties in the producer cells. The EVs obtained from the producer cells can be further modified to be conjugated to a chemical compound, a nucleic acid, a peptide, a protein, or a linker. In some aspects, the scaffold moiety, e.g., Scaffold X and/or Scaffold Y, is deglycosylated. In some aspects, the scaffold moiety, Scaffold X and/or Scaffold Y, is highly glycosylated, e.g., higher than naturally-occurring Scaffold X and/or Scaffold Y under the same condition.

In certain aspects, one or more moieties can be introduced into the EVs directly after exosome production e.g., loaded into the EVs: for example, passive diffusion, electroporation, chemical or polymeric transfection, viral transduction, mechanical membrane disruption or mechanical shear, or any combination thereof. In some aspects, the one or more moieties and the EV, e.g., exosome, of the present disclosure can be incubated in an appropriate buffer during loading or encapsulation. The term “encapsulated”, or grammatically different forms of the term (e.g., encapsulation, or encapsulating), refers to a status or process of having a first moiety (e.g., STING agonist) inside a second moiety (e.g., an EV, e.g., exosome) without chemically or physically linking the two moieties. In some aspects, the term “encapsulated” can be used interchangeably with “in the lumen of” or “loaded”. Non-limiting examples of encapsulating a first moiety (e.g., STING agonist) into a second moiety (e.g., EVs, e.g., exosomes) are disclosed elsewhere herein. In some aspects, the moiety that can be encapsulated or loaded in the EVs includes a STING agonist. STING agonists refer to an agent that activates a STING pathway. Activation of the STING pathway in DCs results in Type I IFN and pro inflammatory cytokine production via TBK1, IRF3, and NF-κB signaling. Binding of IFN to their receptors on cells results in activation of IFN-stimulated response elements and the transcription of IFN-sensitive genes that result in the immune and inflammatory response. IFN signaling also cross-primes DCs to promote antigen persistence, alters the antigen repertoire available for MHCI presentation, enhances MHCI presentation of antigens, and increases the overall surface expression of MHCI, MHCII, and co-stimulatory molecules CD40, CD80, and CD86. These actions result in increased priming of tumor specific CD8+ T cells and initiation of the adaptive immune response.

In some aspects, a STING agonist useful for the EVs of the present disclosure comprises a cyclic dinucleotide (CDN) and/or a non-cyclic nucleotide. STING agonists used in this disclosure can be cyclic purine dinucleotides such as, but not limited to, cGMP, cyclic di-GMP (c-di-GMP), cAMP, cyclic di-AMP (c-di-AMP), cyclic-GMP-AMP (cGAMP), cyclic di-IMP (c-di-IMP), cyclic AMP-IMP (cAIMP), and any analogue thereof, which are known to stimulate or enhance an immune or inflammation response in a patient. The CDNs can have 2′2′, 2′3′, 2′5′, 3′3′, or 3′5′ bonds linking the cyclic dinucleotides, or any combination thereof. Further non-limiting examples of STING agonists that can be used with the present disclosure include: DMXAA, STING agonist-1, ML RR-S2 CDA, ML RR-S2c-di-GMP, ML-RR-S2 cGAMP, 2′3′-c-di-AM(PS)2, 2′3′-cGAMP, 2′3′-cGAMPdFHS, 3′3′-cGAMP, 3′3′-cGAMPdFSH, cAIMP, cAIM(PS)2, 3′3′-cAIMP, 3′3′-cAIMPdFSH, 2′2′-cGAMP, 2′3′-cGAM(PS)2, 3′3′-cGAMP, and combinations thereof. Non-limiting examples of the STING agonists can also be found at U.S. Pat. No. 9,695,212, WO 2014/189805 A1, WO 2014/179335 A1, WO 2018/100558 A1, U.S. Pat. No. 10,011,630 B2, WO 2017/027646 A1, WO 2017/161349 A1, and WO 2016/096174 A1, each of which is incorporated by reference in its entirety.

Cyclic purine dinucleotides can be modified via standard organic chemistry techniques to produce analogues of purine dinucleotides. Suitable purine dinucleotides include, but are not limited to, adenine, guanine, inosine, hypoxanthine, xanthine, isoguanine, or any other appropriate purine dinucleotide known in the art. The cyclic dinucleotides can be modified analogues. Any suitable modification known in the art can be used, including, but not limited to, phosphorothioate, biphosphorothioate, fluorinate, and difluorinate modifications.

Non cyclic dinucleotide agonists can also be used, such as 5,6-Dimethylxanthenone-4-acetic acid (DMXAA), or any other non-cyclic dinucleotide agonist known in the art.

It is contemplated that any STING agonist can be used. Among the STING agonists are DMXAA, STING agonist-1, ML RR-S2 CDA, ML RR-S2c-di-GMP, ML-RR-S2 cGAMP, 2′3′-c-di-AM(PS)2, 2′3′-cGAMP, 2′3′-cGAMPdFHS, 3′3′-cGAMP, 3′3′-cGAMPdFSH, cAIMP, cAIM(PS)2, 3′3′-cAIMP, 3′3′-cAIMPdFSH, 2′2′-cGAMP, 2′3′-cGAM(PS)2, 3′3′-cGAMP, c-di-AMP, 2′3′-c-di-AMP, 2′3′-c-di-AM(PS)2, c-di-GMP, 2′3′-c-di-GMP, c-di-IMP, c-di-UMP or any combination thereof. In some aspects, the STING agonist is 3′3′-cAIMPdFSH, alternatively named 3-3 cAIMPdFSH. Additional STING agonists known in the art can also be used.

In some aspects, one or more moieties can be introduced into the EVs via an anchoring moiety, e.g., a lipid anchor, e.g., loaded into the EVs: In some aspects, the lipid anchor can be any lipid anchor known in the art, e.g., palmitic acid or glycosylphosphatidylinositols. Under unusual circumstances, e.g., by using a culture medium where myristic acid is limiting, some other fatty acids including shorter-chain and unsaturated, can be attached to the N-terminal glycine. For example, in BK channels, myristate has been reported to be attached posttranslationally to internal serine/threonine or tyrosine residues via a hydroxyester linkage. Membrane anchors known in the art are presented in the following table:

| Modification | Modifying Group |
|---|---|
| S-Palmitoylation | 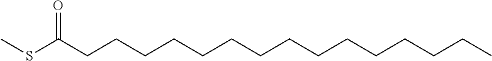 [SMILES: CCCCCCCCCCCCCCCC(=O)SC] |
| N·Palmitoylation | 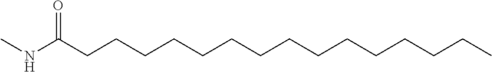 [SMILES: CCCCCCCCCCCCCCCC(=O)NC] |
| N-Myristoylation | 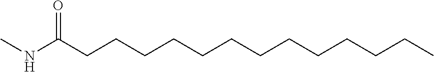 [SMILES: CCCCCCCCCCCCCC(=O)NC] |
| O-Acylation | 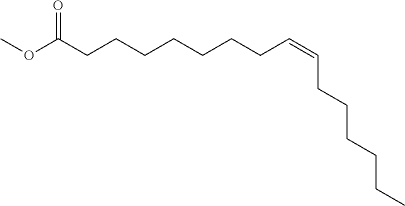 [SMILES: CCCCCC/C=C\CCCCCCCC(=O)OC] |
| Farnesylation | 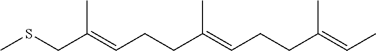 [SMILES: C/C=C(\C)CC/C=C(\C)CC/C=C(\C)CSC] |
| Geranylgeranylation | 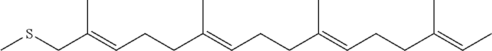 [SMILES: C/C=C(\C)CC/C=C(\C)CC/C=C(\C)CC/C=C(\C)CSC] |
| Cholesterol | 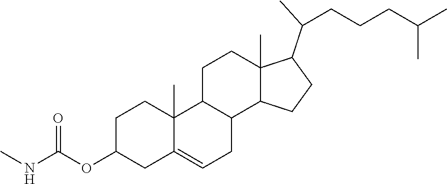 [SMILES: CNC(=O)OC1CCC2(C)C(=CCC3C2CCC2(C)C(C(C)CCCC(C)C)CCC32)C1] |

### II.D. Linkers

In some aspects, a payload, e.g., one or more moieties, can be linked to a scaffold moiety or an anchoring moiety either chemically or non-chemically. In some aspects, a biologically active molecule is linked to a scaffold moiety or an anchoring moiety or an EV via a chemical linker, e.g., a maleimide moiety, a sulfhydryl linker, etc.

In some aspects, a payload is linked to a scaffold moiety or an anchoring moiety on the exterior surface of the EV. In some aspects, the payload is linked to the scaffold moiety or an anchoring moiety on the luminal surface of the EV. In some aspects, the scaffold moiety or an anchoring moiety comprises sterol, GM1, a lipid, a vitamin, a small molecule, a peptide, or a combination thereof. In some aspects, the scaffold moiety or an anchoring moiety comprises cholesterol. In some aspects, the scaffold moiety or an anchoring moiety comprises a phospholipid, a lysophospholipid, a fatty acid, a vitamin (e.g., vitamin D and/or vitamin E), or any combination thereof. In some aspects, the payload is linked to the scaffold moiety or an anchoring moiety by a linker.

In some aspects, a linker can comprise a cholesterol moiety. See, e.g., US 2008/0085869 A1, which is herein incorporated by reference in its entirety.

In some aspects, one or more linkers comprise smaller units (e.g., HEG, TEG, glycerol, C2 to C12 alkyl, and the like) linked together. In some aspects, the linkage is an ester linkage (e.g., phosphodiester or phosphorothioate ester) or other linkage. Examples of non-cleavable linkers that can be used with the present disclosure are known in the art, see, e.g., U.S. Pat. No. 7,569,657 B2; U.S. Pat. No. 8,465,730 B1; U.S. Pat. No. 7,087,229 B2; and U.S. Publ. No. 2014/0193849 A1, each of which is herein incorporated by reference in its entirety. In some aspects, the linker can be, e.g., maleimido caproyl (MC), maleimido propanoyl (MP), methoxyl polyethyleneglycol (MPEG), succinimidyl 4-(N-maleimidomethyl)-cyclohexane-1-carboxylate (SMCC), m-maleimidobenzoyl-N-hydroxysuccinimide ester (MBS), succinimidyl 4-(p-maleimidophenyl)butyrate (SMPB), N-succinimidyl(4-iodoacetyl)aminobenzonate (SIAB), succinimidyl 6-[3-(2-pyridyldithio)-propionamide]hexanoate (LC-SPDP), 4-succinimidyloxycarbonyl-alpha-methyl-alpha-(2-pyridyldithio)toluene (SMPT), etc. (see, e.g., U.S. Pat. No. 7,375,078, which is herein incorporated by reference in its entirety).

In some aspects, the linker comprises acrylic phosphoramidite (e.g., ACRYDITE™), adenylation, azide (NHS Ester), digoxigenin (NHS Ester), cholesterol-TEG, I-LINKER™, an amino modifier (e.g., amino modifier C6, amino modifier C12, amino modifier C6 dT, or Uni-Link™ amino modifier), alkyne, 5′ Hexynyl, 5-Octadiynyl dU, biotinylation (e.g., biotin, biotin (Azide), biotin dT, biotin-TEG, dual biotin, PC biotin, or desthiobiotin), thiol modification (thiol modifier C3 S-S, dithiol or thiol modifier C6 S-S), or any combination thereof. In some aspects, the linker is a cleavable linker. In some aspects, the linker comprises valine-alanine-p-aminobenzylcarbamate or valine-citrulline-p-aminobenzylcarbamate. In some aspects, the linker comprises (i) a maleimide moiety and (ii) valine-alanine-p-aminobenzylcarbamate or valine-citrulline-p-aminobenzylcarbamate.

### II.E Extracellular Vesicles Purified by Present Methods

The present disclosure also includes extracellular vesicles (EVs), e.g., exosomes, purified by the present disclosure. In some aspects, the EVs purified by the present methods include lower impurities, e.g., total nucleic acid and/or protein impurities, than EVs purified by a different process (e.g., that does not comprise a depth filter-based clarification step described herein).

In some aspects, the present disclosure provides a pharmaceutical composition comprising the purified EVs described herein and a pharmaceutically acceptable carrier. In some aspects, the present disclosure provides a composition comprising EVs and impurities, wherein the amount of the impurities present in the composition are lower than a reference amount, where the EVs were purified by a process that does not comprise a depth filter-based clarification step described herein. In some aspects, the present disclosure provides a composition comprising EVs and one or more impurities, wherein the one or more impurities are at least about 5%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 23%, at least about 24%, at least about 25%, at least about 26%, at least about 27%, at least about 28%, at least about 29%, at least about 30%, at least about 31%, at least about 32%, at least about 33%, at least about 34%, at least about 35%, at least about 36%, at least about 37%, at least about 38%, at least about 39%, or at least about 40% lower in the purified EV composition compared to a reference EV composition, wherein the EVs were purified by a process that does not comprise a depth filter-based clarification step described herein.

In some aspects, the impurities are at least about 5%, e.g., 5% to 10%, 5% to 20%, 5% to 25%, or 5% to 30%, lower in the purified EV composition compared to the reference EV composition. In some aspects, the impurities are at least about 10%, e.g., 10% to 15%, 10% to 20%, 10% to 25%, 10% to 30%, 10% to 35%, 10% to 30%, 10% to 95%, 20% to 90%, 50% to 90%, or 80% to 90% lower in the purified EV composition compared to the reference EV composition. In some aspects, the impurities are at least about 11% lower in the purified EV composition compared to the reference EV composition. In some aspects, the impurities are at least about 12% lower in the purified EV composition compared to the reference EV composition. In some aspects, the impurities are at least about 13% lower in the purified EV composition compared to the reference EV composition. In some aspects, the impurities are at least about 14% lower in the purified EV composition compared to the reference EV composition. In some aspects, the impurities are at least about 15%, e.g., 15% to 20%, 15% to 25%, 15% to 30%, 15% to 35%, 15% to 40%, 20% to 25%, 20% to 30%, 20% to 35%, or 20% to 40%, lower in the purified EV composition compared to the reference EV composition.

In some aspects, compositions comprising the purified EVs has an EV concentration that is approximately the same as the concentration of EVs in a reference composition, which comprises EVs purified by a process that does not comprise a depth-filter based clarification step (“reference EV composition”). In some aspects, compositions comprising the purified EVs has an EV concentration that is more than about 99% of the concentration of EVs in the reference EV composition. In some aspects, compositions comprising the purified EVs has an EV concentration that is more than about 98% of the concentration of EVs in the reference EV composition. In some aspects, compositions comprising the purified EVs has an EV concentration that is more than about 97% of the concentration of EVs in the reference EV composition. In some aspects, compositions comprising the purified EVs has an EV concentration that is more than about 96% of the concentration of EVs in the reference EV composition. In some aspects, compositions comprising the purified EVs has an EV concentration that is more than about 95% of the concentration of EVs in the reference EV composition. In some aspects, compositions comprising the purified EVs has an EV concentration that is more than about 90% of the concentration of EVs in the reference EV composition. In some aspects, compositions comprising the purified EVs has an EV concentration that is more than about 85% of the concentration of EVs in the reference EV composition. In some aspects, compositions comprising the purified EVs has an EV concentration that is more than about 80% of the concentration of EVs in the reference EV composition.

In some aspects, compositions comprising the purified EVs have a higher potency than a reference composition comprising EVs purified by a process that does not comprise a depth filter-based clarification step described herein (“reference EV composition”). In some aspects, the potency of the composition comprising the purified EVs is at least about 5%, e.g., 5% to 10%, 5% to 15%, 5% to 20%, 5% to 25%, 5% to 30%, 5% to 35%, 5% to 40%, 5% to 45%, 5% to 50%, e.g., 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30% higher than that of the reference EV composition. In some aspects, the potency of the composition comprising the purified EVs is at least about 10%, e.g., 10% to 15%, 10% to 20%, 10% to 25%, 10% to 30%, 10% to 35%, 10% to 40%, 10% to 45%, 10% to 50%, 10% to 55%, or 10% to 60%, e.g., 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, or 60%, higher than that of the reference EV composition. In some aspects, the potency of the composition comprising the purified EVs is at least about 11% higher than that of the reference EV composition. In some aspects, the potency of the composition comprising the purified EVs is at least about 15%, e.g., 15% to 20%, 15% to 25%, 15% to 30%, 15% to 35%, 15% to 40%, 15% to 45%, 15% to 50%, 15% to 55%, or 15% to 60%, e.g., 16%, 17%, 18%, 19%, 20%, 21%, 22%, 23%, 24%, 25%, 26%, 27%, 28%, 29%, 30%, 35%, 40%, 45%, 50%, 55%, or 60%, higher than that of the reference EV composition. In some aspects, the potency of the composition comprising the purified EVs is at least about 20%, e.g., 20% to 25%, 20% to 30%, 20% to 35%, 20% to 40%, 20% to 45%, 20% to 50%, 20% to 55%, or 20% to 60%, e.g., 20%, 21%, 22%, 23%, 24%, 25%, 26%, 27%, 28%, 29%, 30%, 35%, 40%, 45%, 50%, 55%, or 60%, higher than that of the reference EV composition. In some aspects, the potency of the composition comprising the purified EVs is at least about 25%, e.g., 25% to 30%, 25% to 35%, 25% to 40%, 25% to 45%, 25% to 50%, 25% to 55%, or 25% to 60%, e.g., 25%, 26%, 27%, 28%, 29%, 30%, 35%, 40%, 45%, 50%, 55%, 60%, 65%, 70%, 75%, or 80%, higher than that of the reference EV composition. In some aspects, the potency of the composition comprising the purified EVs is at least about 30%, e.g., 30% to 35%, 30% to 40%, 30% to 45%, 30% to 50%, 30% to 55%, or 30% to 60%, e.g., 30%, 35%, 40%, 45%, 50%, 55%, 60%, 65%, 70%, 75%, 80%, 80%, 85%, or 90% higher than that of the reference EV composition. In some aspects, the potency of the composition comprising the purified EVs is at least about 35%, e.g., 35% to 40%, 35% to 45%, 35% to 50%, 35% to 55%, or 35% to 60%, e.g., 35%, 40%, 45%, 50%, 55%, 60%, 65%, 70%, 75%, 80%, 80%, 85%, or 90% higher than that of the reference EV composition. In some aspects, the potency of the composition comprising the purified EVs is at least about 40%, e.g., 40% to 45%, 40% to 50%, 40% to 55%, or 40% to 60%, e.g., 40%, 45%, 50%, 55%, 60%, 65%, 70%, 75%, 80%, 80%, 85%, or 90%, higher than that of the reference EV composition. In some aspects, the potency of the composition comprising the purified EVs is at least about 45%, e.g., 45% to 50%, 45% to 55%, or 45% to 60%, e.g., 45%, 50%, 55%, 60%, 65%, 70%, 75%, 80%, 80%, 85%, or 90% higher than that of the reference EV composition. In some aspects, the potency of the composition comprising the purified EVs is at least about 50% higher than that of the reference EV composition.

In some aspects, the purified EVs according to the present disclosure is at least about 75% pure. In some aspects, the purified EVs according to the present disclosure is at least about 80% pure. In some aspects, the purified EVs according to the present disclosure is at least about 85% pure. In some aspects, the purified EVs according to the present disclosure is at least about 90% pure. In some aspects, the purified EVs according to the present disclosure is at least about 95% pure. In some aspects, the purified EVs according to the present disclosure is at least about 96% pure. In some aspects, the purified EVs according to the present disclosure is at least about 97% pure. In some aspects, the purified EVs according to the present disclosure is at least about 98% pure. In some aspects, the purified EVs according to the present disclosure is at least about 99% pure. In some aspects, the purified EVs according to the present disclosure is about 100% pure.

In some aspects, a composition comprising the purified EVs of the present disclosure further comprises a saccharide. In some aspects, a composition comprising the purified EVs of the present disclosure further comprises sodium chloride. In some aspects, a composition comprising the purified EVs of the present disclosure further comprises a potassium phosphate. In some aspects, a composition comprising the purified EVs of the present disclosure further comprises a sodium phosphate. In some aspects, a composition comprising the purified EVs of the present disclosure further comprises one or more of a saccharide, sodium chloride, a potassium phosphate, and a sodium phosphate. In some aspects, a composition comprising the purified EVs of the present disclosure further comprises a saccharide, sodium chloride, a potassium phosphate, and a sodium phosphate.

In some aspects, the present disclosure provides a method of administering a composition comprising purified EVs to a subject in need thereof. In some aspects, the present disclosure provides a method of treating a disease or condition in a subject in need thereof comprising administering to the subject a composition comprising purified EVs.

The foregoing description of the specific aspects will so fully reveal the general nature of the disclosure that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

### EXAMPLES

The following examples are put forth so as to provide those of ordinary skill in the art with a complete disclosure and description of how to make and use the aspects described herein, and are not intended to limit the scope of the appended claims, nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees Celsius, and pressure is at or near atmospheric. Standard abbreviations can be used, e.g., s or see, second(s); min, minute(s); h or hr, hour(s).

The aspects described herein employ, unless otherwise indicated, conventional methods of protein chemistry, biochemistry, recombinant DNA techniques and pharmacology, within the skill of the art. Such techniques are explained fully in the literature. Sec, e.g., T. E. Creighton, Proteins: Structures and Molecular Properties (W.H. Freeman and Company, 1993); A L. Lehninger, Biochemistry (Worth Publishers, Inc., current addition); Sambrook, et al., Molecular Cloning: A Laboratory Manual (2nd Edition, 1989); Methods In Enzymology (S. Colowick and N. Kaplan eds., Academic Press, Inc.); Remington's Pharmaceutical Sciences, 21th Edition (Easton, Pennsylvania: Mack Publishing Company, 2005); Carey and Sundberg Advanced Organic Chemistry 3rd Ed. (Plenum Press) Vols A and B (1992).

### Example 1: Assessment of Impurity Clearance with SP Media Grade Depth Filters

In the present example, the ability of different SP media grade depth filters to remove one or more impurities in a sample comprising EVs was assessed. Briefly, samples comprising EVs and one or more impurities were prepared and initially subjected to 0.65 μm glass fiber depth filtration and nuclease digestion (20 U/mL Benzonase). Then, the resulting samples were subjected to one of the following filter-based clarification steps: (1) a multi-layer 0.45 μm PES filter followed by a multi-layer 0.2 μm PES filter (i.e., control); (2) 90SP depth filter followed by a multi-layer 0.2 μm membrane filter; (3) 60SP depth filter followed by a multi-layer 0.2 μm membrane filter: (4) 50SP depth filter followed by a multi-layer 0.2 μm membrane filter; and (5) 30SP depth filter followed by a multi-layer 0.2 μm membrane filter. Subsequently, each filtrate collected from the different groups was loaded onto an individual anion exchange (AEX) chromatography column (e.g., a SARTOBIND® Q AEX membrane at a concentration of 0.55 M NaCl). Following sample binding, an on-column wash was performed using a wash buffer and then, the bound EVs were eluted from the AEX chromatography columns using 1.2 M NaCl and collected for further processing.

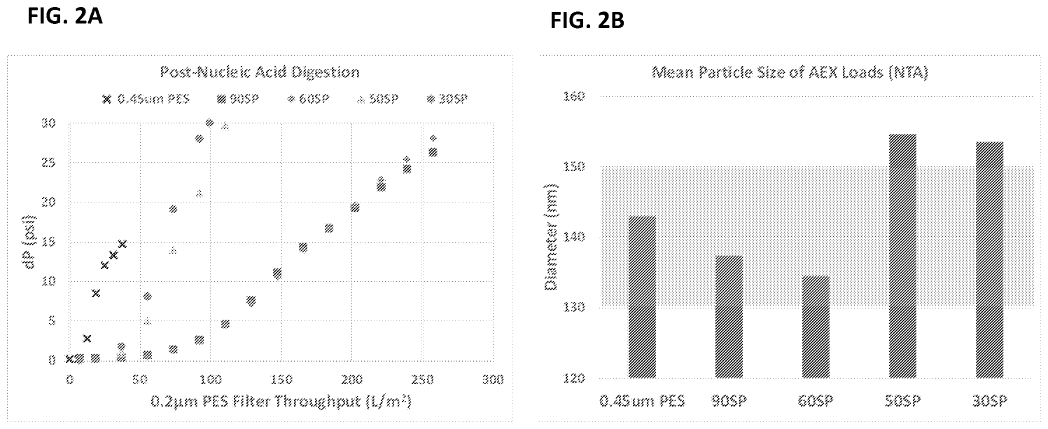

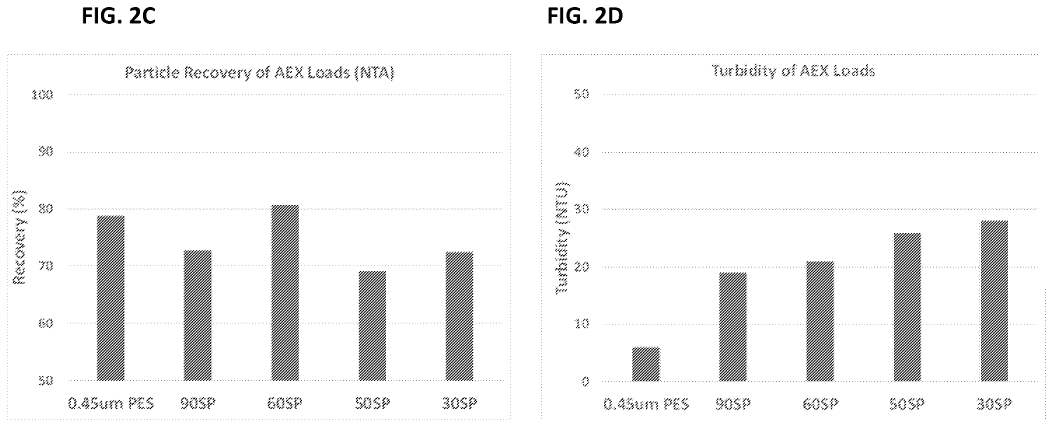

As shown in FIG. 2A, immediately after the initial filtration with the different SP media grade depth filters (i.e., prior to the multi-layer 0.2 μm membrane filter), the filtrate from samples subjected to the 60SP depth filter or the 90SP depth filter had much reduced impurities, as evidenced by the reduced differential pressure. For instance, with the filtrate from the control group, less than about 50 L/m2 throughput volume was sufficient to reach a differential pressure of 15 psi with the multi-layer 0.2 μm membrane filter. In contrast, filtrates from the 60SP depth filter and the 90SP depth filter, similar differential pressure was not observed until at least about 150 L/m2 throughput volume. As for the filtrates from the 50SP depth filter and the 30SP depth filter, compared to the control group, they also had reduced impurities. However, compared to the 60SP depth filter and the 90SP depth filter groups, the 50SP and 30SP depth filters were less efficient at removing impurities.

After the subsequent filtration with the multi-layer 0.2 μm membrane filter, similar results were observed as among the different LP media grade depth filters. For instance, the mean particle size of the AEX load (i.e., filtrate collected after the multi-layer 0.2 μm membrane filter) from the 60SP depth filter and from the 90SP depth filter most closely resembled the mean particle size of exosomes (shaded region in FIG. 2B). Similarly, compared to the AEX load from the 50SP and 30SP depth filter groups, there was reduced turbidity in the AEX load from the 60SP and 90SP depth filter groups (FIG. 2D). As to the recovery of the EVs after the depth filter-based clarification step, greatest percent recovery was observed using the 60SP depth filters (FIG. 2C).

Collectively, the above results demonstrate that compared to at least the PES filters, the SP media grade depth filters described herein are superior in removing one or more impurities from a sample comprising EVs. As among the different SP media grade depth filters tested, greatest clarification was observed with the 60SP depth filter.

### Example 2: Analysis of the Effect of Conductivity on Filter-Based Clarification and EV Quality

To assess the effect that conductivity has on the purified EV preparation methods provided herein, samples comprising EVs and one or more impurities prepared and initially subjected to 0.65 μm glass fiber depth filtration and nuclease digestion (20 U/mL Benzonase). Then, the resulting samples were subjected to one of the following filter-based clarification steps: (i) a multi-layer 0.45 μm PES filter followed by a multi-layer 0.2 μm PES filter (i.e., control) at 14 mS/cm; (ii) 60SP adsorptive depth filter followed by a multi-layer 0.2 μm membrane filter at 14 mS/cm; (iii) 90SP adsorptive depth filter followed by a multi-layer 0.2 μm membrane filter at 14 mS/cm; (iv) 60SP adsorptive depth filter followed by a multi-layer 0.2 μm membrane filter at 50 mS/cm; and (iv) 90SP adsorptive depth filter followed by a multi-layer 0.2 μm membrane filter at 50 mS/cm. As described in Example 1, individual AEX runs were performed using the filtrate from the different groups, and the resulting eluents (comprising the eluted EVs) were collected for further processing.

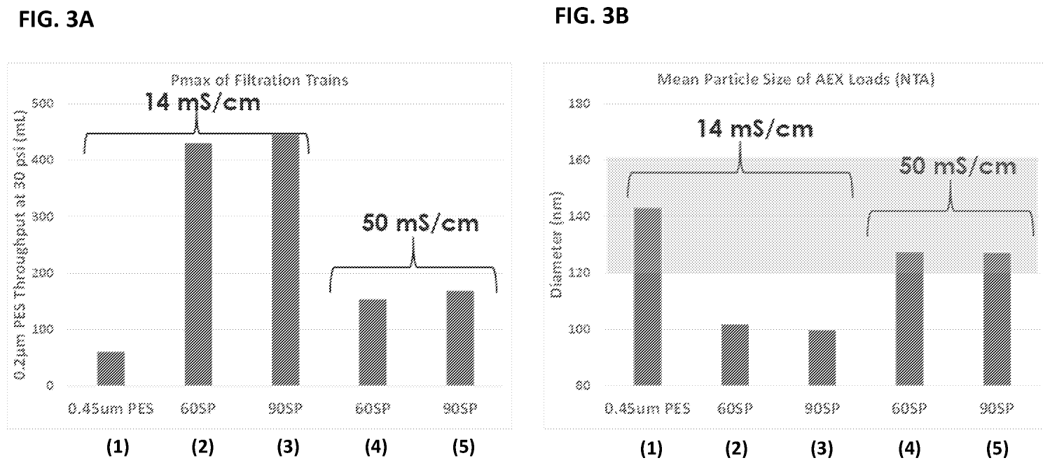

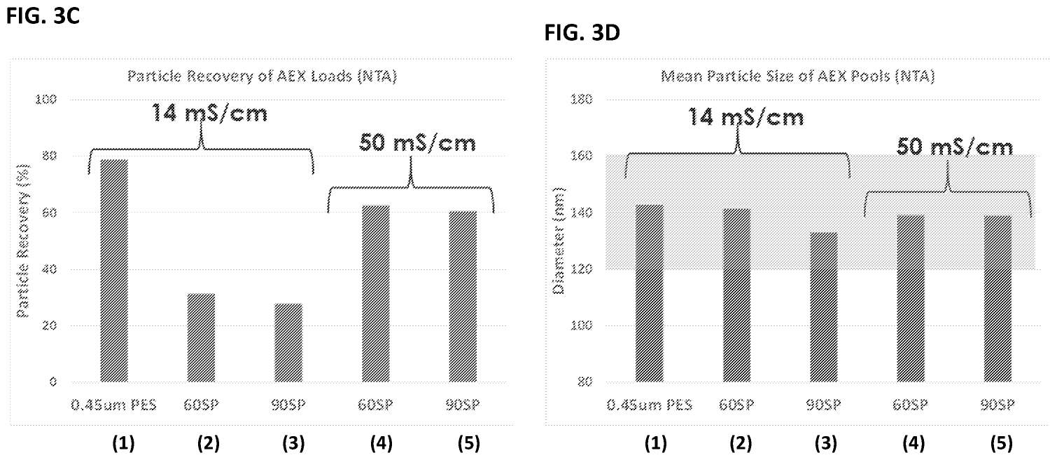

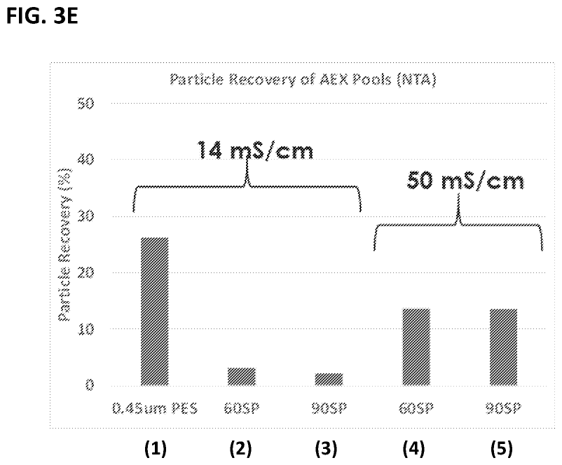

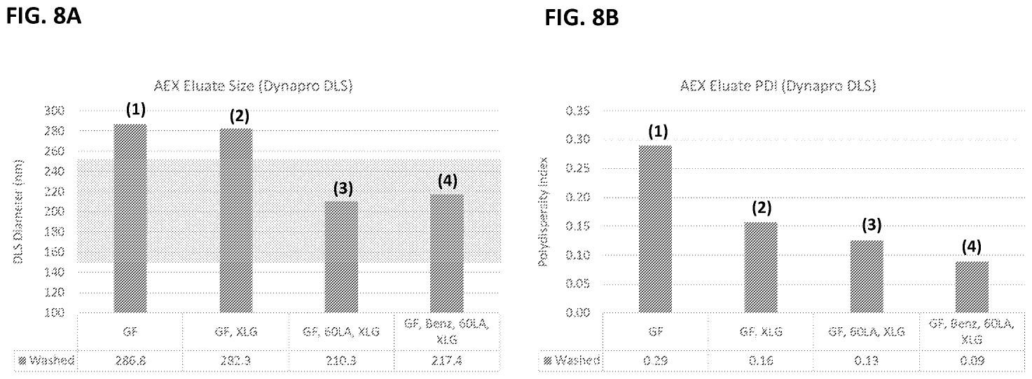

As shown in FIGS. 3A-3E, in the presence of higher conductivity, particle recovery was increased in both pre- and post-chromatography pools. Additionally, as shown in FIG. 8B, the 50 mS/cm depth filtrates showed a mean particle size more in line with exomes (130 nm vs. 100 nm). Such results demonstrate that the SP media grade adsorptive depth filters provided herein can be useful in EV purification.

### Example 3: Assessment of Impurity Clearance with LP Media Grade Depth Filters

Next, the ability of other depth filters to remove one or more impurities in a sample comprising EVs was assessed. Specifically, samples comprising EVs and one or more impurities were prepared and initially subjected to 0.65 μm glass fiber depth filtration and nuclease digestion (20 U/ml. Benzonase). Then, the resulting samples were subjected to an additional filtration step using one of the following LP media grade depth filters: (i) 90LA adsorptive depth filter; (ii) 60LA adsorptive depth filter; (iii) 50LA adsorptive depth filter; and (iv) 30LA adsorptive depth filter. A multi-layer 0.45 μm PES filter was used as control. Each of the above depth filters was followed by a multi-layer 0.2 μm membrane filter. Subsequently, as described in Example 1, individual AEX runs were performed using the filtrate from the different groups.

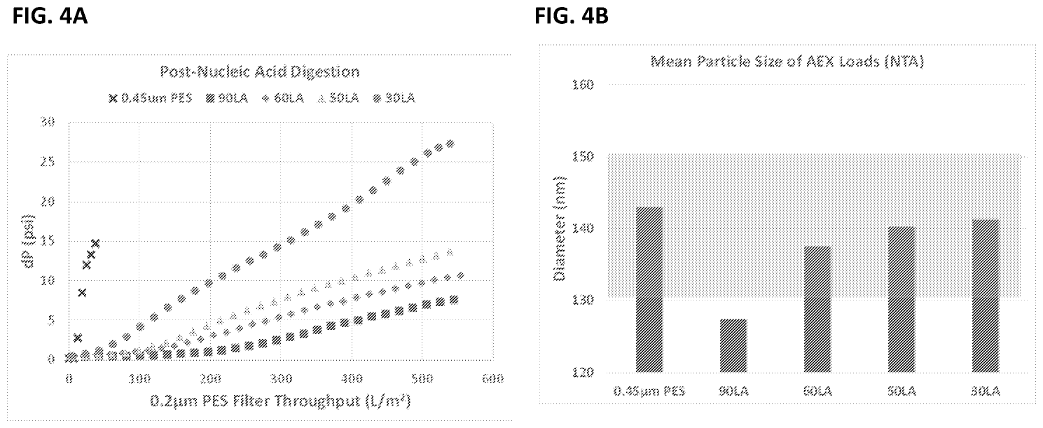

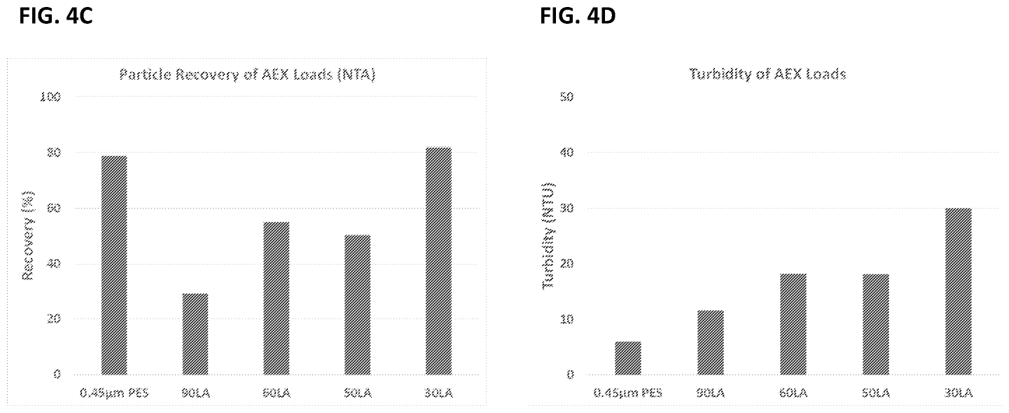

As shown in FIG. 4A, immediately after the initial filtration with the different LA media grade depth filters (i.e., prior to the multi-layer 0.2 μm membrane filter), the filtrate from samples subjected to the different LA media grade depth filters had much reduced impurities, as evidenced by the reduced differential pressure. As among the LA media grade depth filters, the greatest effect was observed with the 90LA depth filter, followed by the 60LA depth filter, the 50LA depth filter, and then the 30LA depth filter.

After the subsequent filtration with the multi-layer 0.2 μm membrane filter, when turbidity of the AEX loads were assessed, similar results were observed. For instance, as among the different LP media grade depth filters. AEX loads from the 90LA depth filter group had the least turbidity (FIG. 4D). However, with the 90LA depth filter, both the mean particle size and EV recovery of the AEX load was much more reduced compared to the other LA media grade depth filters tested (FIGS. 4B and 4C, respectively).

Collectively, the above results demonstrate that at least compared to the PES filters, the LA media grade depth filters are much more effective in reducing one or more impurities from a sample comprising EVs. And, based on at least the above results when considered in their entirety, the 60LA depth filter was superior compared to the other LA media grade depth filters tested.

### Example 4: Further Assessment of Impurity Clearance with 60LA Depth Filter

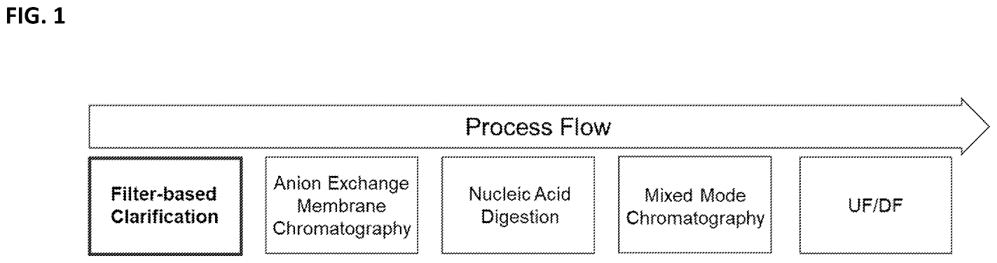

In the present example, the ability of the 60LA depth filter to remove one or more impurities in a sample was further assessed. In particular, whether using the 60LA depth filter during the filter-based clarification stage shown in FIG. 1 would have any effect on the overall EV (e.g., exosome) purification process was assessed.

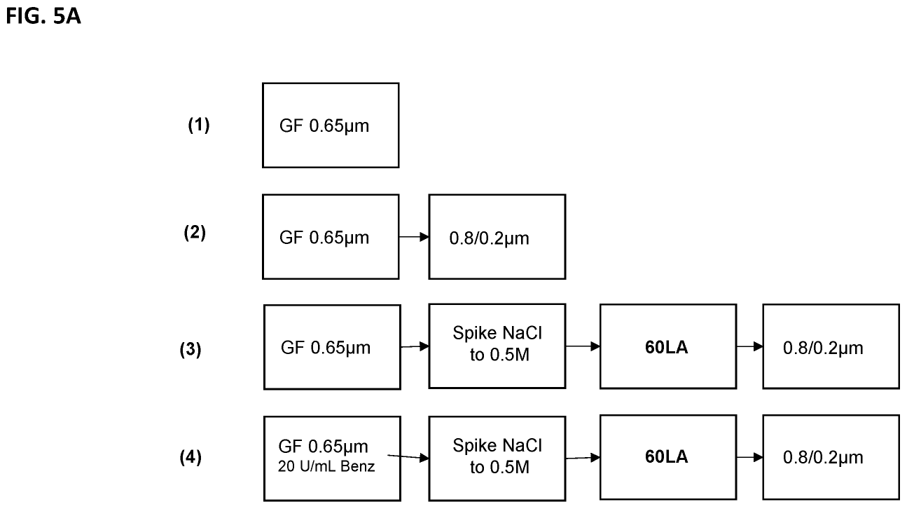

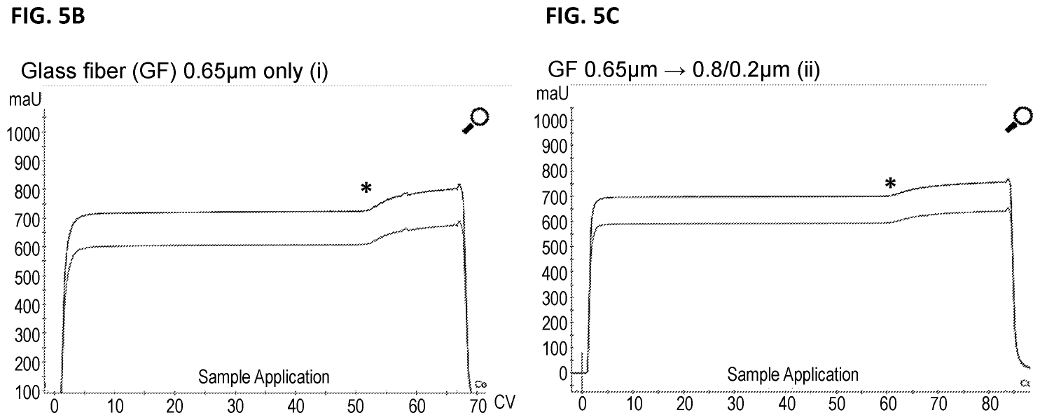

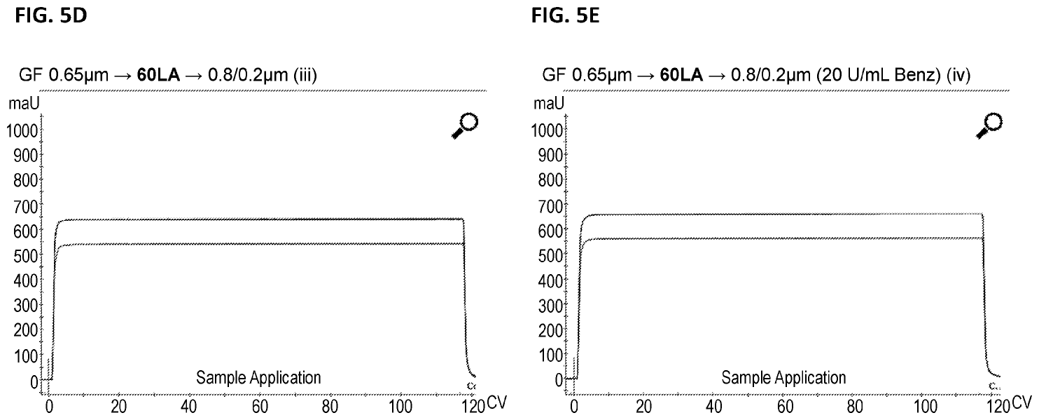

EV (e.g., exosome) comprising samples were prepared, and the samples were subjected to one of the following during the filter-based clarification step: (1) 0.65 μm glass fiber depth filtration alone (i.e., control); (2) 0.65 μm glass fiber depth filtration followed by a multilayer 0.2 μm membrane filter; (3) 0.65 μm glass fiber depth filtration, followed by a depth filtration with the 60LA depth filter, and then followed by a multilayer 0.2 μm membrane filter; and (4) 0.65 μm glass fiber depth filtration (in the presence of 20 U/mL Benzonase), followed by a depth filtration with the 60LA depth filter, and then followed by a multilayer 0.2 μm membrane filter. FIG. 5A. For groups (3) and (4), filtrate collected after the 0.65 μm glass fiber depth filtration were spiked with a sodium chloride solution to achieve a final concentration of 0.5 M NaCl prior to the depth filtration with the 60LA depth filter. Not to be bound by any one theory, the sodium chloride was added to prevent adsorption of the EVs to the surface chemistries of the 60LA filter matrix.

Subsequently, individual AEX runs were performed on each individual exosome sample, where each of the different individual AEX runs for each individual exosome sample was performed using a wash buffer comprising 0.35 M MgCl₂, 0.05 M TRIS, and 20 U/mL salt active nuclease (SAN, ArcticZymes Technologies ASA Norway), at pH 7.4. Control samples were treated with 20 U/mL of Benzonase prior to AEX and prior to filtration. For each individual AEX run for each individual exosome sample, the exosome sample was loaded onto an anion exchange chromatography column (e.g., a SARTOBIND® Q AEX membrane at a concentration of 0.55 M NaCl), and following sample binding, an on-column wash was performed using a wash buffer. After the wash step, the exosomes were then eluted from the AEX membrane using 1.2 M NaCl and collected for further processing.

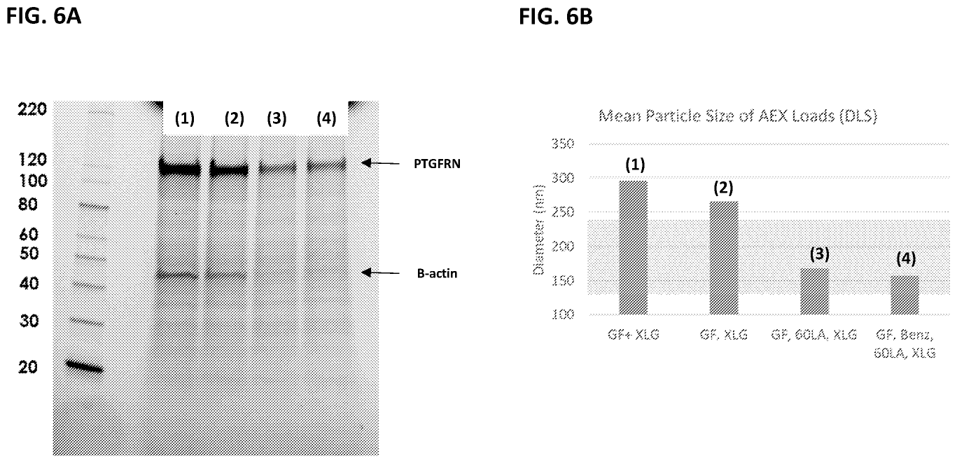

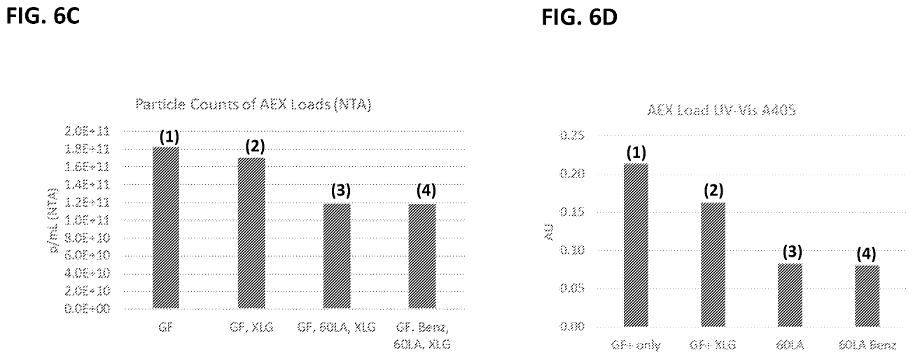

The residual DNA and/or protein concentrations were assessed at various time points during the process. Prior to the loading of the filtrates collected after contacting the samples with the GOLA depth filter, the amount of residual DNA and/or protein present in the AEX load was assessed using various assays. As shown in FIGS. 6A-6D, AEX loads where the initial samples were filtered using the 60LA depth filter (i.e., last two groups in each of the figures) had much reduced residual PTGFRN and protein bands. The reduced residual protein level correlated with reduced mean particle size and particle count, as shown in FIGS. 6B and 6C, respectively. Similar results were observed when solution turbidity was assessed using UV absorbance (see FIG. 6D).

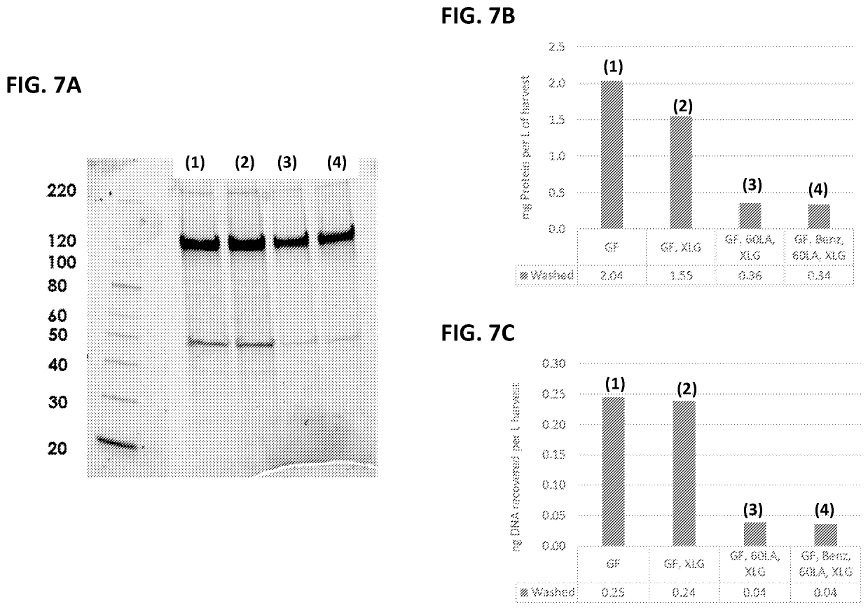

In agreement with the above observation, eluents from samples that were previously contacted with the 60LA depth filter prior to the AEX chromatography had significantly reduced amounts of impurities (see FIGS. 5B-5D and 7A-7C).

The size and the polydispersity of the EV preparations were assessed using dynamic light scattering. In agreement with the purification data, EV preparations from samples that were previously filtered with the 60LA depth filter had decreased product size and polydispersity (FIGS. 8A and 8B, respectively).

The above results demonstrate that the methods provided herein (i.e., contacting the samples with the 60LA depth filter prior to chromatography) is greatly beneficial in manufacturing a highly purified EV (e.g., exosome) preparation.

### Example 5: Analysis of the Effect of the Glass-Fiber (GF) Depth Filtration on EV Purification

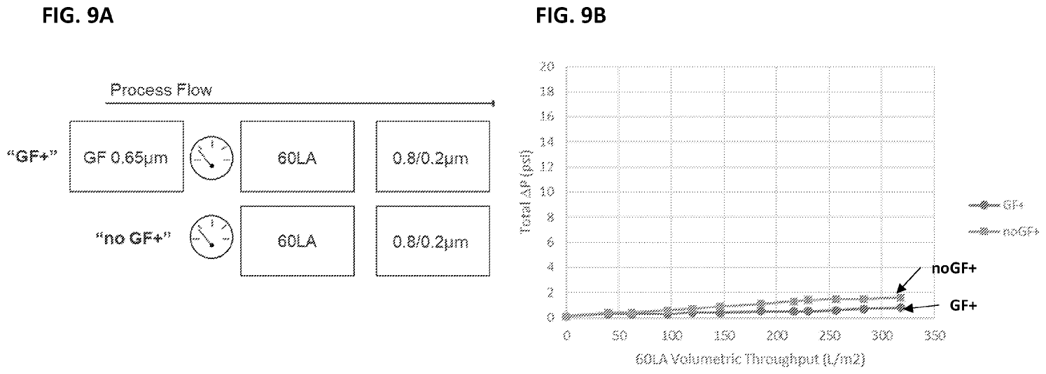

As described in the earlier Examples, prior to the filter-based clarification using the LA media grade and/or SP media grade depth filters, samples comprising EVs and one or more impurities were first subjected to a 0.65 μm glass fiber (GF) depth filtration. Therefore, to assess whether the GF depth filtration has any effect on EV purification, samples comprising EVs and one or more impurities were prepared, and some of the samples were subjected to GF depth filtration (“GF+”) while other samples were not subjected to GF depth filtration (“noGF+”). Then, all samples were subjected to depth filtration with the 60LA depth filter, and then followed by a multilayer 0.2 μm membrane filter (see FIG. 9A).

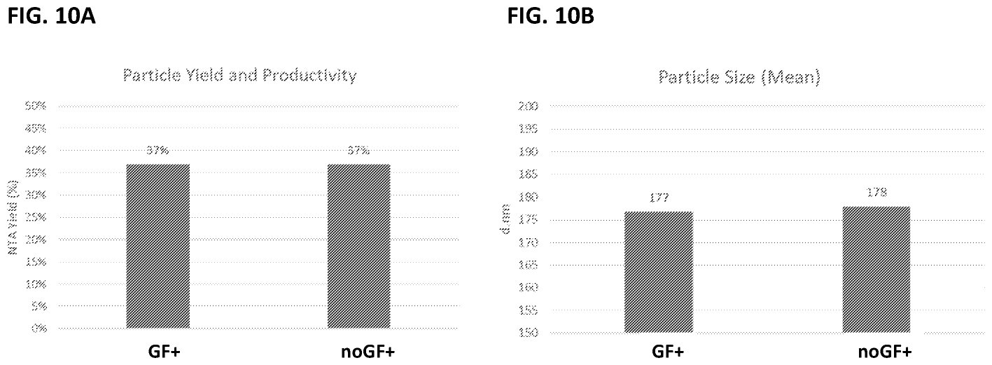

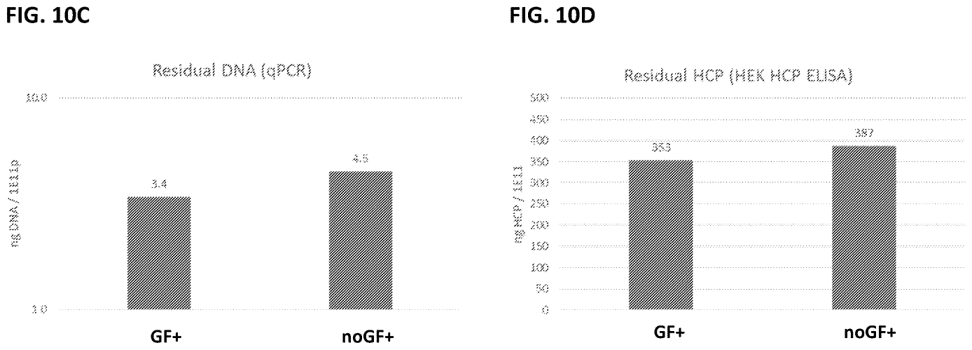

As shown in FIG. 9B, use of the GF depth filters prior to the depth filtration with the 60LA depth filter only had a marginal improvement in performance as measured by pressure drop. Both groups achieved greater than 300 L/m2 while operating at less than 2 psi. Similarly, no significant differences were observed in any of the following metrics assessed between the purified EVs from the two groups after AEX chromatography: (i) particle yield (FIG. 10A), (ii) mean particle size (FIG. 10B), (iii) residual DNA (FIG. 10C), and (iv) residual HCP (FIG. 10D).

The above results suggest that the GF depth filters are not necessary, and that the LA media and/or SP media grade depth filter-based clarification steps described herein are effective in improving EV product quality, even on a large scale.

1. A method of preparing purified extracellular vesicles (EVs) from a sample which comprises EVs and one or more impurities, the method comprising (i) contacting the sample with a depth filter selected from a low aluminum (LA) media grade depth filter, a SP media grade depth filter, or both; and (ii) collecting a filtrate from the depth filter, wherein the method reduces one or more impurities of an EV preparation.

2. (canceled)

3. The method of claim 1, wherein the one or more impurities of the EV preparation is decreased compared to one or more impurities of a reference EV preparation, wherein the reference EV preparation was obtained from a corresponding sample that was not contacted with the depth filter prior to a chromatography,
wherein the one or more impurities of the EV preparation is decreased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the reference EV preparation.

4. (canceled)

5. The method of claim 1, wherein a dynamic binding capacity of a chromatography resin is increased compared to a reference dynamic binding capacity, by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more.

6-7. (canceled)

8. The method of claim 1, which comprises subjecting the sample to a pre-treatment prior to contacting the sample with the depth filter, wherein the pre-treatment is capable of increasing the filterability of the sample, wherein the pre-treatment comprises an agent selected from an acid selected from acetic, acid, citric acid, carboxylic acid, sialic acid, polyaspartic acid, and polyglutamic acid, a salt selected from[NH₄]₂SO₄, K₂SO₄, and KH₂PO₄, a cationic polymer selected from chitosan, pDADMAC, and PEI, an ethylene glycol, a propylene glycol, a polyethylene glycol, a polypropylene glycol, an urea, an arginine-HCl, a lysine, a glycine, a histidine, a calcium, a sodium, a lithium, a potassium, an iodide, a magnesium, an iron, a zinc, a manganese, an aluminum, an ammonium, guanidium polyethylene glycol, a protease inhibitor selected from EDTA and EGTA, an anti-oxidant selected from cysteine and N-acetyl cysteine), a detergent, a chloride, a sulfate, a phosphate, an acetate, a borate, a formate, a perchlorate, a bromine, a nitrate, a dithiothreitol, a beta mercaptoethanol, a tri-n-butyl phosphate, a polyanion, a polyarginine, a polylysine, a polyhistidine, and a combination thereof.

9. (canceled)

10. The method of claim 1, wherein the depth filter has a pore size of less than about 2 μm, less than about 1.9 μm, less than about 1.8 μm, less than about 1.7 μm, less than about 1.6 μm, less than about 1.5 μm, less than about 1.4 μm, less than about 1.3 μm, less than about 1.2 μm, less than about 1.1 μm, less than about 1 μm, less than about 0.9 μm, less than about 0.8 μm, less than about 0.7 μm, less than about 0.6 μm, less than about 0.5 μm, less than about 0.4 μm, less than about 0.3 μm, less than about 0.2 μm, less than about 0.1 μm, or less than about 0.05 μm.

11. The method of claim 1, wherein:
(a) the filtrate comprises at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the EVs present in the sample following the contacting,
(b) a turbidity of the filtrate is reduced by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to a reference filtrate that was not contacted with the depth filter, and
(c) the amount of the one or more impurities present in the filtrate is reduced by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to the amount of the one or more impurities present in the sample prior to the contacting with the depth filter.

12-13. (canceled)

14. The method of claim 1, wherein the one or more impurities comprise a nucleic acid molecule, a protein, or both, and wherein the nucleic acid molecule and the protein are not associated with the EVs.

15. (canceled)

16. The method of claim 1, wherein the one or more impurities comprise a histone aggregate, a scaffold moiety aggregate, a beta-actin binding protein, or any combination thereof.

17. The method of claim 1, further comprising (iii) contacting the filtrate with a chromatography resin, wherein the contacting results in one or more EVs of the filtrate to attach to the chromatography resin, wherein the chromatography resin comprises a cation exchange (CEX) chromatography resin, an anion exchange (AEX) chromatography resin, a mixed mode chromatography (MMC) resin, an affinity chromatography resin, a pseudo affinity chromatography resin, a hydrophobic interaction resin, a hydrophobic charge induction resin, an immobilized metal affinity resin, a ceramic hydroxyapatite resin, a fluoro hydroxyapatite resin, or any combination thereof.

18-19. (canceled)

20. The method of claim 17, wherein the filtrate is contacted with the chromatography resin in a loading buffer, which comprises a salt selected from NaCl, KCl, PO₄, CaCl₂, MgCl₂, Mg₂SO₄, ZnCl₂, MnCl₂, MnSO₄, NaSCN, KSCN, LiCl, NaPO₄, K₂HPO₄, Na₂SO₄, K₂SO₄, NaAcetate, sodium bromide, lithium chloride, sodium iodide, potassium bromide, lithium bromide, sodium fluoride, potassium fluoride, lithium fluoride, lithium iodide, sodium acetate, potassium acetate, lithium acetate, potassium iodide, calcium sulfate, sodium sulfate, chromium trichloride, chromium sulfate, sodium citrate, iron (III) chloride, yttrium (III) chloride, potassium phosphate, potassium sulfate, sodium phosphate, ferrous chloride, calcium citrate, magnesium phosphate, ferric chloride, arginine-HCl, and any combination thereof.

21-22. (canceled)

23. The method of claim 17, further comprising (iv) contacting the chromatography resin with a wash buffer, wherein (iv) occurs after (iii).

24. The method of claim 23, wherein the wash buffer comprises:
(a), a nuclease, wherein the nuclease comprises an endonuclease, exonuclease, or both, wherein the endonuclease comprises a salt active nuclease (SAN), Benzonase, Denarase, Kryptonase, or any combination thereof;
(b) a cation, wherein the cation comprises a monovalent cation, a divalent cation, or both;
(c) an anion;
(d) an excipient, wherein the excipient is selected from an acid selected from acetic, acid, citric acid, carboxylic acid, sialic acid, polyaspartic acid, and polyglutamic acid, a salt selected from [NH4]2SO4, K2SO4, and KH2PO4, a cationic polymer selected from chitosan, pDADMAC, and PEI), an ethylene glycol, a propylene glycol, a polyethylene glycol, a polypropylene glycol, an urea, an arginine-HCl, a lysine, a glycine, a histidine, a calcium, a sodium, a lithium, a potassium, an iodide, a magnesium, an iron, a zinc, a manganese, an aluminum, an ammonium, guanidium polyethylene glycol, a protease inhibitor selected from EDTA and EGTA), an anti-oxidant selected from cysteine and N-acetyl cysteine, a detergent, a chloride, a sulfate, a phosphate, an acetate, a borate, a formate, a perchlorate, a bromine, a nitrate, a dithiothreitol, a beta mercaptoethanol, a tri-n-butyl phosphate, a polyanion, a polyarginine, a polylysine, a polyhistidine, and a combination thereof; or
(e) any combination of (a) to (d); and
wherein the chromatography resin is contacted with the wash buffer at least 2 times, at least 3 times, at least 4 times, or at least 5 times.

25-35. (canceled)

36. The method of claim 23, further comprising (v) contacting the chromatography resin with an elution buffer, wherein (v) occurs after (iv), wherein the contacting of the chromatography resin with the elution buffer releases one or more of the attached EVs from the chromatography resin.

37. (canceled)

38. The method of claim 36, further comprising (vi) collecting an eluent after (v),
wherein the eluent comprises EVs,
wherein a concentration of the EVs present in the eluent is increased by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to a reference concentration,
wherein a mean particle size of the eluent is reduced by at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, or at least about 50-fold or more, compared to a reference mean particle, wherein the mean particle size of the eluent is between about 20 nm to about 300 nm, and
wherein a polydispersity index of the eluent is reduced by at least about 10%, at least about 20%, at least about 30%, at least about 40%, at least about 50%, at least about 60%, at least about 70%, at least about 80%, or at least about 90% or more, compared to a reference polydispersity index.

39-49. (canceled)

50. The method of claim 38, further comprising contacting the eluent with one or more additional chromatography resins, wherein the one or more additional chromatography resins comprise an anion exchange chromatography (AEX) resin, a cation exchange chromatography (CEX) resin, a mixed mode chromatography (MMC) resin, a hydrophobic charge induction chromatography resin, an immobilized metal affinity resin, an affinity resin, a pseudo affinity resin, a hydrophobic interaction chromatography resin, or any combination thereof.

51-52. (canceled)

53. The method of claim 50, which comprises a first chromatography step a second chromatography step, and a third chromatography step,
wherein the first chromatography step comprises contacting the filtrate with a AEX chromatography resin,
wherein the second chromatography step comprises contacting the eluent from the first chromatography step with a MMC chromatography resin, and
wherein the third chromatography step comprises contacting the eluent from the second chromatography step with an additional MMC chromatography resin.

54. (canceled)

55. The method of claim 50, wherein the sample is contacted with the chromatography resin and/or the additional chromatography resin at least two times, at least three times, at least four times, at least five times, at least six times, at least seven times, at least eight times, at least nine times, at least eight times, at least nine times, at least ten times, at least 11 times, at least 12 times, at least 13 times, at least 14 times, at least 15 times, at least 16 times, at least 17 times, at least 18 times, at least 19 times, at least 20 times, at least 21 times, at least 22 times, at least 23 times, at least 24 times, or at least 25 times, and
wherein the sample is contacted with:
a. an AEX resin;
b. a CEX resin;
C. a MMC resin;
d. an affinity chromatography resin;
e. a HIC resin;
f. a ceramic hydroxyapatite resin;
g. an IMAC resin;
h. a HCIC resin; or
i. any combination thereof.

56. (canceled)

57. The method of claim 1, wherein the EV is an exosome.

58. A composition comprising extracellular vesicles (EVs) prepared by the method of claim 1, the composition further comprising:
a. a saccharide,
b. sodium chloride, wherein the sodium chloride is present at a concentration of between about 0.01 M to about 2 M,
c. potassium phosphate,
d. sodium phosphate,
e. tris, wherein the tris is present at a concentration of about 0.01 M to about 0.1 M,
f. magnesium chloride, wherein the magnesium chloride is present at a concentration of about 0.0001 M to about 1 M, or
g. any combination thereof.

59-67. (canceled)

68. The composition of claim 58, wherein the composition is in a solution at a pH of 7.2 and at a conductivity of 8.8 mS/cm+/−10%.

69. (canceled)


SEQUENCE LISTING (380 sequences)

SEQ ID NO: 1 - protein, 879 aa, Homo sapiens
MGRLASRPLLLALLSLALCRGRVVRVPTATLVRVVGTELVIPCNVSDYDGPSEQNFDWSFSSLGSSFVELASTWEVGFPAQLYQERLQRGEILLRRTANDAVELHIKNVQPSDQGHYKCSTPSTDATVQGNYEDTVQVKVLADSLHVGPSARPPPSLSLREGEPFELRCTAASASPLHTHLALLWEVHRGPARRSVLALTHEGRFHPGLGYEQRYHSGDVRLDTVGSDAYRLSVSRALSADQGSYRCIVSEWIAEQGNWQEIQEKAVEVATVVIQPSVLRAAVPKNVSVAEGKELDLTCNITTDRADDVRPEVTWSFSRMPDSTLPGSRVLARLDRDSLVHSSPHVALSHVDARSYHLLVRDVSKENSGYYYCHVSLWAPGHNRSWHKVAEAVSSPAGVGVTWLEPDYQVYLNASKVPGFADDPTELACRVVDTKSGEANVRFTVSWYYRMNRRSDNVVTSELLAVMDGDWTLKYGERSKQRAQDGDFIFSKEHTDTFNFRIQRTTEEDRGNYYCVVSAWTKQRNNSWVKSKDVFSKPVNIFWALEDSVLVVKARQPKPFFAAGNTFEMTCKVSSKNIKSPRYSVLIMAEKPVGDLSSPNETKYIISLDQDSVVKLENWTDASRVDGVVLEKVQEDEFRYRMYQTQVSDAGLYRCMVTAWSPVRGSLWREAATSLSNPIEIDFQTSGPIFNASVHSDTPSVIRGDLIKLFCIITVEGAALDPDDMAFDVSWFAVHSFGLDKAPVLLSSLDRKGIVTTSRRDWKSDLSLERVSVLEFLLQVHGSEDQDFGNYYCSVTPWVKSPTGSWQKEAEIHSKPVFITVKMDVLNAFKYPLLIGVGLSTVIGLLSCLIGYCSSHWCCKKEVQETRRERRRLMSMEMD

SEQ ID NO: 2 - protein, 731 aa, Homo sapiens
PSARPPPSLSLREGEPFELRCTAASASPLHTHLALLWEVHRGPARRSVLALTHEGRFHPGLGYEQRYHSGDVRLDTVGSDAYRLSVSRALSADQGSYRCIVSEWIAEQGNWQEIQEKAVEVATVVIQPSVLRAAVPKNVSVAEGKELDLTCNITTDRADDVRPEVTWSFSRMPDSTLPGSRVLARLDRDSLVHSSPHVALSHVDARSYHLLVRDVSKENSGYYYCHVSLWAPGHNRSWHKVAEAVSSPAGVGVTWLEPDYQVYLNASKVPGFADDPTELACRVVDTKSGEANVRFTVSWYYRMNRRSDNVVTSELLAVMDGDWTLKYGERSKQRAQDGDFIFSKEHTDTFNFRIQRTTEEDRGNYYCVVSAWTKQRNNSWVKSKDVFSKPVNIFWALEDSVLVVKARQPKPFFAAGNTFEMTCKVSSKNIKSPRYSVLIMAEKPVGDLSSPNETKYIISLDQDSVVKLENWTDASRVDGVVLEKVQEDEFRYRMYQTQVSDAGLYRCMVTAWSPVRGSLWREAATSLSNPIEIDFQTSGPIFNASVHSDTPSVIRGDLIKLFCIITVEGAALDPDDMAFDVSWFAVHSFGLDKAPVLLSSLDRKGIVTTSRRDWKSDLSLERVSVLEFLLQVHGSEDQDFGNYYCSVTPWVKSPTGSWQKEAEIHSKPVFITVKMDVLNAFKYPLLIGVGLSTVIGLLSCLIGYCSSHWCCKKEVQETRRERRRLMSMEMD

SEQ ID NO: 3 - protein, 611 aa, Homo sapiens
VATVVIQPSVLRAAVPKNVSVAEGKELDLTCNITTDRADDVRPEVTWSFSRMPDSTLPGSRVLARLDRDSLVHSSPHVALSHVDARSYHLLVRDVSKENSGYYYCHVSLWAPGHNRSWHKVAEAVSSPAGVGVTWLEPDYQVYLNASKVPGFADDPTELACRVVDTKSGEANVRFTVSWYYRMNRRSDNVVTSELLAVMDGDWTLKYGERSKQRAQDGDFIFSKEHTDTFNFRIQRTTEEDRGNYYCVVSAWTKQRNNSWVKSKDVFSKPVNIFWALEDSVLVVKARQPKPFFAAGNTFEMTCKVSSKNIKSPRYSVLIMAEKPVGDLSSPNETKYIISLDQDSVVKLENWTDASRVDGVVLEKVQEDEFRYRMYQTQVSDAGLYRCMVTAWSPVRGSLWREAATSLSNPIEIDFQTSGPIFNASVHSDTPSVIRGDLIKLFCIITVEGAALDPDDMAFDVSWFAVHSFGLDKAPVLLSSLDRKGIVTTSRRDWKSDLSLERVSVLEFLLQVHGSEDQDFGNYYCSVTPWVKSPTGSWQKEAEIHSKPVFITVKMDVLNAFKYPLLIGVGLSTVIGLLSCLIGYCSSHWCCKKEVQETRRERRRLMSMEMD

SEQ ID NO: 4 - protein, 485 aa, homo sapien
SPAGVGVTWLEPDYQVYLNASKVPGFADDPTELACRVVDTKSGEANVRFTVSWYYRMNRRSDNVVTSELLAVMDGDWTLKYGERSKQRAQDGDFIFSKEHTDTFNFRIQRTTEEDRGNYYCVVSAWTKQRNNSWVKSKDVFSKPVNIFWALEDSVLVVKARQPKPFFAAGNTFEMTCKVSSKNIKSPRYSVLIMAEKPVGDLSSPNETKYIISLDQDSVVKLENWTDASRVDGVVLEKVQEDEFRYRMYQTQVSDAGLYRCMVTAWSPVRGSLWREAATSLSNPIEIDFQTSGPIFNASVHSDTPSVIRGDLIKLFCIITVEGAALDPDDMAFDVSWFAVHSFGLDKAPVLLSSLDRKGIVTTSRRDWKSDLSLERVSVLEFLLQVHGSEDQDFGNYYCSVTPWVKSPTGSWQKEAEIHSKPVFITVKMDVLNAFKYPLLIGVGLSTVIGLLSCLIGYCSSHWCCKKEVQETRRERRRLMSMEMD

SEQ ID NO: 5 - protein, 343 aa, Homo sapiens
KPVNIFWALEDSVLVVKARQPKPFFAAGNTFEMTCKVSSKNIKSPRYSVLIMAEKPVGDLSSPNETKYIISLDQDSVVKLENWTDASRVDGVVLEKVQEDEFRYRMYQTQVSDAGLYRCMVTAWSPVRGSLWREAATSLSNPIEIDFQTSGPIFNASVHSDTPSVIRGDLIKLFCIITVEGAALDPDDMAFDVSWFAVHSFGLDKAPVLLSSLDRKGIVTTSRRDWKSDLSLERVSVLEFLLQVHGSEDQDFGNYYCSVTPWVKSPTGSWQKEAEIHSKPVFITVKMDVLNAFKYPLLIGVGLSTVIGLLSCLIGYCSSHWCCKKEVQETRRERRRLMSMEMD

SEQ ID NO: 6 - protein, 217 aa, Homo sapiens
VRGSLWREAATSLSNPIEIDFQTSGPIFNASVHSDTPSVIRGDLIKLFCIITVEGAALDPDDMAFDVSWFAVHSFGLDKAPVLLSSLDRKGIVTTSRRDWKSDLSLERVSVLEFLLQVHGSEDQDFGNYYCSVTPWVKSPTGSWQKEAEIHSKPVFITVKMDVLNAFKYPLLIGVGLSTVIGLLSCLIGYCSSHWCCKKEVQETRRERRRLMSMEMD

SEQ ID NO: 7 - protein, 66 aa, homo sapiens
SKPVFITVKMDVLNAFKYPLLIGVGLSTVIGLLSCLIGYCSSHWCCKKEVQETRRERRRLMSMEMD

SEQ ID NO: 8 - protein, 21 aa, Homo sapiens
MGRLASRPLLLALLSLALCRG

SEQ ID NO: 9 - protein, 385 aa, Homo sapiens
MAAALFVLLGFALLGTHGASGAAGFVQAPLSQQRWVGGSVELHCEAVGSPVPEIQWWFEGQGPNDTCSQLWDGARLDRVHIHATYHQHAASTISIDTLVEEDTGTYECRASNDPDRNHLTRAPRVKWVRAQAVVLVLEPGTVFTTVEDLGSKILLTCSLNDSATEVTGHRWLKGGVVLKEDALPGQKTEFKVDSDDQWGEYSCVFLPEPMGTANIQLHGPPRVKAVKSSEHINEGETAMLVCKSESVPPVTDWAWYKITDSEDKALMNGSESRFFVSSSQGRSELHIENLNMEADPGQYRCNGTSSKGSDQAIITLRVRSHLAALWPFLGIVAEVLVLVTIIFIYEKRRKPEDVLDDDDAGSAPLKSSGQHQNDKGKNVRQRNSS

SEQ ID NO: 10 - protein, 247 aa, Homo sapiens
PGTVFTTVEDLGSKILLTCSLNDSATEVTGHRWLKGGVVLKEDALPGQKTEFKVDSDDQWGEYSCVFLPEPMGTANIQLHGPPRVKAVKSSEHINEGETAMLVCKSESVPPVTDWAWYKITDSEDKALMNGSESRFFVSSSQGRSELHIENLNMEADPGQYRCNGTSSKGSDQAIITLRVRSHLAALWPFLGIVAEVLVLVTIIFIYEKRRKPEDVLDDDDAGSAPLKSSGQHQNDKGKNVRQRNSS

SEQ ID NO: 11 - protein, 168 aa, Homo sapiens
HGPPRVKAVKSSEHINEGETAMLVCKSESVPPVTDWAWYKITDSEDKALMNGSESRFFVSSSQGRSELHIENLNMEADPGQYRCNGTSSKGSDQAIITLRVRSHLAALWPFLGIVAEVLVLVTIIFIYEKRRKPEDVLDDDDAGSAPLKSSGQHQNDKGKNVRQRNSS

SEQ ID NO: 12 - protein, 66 aa, homo sapiens
SHLAALWPFLGIVAEVLVLVTIIFIYEKRRKPEDVLDDDDAGSAPLKSSGQHQNDKGKNVRQRNSS

SEQ ID NO: 13 - protein, 18 aa, homo sapiens
MAAALFVLLGFALLGTHG

SEQ ID NO: 14 - protein, 613 aa, homo sapiens
MGALRPTLLPPSLPLLLLLMLGMGCWAREVLVPEGPLYRVAGTAVSISCNVTGYEGPAQQNFEWFLYRPEAPDTALGIVSTKDTQFSYAVFKSRVVAGEVQVQRLQGDAVVLKIARLQAQDAGIYECHTPSTDTRYLGSYSGKVELRVLPDVLQVSAAPPGPRGRQAPTSPPRMTVHEGQELALGCLARTSTQKHTHLAVSFGRSVPEAPVGRSTLQEVVGIRSDLAVEAGAPYAERLAAGELRLGKEGTDRYRMVVGGAQAGDAGTYHCTAAEWIQDPDGSWAQIAEKRAVLAHVDVQTLSSQLAVTVGPGERRIGPGEPLELLCNVSGALPPAGRHAAYSVGWEMAPAGAPGPGRLVAQLDTEGVGSLGPGYEGRHIAMEKVASRTYRLRLEAARPGDAGTYRCLAKAYVRGSGTRLREAASARSRPLPVHVREEGVVLEAVAWLAGGTVYRGETASLLCNISVRGGPPGLRLAASWWVERPEDGELSSVPAQLVGGVGQDGVAELGVRPGGGPVSVELVGPRSHRLRLHSLGPEDEGVYHCAPSAWVQHADYSWYQAGSARSGPVTVYPYMHALDTLFVPLLVGTGVALVTGATVLGTITCCFMKRLRKR

SEQ ID NO: 15 - protein, 456 aa, homo sapiens
APPGPRGRQAPTSPPRMTVHEGQELALGCLARTSTQKHTHLAVSFGRSVPEAPVGRSTLQEVVGIRSDLAVEAGAPYAERLAAGELRLGKEGTDRYRMVVGGAQAGDAGTYHCTAAEWIQDPDGSWAQIAEKRAVLAHVDVQTLSSQLAVTVGPGERRIGPGEPLELLCNVSGALPPAGRHAAYSVGWEMAPAGAPGPGRLVAQLDTEGVGSLGPGYEGRHIAMEKVASRTYRLRLEAARPGDAGTYRCLAKAYVRGSGTRLREAASARSRPLPVHVREEGVVLEAVAWLAGGTVYRGETASLLCNISVRGGPPGLRLAASWWVERPEDGELSSVPAQLVGGVGQDGVAELGVRPGGGPVSVELVGPRSHRLRLHSLGPEDEGVYHCAPSAWVQHADYSWYQAGSARSGPVTVYPYMHALDTLFVPLLVGTGVALVTGATVLGTITCCFMKRLRKR

SEQ ID NO: 16 - protein, 320 aa, Homo sapiens
AHVDVQTLSSQLAVTVGPGERRIGPGEPLELLCNVSGALPPAGRHAAYSVGWEMAPAGAPGPGRLVAQLDTEGVGSLGPGYEGRHIAMEKVASRTYRLRLEAARPGDAGTYRCLAKAYVRGSGTRLREAASARSRPLPVHVREEGVVLEAVAWLAGGTVYRGETASLLCNISVRGGPPGLRLAASWWVERPEDGELSSVPAQLVGGVGQDGVAELGVRPGGGPVSVELVGPRSHRLRLHSLGPEDEGVYHCAPSAWVQHADYSWYQAGSARSGPVTVYPYMHALDTLFVPLLVGTGVALVTGATVLGTITCCFMKRLRKR

SEQ ID NO: 17 - protein, 179 aa, homo sapiens
REEGVVLEAVAWLAGGTVYRGETASLLCNISVRGGPPGLRLAASWWVERPEDGELSSVPAQLVGGVGQDGVAELGVRPGGGPVSVELVGPRSHRLRLHSLGPEDEGVYHCAPSAWVQHADYSWYQAGSARSGPVTVYPYMHALDTLFVPLLVGTGVALVTGATVLGTITCCFMKRLRKR

SEQ ID NO: 18 - protein, 24 aa, Homo sapiens
VALVTGATVLGTITCCFMKRLRKR

SEQ ID NO: 19 - protein, 27 aa, Homo sapiens
MGALRPTLLPPSLPLLLLLMLGMGCWA

SEQ ID NO: 20 - protein, 1195 aa, homo sapiens
MKCFFPVLSCLAVLGVVSAQRQVTVQEGPLYRTEGSHITIWCNVSGYQGPSEQNFQWSIYLPSSPEREVQIVSTMDSSFPYAIYTQRVRGGKIFIERVQGNSTLLHITDLQARDAGEYECHTPSTDKQYFGSYSAKMNLVVIPDSLQTTAMPQTLHRVEQDPLELTCEVASETIQHSHLSVAWLRQKVGEKPVEVISLSRDFMLHSSSEYAQRQSLGEVRLDKLGRTTFRLTIFHLQPSDQGEFYCEAAEWIQDPDGSWYAMTRKRSEGAVVNVQPTDKEFTVRLETEKRLHTVGEPVEFRCILEAQNVPDRYFAVSWAFNSSLIATMGPNAVPVLNSEFAHREARGQLKVAKESDSVFVLKIYHLRQEDSGKYNCRVTEREKTVTGEFIDKESKRPKNIPIIVLPLKSSISVEVASNASVILEGEDLRFSCSVRTAGRPQGRFSVIWQLVDRQNRRSNIMWLDRDGTVQPGSSYWERSSFGGVQMEQVQPNSFSLGIFNSRKEDEGQYECHVTEWVRAVDGEWQIVGERRASTPISITALEMGFAVTAISRTPGVTYSDSFDLQCIIKPHYPAWVPVSVTWRFQPVGTVEFHDLVTFTRDGGVQWGDRSSSFRTRTAIEKAESSNNVRLSISRASDTEAGKYQCVAELWRKNYNNTWTRLAERTSNLLEIRVLQPVTKLQVSKSKRTLTLVENKPIQLNCSVKSQTSQNSHFAVLWYVHKPSDADGKLILKTTHNSAFEYGTYAEEEGLRARLQFERHVSGGLFSLTVQRAEVSDSGSYYCHVEEWLLSPNYAWYKLAEEVSGRTEVTVKQPDSRLRLSQAQGNLSVLETRQVQLECVVLNRTSITSQLMVEWFVWKPNHPERETVARLSRDATFHYGEQAAKNNLKGRLHLESPSPGVYRLFIQNVAVQDSGTYSCHVEEWLPSPSGMWYKRAEDTAGQTALTVMRPDASLQVDTVVPNATVSEKAAFQLDCSIVSRSSQDSRFAVAWYSLRTKAGGKRSSPGLEEQEEEREEEEEEEEDDDDDDPTERTALLSVGPDAVFGPEGSPWEGRLRFQRLSPVLYRLTVLQASPQDTGNYSCHVEEWLPSPQKEWYRLTEEESAPIGIRVLDTSPTLQSIICSNDALFYFVFFYPFPIFGILIITILLVRFKSRNSSKNSDGKNGVPLLWIKEPHLNYSPTCLEPPVLSIHPGAID

SEQ ID NO: 21 - protein, 798 aa, homo sapiens
MNLQPIFWIGLISSVCCVFAQTDENRCLKANAKSCGECIQAGPNCGWCTNSTFLQEGMPTSARCDDLEALKKKGCPPDDIENPRGSKDIKKNKNVTNRSKGTAEKLKPEDITQIQPQQLVLRLRSGEPQTFTLKFKRAEDYPIDLYYLMDLSYSMKDDLENVKSLGTDLMNEMRRITSDFRIGFGSFVEKTVMPYISTTPAKLRNPCTSEQNCTSPFSYKNVLSLTNKGEVFNELVGKQRISGNLDSPEGGFDAIMQVAVCGSLIGWRNVTRLLVFSTDAGFHFAGDGKLGGIVLPNDGQCHLENNMYTMSHYYDYPSIAHLVQKLSENNIQTIFAVTEEFQPVYKELKNLIPKSAVGTLSANSSNVIQLIIDAYNSLSSEVILENGKLSEGVTISYKSYCKNGVNGTGENGRKCSNISIGDEVQFEISITSNKCPKKDSDSFKIRPLGFTEEVEVILQYICECECQSEGIPESPKCHEGNGTFECGACRCNEGRVGRHCECSTDEVNSEDMDAYCRKENSSEICSNNGECVCGQCVCRKRDNTNEIYSGKFCECDNFNCDRSNGLICGGNGVCKCRVCECNPNYTGSACDCSLDTSTCEASNGQICNGRGICECGVCKCTDPKFQGQTCEMCQTCLGVCAEHKECVQCRAFNKGEKKDTCTQECSYFNITKVESRDKLPQPVQPDPVSHCKEKDVDDCWFYFTYSVNGNNEVMVHVVENPECPTGPDIIPIVAGVVAGIVLIGLALLLIWKLLMIIHDRREFAKFEKEKMNAKWDTGENPIYKSAVTTVVNPKYEGK

SEQ ID NO: 22 - protein, 1032 aa, homo sapiens [sequence omitted]

SEQ ID NO: 23 - protein, 660 aa, homo sapiens
MELQPPEASIAVVSIPRQLPGSHSEAGVQGLSAGDDSELGSHCVAQTGLELLASGDPLPSASQNAEMIETGSDCVTQAGLQLLASSDPPALASKNAEVTETGFHHVSQADIEFLTSIDPTASASGSAGITGTMSQDTEVDMKEVELNELEPEKQPMNAASGAAMSLAGAEKNGLVKIKVAEDEAEAAAAAKFTGLSKEELLKVAGSPGWVRTRWALLLLFWLGWLGMLAGAVVIIVRAPRCRELPAQKWWHTGALYRIGDLQAFQGHGAGNLAGLKGRLDYLSSLKVKGLVLGPIHKNQKDDVAQTDLLQIDPNFGSKEDFDSLLQSAKKKSIRVILDLTPNYRGENSWFSTQVDTVATKVKDALEFWLQAGVDGFQVRDIENLKDASSFLAEWQNITKGFSEDRLLIAGTNSSDLQQILSLLESNKDLLLTSSYLSDSGSTGEHTKSLVTQYLNATGNRWCSWSLSQARLLTSFLPAQLLRLYQLMLFTLPGTPVFSYGDEIGLDAAALPGQPMEAPVMLWDESSFPDIPGAVSANMTVKGQSEDPGSLLSLFRRLSDQRSKERSLLHGDFHAFSAGPGLFSYIRHWDQNERFLVVLNFGDVGLSAGLQASDLPASASLPAKADLLLSTQPGREEGSPLELERLKLEPHEGLLLRFPYA

SEQ ID NO: 24 - protein, 1023 aa, homo sapiens
MGKGVGRDKYEPAAVSEQGDKKGKKGKKDRDMDELKKEVSMDDHKLSLDELHRKYGTDLSRGLTSARAAEILARDGPNALTPPPTTPEWIKFCRQLFGGFSMLLWIGAILCFLAYSIQAATEEEPQNDNLYLGVVLSAVVIITGCFSYYQEAKSSKIMESFKNMVPQQALVIRNGEKMSINAEEVVVGDLVEVKGGDRIPADLRIISANGCKVDNSSLTGESEPQTRSPDFTNENPLETRNIAFFSTNCVEGTARGIVVYTGDRTVMGRIATLASGLEGGQTPIAAEIEHFIHIITGVAVFLGVSFFILSLILEYTWLEAVIFLIGIIVANVPEGLLATVTVCLTLTAKRMARKNCLVKNLEAVETLGSTSTICSDKTGTLTQNRMTVAHMWFDNQIHEADTTENQSGVSFDKTSATWLALSRIAGLCNRAVFQANQENLPILKRAVAGDASESALLKCIELCCGSVKEMRERYAKIVEIPFNSTNKYQLSIHKNPNTSEPQHLLVMKGAPERILDRCSSILLHGKEQPLDEELKDAFQNAYLELGGLGERVLGFCHLFLPDEQFPEGFQFDTDDVNFPIDNLCFVGLISMIDPPRAAVPDAVGKCRSAGIKVIMVTGDHPITAKAIAKGVGIISEGNETVEDIAARLNIPVSQVNPRDAKACVVHGSDLKDMTSEQLDDILKYHTEIVFARTSPQQKLIIVEGCQRQGAIVAVTGDGVNDSPALKKADIGVAMGIAGSDVSKQAADMILLDDNFASIVTGVEEGRLIFDNLKKSIAYTLTSNIPEITPFLIFIIANIPLPLGTVTILCIDLGTDMVPAISLAYEQAESDIMKRQPRNPKTDKLVNERLISMAYGQIGMIQALGGFFTYFVILAENGFLPIHLLGLRVDWDDRWINDVEDSYGQQWTYEQRKIVEFTCHTAFFVSIVVVQWADLVICKTRRNSVFQQGMKNKILIFGLFEETALAAFLSYCPGMGVALRMYPLKPTWWFCAFPYSLLIFVYDEVRKLIIRRRPGGWVEKETYY

SEQ ID NO: 25 - protein, 1020 aa, homo sapiens
MGRGAGREYSPAATTAENGGGKKKQKEKELDELKKEVAMDDHKLSLDELGRKYQVDLSKGLTNQRAQDVLARDGPNALTPPPTTPEWVKFCRQLFGGFSILLWIGAILCFLAYGIQAAMEDEPSNDNLYLGVVLAAVVIVTGCFSYYQEAKSSKIMDSFKNMVPQQALVIREGEKMQINAEEVVVGDLVEVKGGDRVPADLRIISSHGCKVDNSSLTGESEPQTRSPEFTHENPLETRNICFFSTNCVEGTARGIVIATGDRTVMGRIATLASGLEVGRTPIAMEIEHFIQLITGVAVFLGVSFFVLSLILGYSWLEAVIFLIGIIVANVPEGLLATVTVCLTLTAKRMARKNCLVKNLEAVETLGSTSTICSDKTGTLTQNRMTVAHMWFDNQIHEADTTEDQSGATFDKRSPTWTALSRIAGLCNRAVFKAGQENISVSKRDTAGDASESALLKCIELSCGSVRKMRDRNPKVAEIPFNSTNKYQLSIHEREDSPQSHVLVMKGAPERILDRCSTILVQGKEIPLDKEMQDAFQNAYMELGGLGERVLGFCQLNLPSGKFPRGFKFDTDELNFPTEKLCFVGLMSMIDPPRAAVPDAVGKCRSAGIKVIMVTGDHPITAKAIAKGVGIISEGNETVEDIAARLNIPMSQVNPREAKACVVHGSDLKDMTSEQLDEILKNHTEIVFARTSPQQKLIIVEGCQRQGAIVAVTGDGVNDSPALKKADIGIAMGISGSDVSKQAADMILLDDNFASIVTGVEEGRLIFDNLKKSIAYTLTSNIPEITPFLLFIIANIPLPLGTVTILCIDLGTDMVPAISLAYEAAESDIMKRQPRNSQTDKLVNERLISMAYGQIGMIQALGGFFTYFVILAENGFLPSRLLGIRLDWDDRTMNDLEDSYGQEWTYEQRKVVEFTCHTAFFASIVVVQWADLIICKTRRNSVFQQGMKNKILIFGLLEETALAAFLSYCPGMGVALRMYPLKVTWWFCAFPYSLLIFIYDEVRKLILRRYPGGWVEKETYY

SEQ ID NO: 26 - protein, 1026 aa, homo sapiens
MGSGGSDSYRIATSQDKKDDKDSPKKNKGKERRDLDDLKKEVAMTEHKMSVEEVCRKYNTDCVQGLTHSKAQEILARDGPNALTPPPTTPEWVKFCRQLFGGFSILLWIGAILCFLAYGIQAGTEDDPSGDNLYLGIVLAAVVIITGCFSYYQEAKSSKIMESFKNMVPQQALVIREGEKMQVNAEEVVVGDLVEIKGGDRVPADLRIISAHGCKVDNSSLTGESEPQTRSPDCTHDNPLETRNITFFSTNCVEGTARGVVVATGDRTVMGRIATLASGLEVGKTPIAIEIEHFIQLITGVAVFLGVSFFILSLILGYTWLEAVIFLIGIIVANVPEGLLATVTVCLTLTAKRMARKNCLVKNLEAVETLGSTSTICSDKTGTLTQNRMTVAHMWFDNQIHEADTTEDQSGTSFDKSSHTWVALSHIAGLCNRAVFKGGQDNIPVLKRDVAGDASESALLKCIELSSGSVKLMRERNKKVAEIPFNSTNKYQLSIHETEDPNDNRYLLVMKGAPERILDRCSTILLQGKEQPLDEEMKEAFQNAYLELGGLGERVLGFCHYYLPEEQFPKGFAFDCDDVNFTTDNLCFVGLMSMIDPPRAAVPDAVGKCRSAGIKVIMVTGDHPITAKAIAKGVGIISEGNETVEDIAARLNIPVSQVNPRDAKACVIHGTDLKDFTSEQIDEILQNHTEIVFARTSPQQKLIIVEGCQRQGAIVAVTGDGVNDSPALKKADIGVAMGIAGSDVSKQAADMILLDDNFASIVTGVEEGRLIFDNLKKSIAYTLTSNIPEITPFLLFIMANIPLPLGTITILCIDLGTDMVPAISLAYEAAESDIMKRQPRNPRTDKLVNERLISMAYGQIGMIQALGGFFSYFVILAENGFLPGNLVGIRLNWDDRTVNDLEDSYGQQWTYEQRKVVEFTCHTAFFVSIVVVQWADLIICKTRRNSVFQQGMKNKILIFGLFEETALAAFLSYCPGMDVALRMYPLKPSWWFCAFPYSFLIFVYDEIRKLILRRNPGGWVEKETYY

SEQ ID NO: 27 - protein, 1029 aa, Homo sapiens
MGLWGKKGTVAPHDQSPRRRPKKGLIKKKMVKREKQKRNMEELKKEVVMDDHKLTLEELSTKYSVDLTKGHSHQRAKEILTRGGPNTVTPPPTTPEWVKFCKQLFGGFSLLLWTGAILCFVAYSIQIYFNEEPTKDNLYLSIVLSVVVIVTGCFSYYQEAKSSKIMESFKNMVPQQALVIRGGEKMQINVQEVVLGDLVEIKGGDRVPADLRLISAQGCKVDNSSLTGESEPQSRSPDFTHENPLETRNICFFSTNCVEGTARGIVIATGDSTVMGRIASLTSGLAVGQTPIAAEIEHFIHLITVVAVFLGVTFFALSLLLGYGWLEAIIFLIGIIVANVPEGLLATVTVCLTLTAKRMARKNCLVKNLEAVETLGSTSTICSDKTGTLTQNRMTVAHMWFDMTVYEADTTEEQTGKTFTKSSDTWFMLARIAGLCNRADFKANQEILPIAKRATTGDASESALLKFIEQSYSSVAEMREKNPKVAEIPFNSTNKYQMSIHLREDSSQTHVLMMKGAPERILEFCSTFLLNGQEYSMNDEMKEAFQNAYLELGGLGERVLGFCFLNLPSSFSKGFPFNTDEINFPMDNLCFVGLISMIDPPRAAVPDAVSKCRSAGIKVIMVTGDHPITAKAIAKGVGIISEGTETAEEVAARLKIPISKVDASAAKAIVVHGAELKDIQSKQLDQILQNHPEIVFARTSPQQKLIIVEGCQRLGAVVAVTGDGVNDSPALKKADIGIAMGISGSDVSKQAADMILLDDNFASIVTGVEEGRLIFDNLKKSIMYTLTSNIPEITPFLMFIILGIPLPLGTITILCIDLGTDMVPAISLAYESAESDIMKRLPRNPKTDNLVNHRLIGMAYGQIGMIQALAGFFTYFVILAENGFRPVDLLGIRLHWEDKYLNDLEDSYGQQWTYEQRKVVEFTCQTAFFVTIVVVQWADLIISKTRRNSLFQQGMRNKVLIFGILEETLLAAFLSYTPGMDVALRMYPLKITWWLCAIPYSILIFVYDEIRKLLIRQHPDGWVERETYY

SEQ ID NO: 28 - protein, 279 aa, homo sapiens
MTKNEKKSLNQSLAEWKLFIYNPTTGEFLGRTAKSWGLILLFYLVFYGFLAALFSFTMWVMLQTLNDEVPKYRDQIPSPGLMVFPKPVTALEYTFSRSDPTSYAGYIEDLKKFLKPYTLEEQKNLTVCPDGALFEQKGPVYVACQFPISLLQACSGMNDPDFGYSQGNPCILVKMNRIIGLKPEGVPRIDCVSKNEDIPNVAVYPHNGMIDLKYFPYYGKKLHVGYLQPLVAVQVSFAPNNTGKEVTVECKIDGSANLKSQDDRDKFLGRVMFKITARA

SEQ ID NO: 29 - protein, 1258 aa, Homo sapiens
MGDMANNSVAYSGVKNSLKEANHDGDFGITLAELRALMELRSTDALRKIQESYGDVYGICTKLKTSPNEGLSGNPADLERREAVFGKNFIPPKKPKTFLQLVWEALQDVTLIILEIAAIVSLGLSFYQPPEGDNALCGEVSVGEEEGEGETGWIEGAAILLSVVCVVLVTAFNDWSKEKQFRGLQSRIEQEQKFTVIRGGQVIQIPVADITVGDIAQVKYGDLLPADGILIQGNDLKIDESSLTGESDHVKKSLDKDPLLLSGTHVMEGSGRMVVTAVGVNSQTGIIFTLLGAGGEEEEKKDEKKKEKKNKKQDGAIENRNKAKAQDGAAMEMQPLKSEEGGDGDEKDKKKANLPKKEKSVLQGKLTKLAVQIGKAGLLMSAITVIILVLYFVIDTFWVQKRPWLAECTPIYIQYFVKFFIIGVTVLVVAVPEGLPLAVTISLAYSVKKMMKDNNLVRHLDACETMGNATAICSDKTGTLTMNRMTVVQAYINEKHYKKVPEPEAIPPNILSYLVTGISVNCAYTSKILPPEKEGGLPRHVGNKTECALLGLLLDLKRDYQDVRNEIPEEALYKVYTFNSVRKSMSTVLKNSDGSYRIFSKGASEIILKKCFKILSANGEAKVFRPRDRDDIVKTVIEPMASEGLRTICLAFRDFPAGEPEPEWDNENDIVTGLTCIAVVGIEDPVRPEVPDAIKKCQRAGITVRMVTGDNINTARAIATKCGILHPGEDFLCLEGKDFNRRIRNEKGEIEQERIDKIWPKLRVLARSSPTDKHTLVKGIIDSTVSDQRQVVAVTGDGTNDGPALKKADVGFAMGIAGTDVAKEASDIILTDDNFTSIVKAVMWGRNVYDSISKFLQFQLTVNVVAVIVAFTGACITQDSPLKAVQMLWVNLIMDTLASLALATEPPTESLLLRKPYGRNKPLISRTMMKNILGHAFYQLVVVFTLLFAGEKFFDIDSGRNAPLHAPPSEHYTIVFNTFVLMQLFNEINARKIHGERNVFEGIFNNAIFCTIVLGTFVVQIIIVQFGGKPFSCSELSIEQWLWSIFLGMGTLLWGQLISTIPTSRLKFLKEAGHGTQKEEIPEEELAEDVEEIDHAERELRRGQILWFRGLNRIQTQMDVVNAFQSGSSIQGALRRQPSIASQHHDVTNISTPTHIRVVNAFRSSLYEGLEKPESRSSIHNFMTHPEFRIEDSEPHIPLIDDTDAEDDAPTKRNSSPPPSPNKNNNAVDSGIHLTIEMNKSATSSSPGSPLHSLETSL

SEQ ID NO: 30 - protein, 1272 aa, Homo sapiens
MGDMTNSDFYSKNQRNESSHGGEFGCTMEELRSLMELRGTEAVVKIKETYGDTEAICRRLKTSPVEGLPGTAPDLEKRKQIFGQNFIPPKKPKTFLQLVWEALQDVTLIILEIAAIISLGLSFYHPPGEGNEGCATAQGGAEDEGEAEAGWIEGAAILLSVICVVLVTAFNDWSKEKQFRGLQSRIEQEQKFTVVRAGQVVQIPVAEIVVGDIAQVKYGDLLPADGLFIQGNDLKIDESSLTGESDQVRKSVDKDPMLLSGTHVMEGSGRMLVTAVGVNSQTGIIFTLLGAGGEEEEKKDKKGVKKGDGLQLPAADGAAASNAADSANASLVNGKMQDGNVDASQSKAKQQDGAAAMEMQPLKSAEGGDADDRKKASMHKKEKSVLQGKLTKLAVQIGKAGLVMSAITVIILVLYFTVDTFVVNKKPWLPECTPVYVQYFVKFFIIGVTVLVVAVPEGLPLAVTISLAYSVKKMMKDNNLVRHLDACETMGNATAICSDKTGTLTTNRMTVVQAYVGDVHYKEIPDPSSINTKTMELLINAIAINSAYTTKILPPEKEGALPRQVGNKTECGLLGFVLDLKQDYEPVRSQMPEEKLYKVYTFNSVRKSMSTVIKLPDESFRMYSKGASEIVLKKCCKILNGAGEPRVFRPRDRDEMVKKVIEPMACDGLRTICVAYRDFPSSPEPDWDNENDILNELTCICVVGIEDPVRPEVPEAIRKCQRAGITVRMVTGDNINTARAIAIKCGIIHPGEDFLCLEGKEFNRRIRNEKGEIEQERIDKIWPKLRVLARSSPTDKHTLVKGIIDSTHTEQRQVVAVTGDGTNDGPALKKADVGFAMGIAGTDVAKEASDIILTDDNFSSIVKAVMWGRNVYDSISKFLQFQLTVNVVAVIVAFTGACITQDSPLKAVQMLWVNLIMDTFASLALATEPPTETLLLRKPYGRNKPLISRTMMKNILGHAVYQLALIFTLLFVGEKMFQIDSGRNAPLHSPPSEHYTIIFNTFVMMQLFNEINARKIHGERNVFDGIFRNPIFCTIVLGTFAIQIVIVQFGGKPFSCSPLQLDQWMWCIFIGLGELVWGQVIATIPTSRLKFLKEAGRLTQKEEIPEEELNEDVEEIDHAERELRRGQILWFRGLNRIQTQIEVVNTFKSGASFQGALRRQSSVTSQSQDIRVVKAFRSSLYEGLEKPESRTSIHNFMAHPEFRIEDSQPHIPLIDDTDLEEDAALKQNSSPPSSLNKNNSAIDSGINLTTDTSKSATSSSPGSPIHSLETSL

SEQ ID NO: 31 - protein, 1241 aa, Homo sapiens
MTNPSDRVLPANSMAESREGDFGCTVMELRKLMELRSRDALTQINVHYGGVQNLCSRLKTSPVEGLSGNPADLEKRRQVFGHNVIPPKKPKTFLELVWEALQDVTLIILEIAAIISLVLSFYRPAGEENELCGQVATTPEDENEAQAGWIEGAAILFSVIIVVLVTAFNDWSKEKQFRGLQCRIEQEQKFSIIRNGQLIQLPVAEIVVGDIAQVKYGDLLPADGILIQGNDLKIDESSLTGESDHVKKSLDKDPMLLSGTHVMEGSGRMVVTAVGVNSQTGIILTLLGVNEDDEGEKKKKGKKQGVPENRNKAKTQDGVALEIQPLNSQEGIDNEEKDKKAVKVPKKEKSVLQGKLTRLAVQIGKAGLLMSALTVFILILYFVIDNFVINRRPWLPECTPIYIQYFVKFFIIGITVLVVAVPEGLPLAVTISLAYSVKKMMKDNNLVRHLDACETMGNATAICSDKTGTLTMNRMTVVQAYIGGIHYRQIPSPDVFLPKVLDLIVNGISINSAYTSKILPPEKEGGLPRQVGNKTECALLGFVTDLKQDYQAVRNEVPEEKLYKVYTFNSVRKSMSTVIRNPNGGFRMYSKGASEIILRKCNRILDRKGEAVPFKNKDRDDMVRTVIEPMACDGLRTICIAYRDFDDTEPSWDNENEILTELTCIAVVGIEDPVRPEVPDAIAKCKQAGITVRMVTGDNINTARAIATKCGILTPGDDFLCLEGKEFNRLIRNEKGEVEQEKLDKIWPKLRVLARSSPTDKHTLVKGIIDSTVGEHRQVVAVTGDGTNDGPALKKADVGFAMGIAGTDVAKEASDIILTDDNFTSIVKAVMWGRNVYDSISKFLQFQLTVNVVAVIVAFTGACITQDSPLKAVQMLWVNLIMDTFASLALATEPPTESLLKRRPYGRNKPLISRTMMKNILGHAFYQLIVIFILVFAGEKFFDIDSGRKAPLHSPPSQHYTIVFNTFVLMQLFNEINSRKIHGEKNVFSGIYRNIIFCSVVLGTFICQIFIVEFGGKPFSCTSLSLSQWLWCLFIGIGELLWGQFISAIPTRSLKFLKEAGHGTTKEEITKDAEGLDEIDHAEMELRRGQILWFRGLNRIQTQIDVINTFQTGASFKGVLRRQNMGQHLDVKLVPSSSYIKVVKAFHSSLHESIQKPYNQKSIHSFMTHPEFAIEEELPRTPLLDEEEEENPDKASKFGTRVLLLDGEVTPYANTNNNAVDCNQVQLPQSDSSLQSLETSV

SEQ ID NO: 32 - protein, 1241 aa, homo sapiens; identical to SEQ ID NO: 31

SEQ ID NO: 33 - protein, 193 aa, homo sapiens
GPIFNASVHSDTPSVIRGDLIKLFCIITVEGAALDPDDMAFDVSWFAVHSFGLDKAPVLLSSLDRKGIVTTSRRDWKSDLSLERVSVLEFLLQVHGSEDQDFGNYYCSVTPWVKSPTGSWQKEAEIHSKPVFITVKMDVLNAFKYPLLIGVGLSTVIGLLSCLIGYCSSHWCCKKEVQETRRERRRLMSMEMD

SEQ ID NO: 34 - protein, 1021 aa, homo sapiens
MAGISYVASFFLLLTKLSIGQREVTVQKGPLFRAEGYPVSIGCNVTGHQGPSEQHFQWSVYLPTNPTQEVQIISTKDAAFSYAVYTQRVRSGDVYVERVQGNSVLLHISKLQMKDAGEYECHTPNTDEKYYGSYSAKTNLIVIPDTLSATMSSQTLGKEEGEPLALTCEASKATAQHTHLSVTWYLTQDGGGSQATEIISLSKDFILVPGPLYTERFAASDVQLNKLGPTTFRLSIERLQSSDQGQLFCEATEWIQDPDETWMFITKKQTDQTTLRIQPAVKDFQVNITADSLFAEGKPLELVCLVVSSGRDPQLQGIWFFNGTEIAHIDAGGVLGLKNDYKERASQGELQVSKLGPKAFSLKIFSLGPEDEGAYRCVVAEVMKTRTGSWQVLQRKQSPDSHVHLRKPAARSVVMSTKNKQQVVWEGETLAFLCKAGGAESPLSVSWWHIPRDQTQPEFVAGMGQDGIVQLGASYGVPSYHGNTRLEKMDWATFQLEITFTAITDSGTYECRVSEKSRNQARDLSWTQKISVTVKSLESSLQVSLMSRQPQVMLTNTFDLSCVVRAGYSDLKVPLTVTWQFQPASSHIFHQLIRITHNGTIEWGNFLSRFQKKTKVSQSLFRSQLLVHDATEEETGVYQCEVEVYDRNSLYNNRPPRASAISHPLRIAVTLPESKLKVNSRSQVQELSINSNTDIECSILSRSNGNLQLAIIWYFSPVSTNASWLKILEMDQTNVIKTGDEFHTPQRKQKFHTEKVSQDLFQLHILNVEDSDRGKYHCAVEEWLLSTNGTWHKLGEKKSGLTELKLKPTGSKVRVSKVYWTENVTEHREVAIRCSLESVGSSATLYSVMWYWNRENSGSKLLVHLQHDGLLEYGEEGLRRHLHCYRSSSTDFVLKLHQVEMEDAGMYWCRVAEWQLHGHPSKWINQASDESQRMVLTVLPSEPTLPSRICSSAPLLYFLFICPFVLLLLLLISLLCLYWKARKLSTLRSNTRKEKALWVDLKEAGGVTTNRREDEEEDEGN

SEQ ID NO: 35 - protein, 20 aa, homo sapiens
MAGISYVASFFLLLTKLSIG

SEQ ID NO: 36 - DNA, 20 bp, Artificial Sequence
  Synthetic  Oligonucleotide
cgttggcagtccgccttaac

SEQ ID NO: 37 - DNA, 20 bp, Artificial Sequence
  Synthetic  oligonucleotide
catagtcactgacgttgcag

SEQ ID NO: 38 - DNA, 20 bp, Artificial Sequence
  Synthetic  oligonucleotide
ttgtggagcttgcaagcacc

SEQ ID NO: 39 - DNA, 20 bp, Artificial Sequence
  Synthetic  oligonucleotide
gttctttatgtggagctcca

SEQ ID NO: 40 - DNA, 20 bp, Artificial Sequence
  Synthetic  oligonucleotide
tatcccttgctgatcggcgt

SEQ ID NO: 41 - DNA, 20 bp, Artificial Sequence
  Synthetic  oligonucleotide
gctgcagtacccgatgagac

SEQ ID NO: 42 - protein, 38 aa, Artificial Sequence
  Synthetic Polypeptide
EHSAGGGGSDYKDDDDKGGGGSLSNPIEIDFQTSGPIF

SEQ ID NO: 43 - protein, 34 aa, Artificial Sequence
  Synthetic Polypeptide
EHSAGGGGSDYKDDDDKGGGGSIEIDFQTSGPIF

SEQ ID NO: 44 - protein, 30 aa, Artificial Sequence
  Synthetic Polypeptide
EHSAGGGGSDYKDDDDKGGGGSFQTSGPIF

SEQ ID NO: 45 - protein, 26 aa, Artificial Sequence
  Synthetic Polypeptide
EHSAGGGGSDYKDDDDKGGGGSGPIF

SEQ ID NO: 46 - protein, 42 aa, Artificial Sequence
  Synthetic Polypeptide
FITVKMDTLDPRSFLLRNPNDKYEPFWEDEEKNESGSDKTHT

SEQ ID NO: 47 - protein, 332 aa, Homo sapiens
MGAQFSKTAAKGEAAAERPGEAAVASSPSKANGQENGHVKVNGDASPAAAESGAKEELQANGSAPAADKEEPAAAGSGAASPSAAEKGEPAAAAAPEAGASPVEKEAPAEGEAAEPGSPTAAEGEAASAASSTSSPKAEDGATPSPSNETPKKKKKRFSFKKSFKLSGFSFKKNKKEAGEGGEAEAPAAEGGKDEAAGGAAAAAAEAGAASGEQAAAPGEEAAAGEEGAAGGDPQEAKPQEAAVAPEKPPASDETKAAEEPSKVEEKKAEEAGASAAACEAPSAAGPGAPPEQEAAPAEEPAAAAASSACAAPSQEAQPECSPEAPPAEAAE

SEQ ID NO: 48 - protein, 195 aa, Homo sapiens
MGSQSSKAPRGDVTAEEAAGASPAKANGQENGHVKSNGDLSPKGEGESPPVNGTDEAAGATGDAIEPAPPSQGAEAKGEVPPKETPKKKKKFSFKKPFKLSGLSFKRNRKEGGGDSSASSPTEEEQEQGEIGACSDEGTAQEGKAAATPESQEPQAKGAEASAASEEEAGPQATEPSTPSGPESGPTPASAEQNE

SEQ ID NO: 49 - protein, 227 aa, Homo sapiens
MGGKLSKKKKGYNVNDEKAKEKDKKAEGAATEEEGTPKESEPQAAAEPAEAKEGKEKPDQDAEGKAEEKEGEKDAAAAKEEAPKAEPEKTEGAAEAKAEPPKAPEQEQAAPGPAAGGEAPKAAEAAAAPAESAAPAAGEEPSKEEGEPKKTEAPAAPAAQETKSDGAPASDSKPGSSEAAPSSKETPAATEAPSSTPKAQGPAASAEEPKPVEAPAANSDQTVTVKE

SEQ ID NO: 50 - protein, 30 aa, Artificial Sequence
  Description of Artificial Sequence: Synthetic peptide
MGGKLSKKKKGYNVNDEKAKEKDKKAEGAA

SEQ ID NO: 51 - protein, 27 aa, Artificial Sequence
  Description of Artificial Sequence: Synthetic peptide
MGGKLSKKKKGYNVNDEKAKEKDKKAE

SEQ ID NO: 52 - protein, 24 aa, Artificial Sequence
  Description of Artificial Sequence: Synthetic peptide
MGGKLSKKKKGYNVNDEKAKEKDK

SEQ ID NO: 53 - protein, 21 aa, Artificial Sequence
  Description of Artificial Sequence: Synthetic peptide
MGGKLSKKKKGYNVNDEKAKE

SEQ ID NO: 54 - protein, 18 aa, Artificial Sequence
  Description of Artificial Sequence: Synthetic peptide
MGGKLSKKKKGYNVNDEK

SEQ ID NO: 55 - protein, 15 aa, Artificial Sequence
  Description of Artificial Sequence: Synthetic peptide
MGGKLSKKKKGYNVN

SEQ ID NO: 56 - protein, 12 aa, Artificial Sequence
  Description of Artificial Sequence: Synthetic peptide
MGGKLSKKKKGY

SEQ ID NO: 57 - protein, 11 aa, Artificial Sequence
  Description of Artificial Sequence: Synthetic peptide
MGGKLSKKKKG

SEQ ID NO: 58 - protein, 10 aa, Artificial Sequence
  Description of Artificial Sequence: Synthetic peptide
MGGKLSKKKK

SEQ ID NO: 59 - protein, 9 aa, Artificial Sequence
  Description of Artificial Sequence: Synthetic peptide
MGGKLSKKK

SEQ ID NO: 60 - protein, 8 aa, Artificial Sequence
  Description of Artificial Sequence: Synthetic peptide
MGGKLSKK

SEQ ID NO: 61 - protein, 7 aa, Artificial Sequence
  Description of Artificial Sequence: Synthetic peptide
MGGKLSK

SEQ ID NO: 62 - protein, 8 aa, Artificial Sequence
  Description of Artificial Sequence: Synthetic peptide
MGGKLAKK

SEQ ID NO: 63 - protein, 8 aa, Artificial Sequence
  Description of Artificial Sequence: Synthetic peptide
MGGKFSKK

SEQ ID NO: 64 - protein, 8 aa, Artificial Sequence
  Description of Artificial Sequence: Synthetic peptide
MGGKFAKK

SEQ ID NO: 65 - protein, 8 aa, Artificial Sequence
  Description of Artificial Sequence: Synthetic peptide
MGGKSSKK

SEQ ID NO: 66 - protein, 8 aa, Artificial Sequence
  Description of Artificial Sequence: Synthetic peptide
MGGKSAKK

SEQ ID NO: 67 - protein, 8 aa, Artificial Sequence
  Description of Artificial Sequence: Synthetic peptide
MGGKQSKK

SEQ ID NO: 68 - protein, 8 aa, Artificial Sequence
  Description of Artificial Sequence: Synthetic peptide
MGGKQAKK

SEQ ID NO: 69 - protein, 8 aa, Artificial Sequence
  Description of Artificial Sequence: Synthetic peptide
MGGQLSKK

SEQ ID NO: 70 - protein, 8 aa, Artificial Sequence
  Description of Artificial Sequence: Synthetic peptide
MGGQLAKK

SEQ ID NO: 71 - protein, 8 aa, Artificial Sequence
  Description of Artificial Sequence: Synthetic peptide
MGGQFSKK

SEQ ID NO: 72 - protein, 8 aa, Artificial Sequence
  Description of Artificial Sequence: Synthetic peptide
MGGQFAKK

SEQ ID NO: 73 - protein, 8 aa, Artificial Sequence
  Description of Artificial Sequence: Synthetic peptide
MGGQSSKK

SEQ ID NO: 74 - protein, 8 aa, Artificial Sequence
  Description of Artificial Sequence: Synthetic peptide
MGGQSAKK

SEQ ID NO: 75 - protein, 8 aa, Artificial Sequence
  Description of Artificial Sequence: Synthetic peptide
MGGQQSKK

SEQ ID NO: 76 - protein, 8 aa, Artificial Sequence
  Description of Artificial Sequence: Synthetic peptide
MGGQQAKK

SEQ ID NO: 77 - protein, 8 aa, Artificial Sequence
  Description of Artificial Sequence: Synthetic peptide
MGAKLSKK

SEQ ID NO: 78 - protein, 8 aa, Artificial Sequence
  Description of Artificial Sequence: Synthetic peptide
MGAKLAKK

SEQ ID NO: 79 - protein, 8 aa, Artificial Sequence
  Description of Artificial Sequence: Synthetic peptide
MGAKFSKK

SEQ ID NO: 80 - protein, 8 aa, Artificial Sequence
  Description of Artificial Sequence: Synthetic peptide
MGAKFAKK

SEQ ID NO: 81 - protein, 8 aa, Artificial Sequence
  Description of Artificial Sequence: Synthetic peptide
MGAKSSKK

SEQ ID NO: 82 - protein, 8 aa, Artificial Sequence
  Description of Artificial Sequence: Synthetic peptide
MGAKSAKK

SEQ ID NO: 83 - protein, 8 aa, Artificial Sequence
  Description of Artificial Sequence: Synthetic peptide
MGAKQSKK

SEQ ID NO: 84 - protein, 8 aa, Artificial Sequence
  Description of Artificial Sequence: Synthetic peptide
MGAKQAKK

SEQ ID NO: 85 - protein, 8 aa, Artificial Sequence
  Description of Artificial Sequence: Synthetic peptide
MGAQLSKK

SEQ ID NO: 86 - protein, 8 aa, Artificial Sequence
  Description of Artificial Sequence: Synthetic peptide
MGAQLAKK

SEQ ID NO: 87 - protein, 8 aa, Artificial Sequence
  Description of Artificial Sequence: Synthetic peptide
MGAQFSKK

SEQ ID NO: 88 - protein, 8 aa, Artificial Sequence
  Description of Artificial Sequence: Synthetic peptide
MGAQFAKK

SEQ ID NO: 89 - protein, 8 aa, Artificial Sequence
  Description of Artificial Sequence: Synthetic peptide
MGAQSSKK

SEQ ID NO: 90 - protein, 8 aa, Artificial Sequence
  Description of Artificial Sequence: Synthetic peptide
MGAQSAKK

SEQ ID NO: 91 - protein, 8 aa, Artificial Sequence
  Description of Artificial Sequence: Synthetic peptide
MGAQQSKK

SEQ ID NO: 92 - protein, 8 aa, Artificial Sequence
  Description of Artificial Sequence: Synthetic peptide
MGAQQAKK

SEQ ID NO: 93 - protein, 8 aa, Artificial Sequence
  Description of Artificial Sequence: Synthetic peptide
MGSKLSKK

SEQ ID NO: 94 - protein, 8 aa, Artificial Sequence
  Description of Artificial Sequence: Synthetic peptide
MGSKLAKK

SEQ ID NO: 95 - protein, 8 aa, Artificial Sequence
  Description of Artificial Sequence: Synthetic peptide
MGSKFSKK

SEQ ID NO: 96 - protein, 8 aa, Artificial Sequence
  Description of Artificial Sequence: Synthetic peptide
MGSKFAKK

SEQ ID NO: 97 - protein, 8 aa, Artificial Sequence
  Description of Artificial Sequence: Synthetic peptide
MGSKSSKK

SEQ ID NO: 98 - protein, 8 aa, Artificial Sequence
  Description of Artificial Sequence: Synthetic peptide
MGSKSAKK

SEQ ID NO: 99 - protein, 8 aa, Artificial Sequence
  Description of Artificial Sequence: Synthetic peptide
MGSKQSKK

SEQ ID NO: 100 - protein, 8 aa, Artificial Sequence
  Description of Artificial Sequence: Synthetic peptide
MGSKQAKK

SEQ ID NO: 101 - protein, 8 aa, Artificial Sequence
  Description of Artificial Sequence: Synthetic peptide
MGSQLSKK

SEQ ID NO: 102 - protein, 8 aa, Artificial Sequence
  Description of Artificial Sequence: Synthetic peptide
MGSQLAKK

SEQ ID NO: 103 - protein, 8 aa, Artificial Sequence
  Description of Artificial Sequence: Synthetic peptide
MGSQFSKK

SEQ ID NO: 104 - protein, 8 aa, Artificial Sequence
  Description of Artificial Sequence: Synthetic peptide
MGSQFAKK

SEQ ID NO: 105 - protein, 8 aa, Artificial Sequence
  Description of Artificial Sequence: Synthetic peptide
MGSQSSKK

SEQ ID NO: 106 - protein, 8 aa, Artificial Sequence
  Description of Artificial Sequence: Synthetic peptide
MGSQSAKK

SEQ ID NO: 107 - protein, 8 aa, Artificial Sequence
  Description of Artificial Sequence: Synthetic peptide
MGSQQSKK

SEQ ID NO: 108 - protein, 8 aa, Artificial Sequence
  Description of Artificial Sequence: Synthetic peptide
MGSQQAKK

SEQ ID NO: 109 - protein, 7 aa, Artificial Sequence
  Description of Artificial Sequence: Synthetic peptide
MGGKLAK

SEQ ID NO: 110 - protein, 7 aa, Artificial Sequence
  Description of Artificial Sequence: Synthetic peptide
MGGKFSK

SEQ ID NO: 111 - protein, 7 aa, Artificial Sequence
  Description of Artificial Sequence: Synthetic peptide
MGGKFAK

SEQ ID NO: 112 - protein, 7 aa, Artificial Sequence
  Description of Artificial Sequence: Synthetic peptide
MGGKSSK

SEQ ID NO: 113 - protein, 7 aa, Artificial Sequence
  Description of Artificial Sequence: Synthetic peptide
MGGKSAK

SEQ ID NO: 114 - protein, 7 aa, Artificial Sequence
  Description of Artificial Sequence: Synthetic peptide
MGGKQSK

SEQ ID NO: 115 - protein, 7 aa, Artificial Sequence
  Description of Artificial Sequence: Synthetic peptide
MGGKQAK

SEQ ID NO: 116 - protein, 7 aa, Artificial Sequence
  Description of Artificial Sequence: Synthetic peptide
MGGQLSK

SEQ ID NO: 117 - protein, 7 aa, Artificial Sequence
  Description of Artificial Sequence: Synthetic peptide
MGGQLAK

SEQ ID NO: 118 - protein, 7 aa, Artificial Sequence
  Description of Artificial Sequence: Synthetic peptide
MGGQFSK

SEQ ID NO: 119 - protein, 7 aa, Artificial Sequence
  Description of Artificial Sequence: Synthetic peptide
MGGQFAK

SEQ ID NO: 120 - protein, 7 aa, Artificial Sequence
  Description of Artificial Sequence: Synthetic peptide
MGGQSSK

SEQ ID NO: 121 - protein, 7 aa, Artificial Sequence
  Description of Artificial Sequence: Synthetic peptide
MGGQSAK

SEQ ID NO: 122 - protein, 7 aa, Artificial Sequence
  Description of Artificial Sequence: Synthetic peptide
MGGQQSK

SEQ ID NO: 123 - protein, 7 aa, Artificial Sequence
  Description of Artificial Sequence: Synthetic peptide
MGGQQAK

SEQ ID NO: 124 - protein, 7 aa, Artificial Sequence
  Description of Artificial Sequence: Synthetic peptide
MGAKLSK

SEQ ID NO: 125 - protein, 7 aa, Artificial Sequence
  Description of Artificial Sequence: Synthetic peptide
MGAKLAK

SEQ ID NO: 126 - protein, 7 aa, Artificial Sequence
  Description of Artificial Sequence: Synthetic peptide
MGAKFSK

SEQ ID NO: 127 - protein, 7 aa, Artificial Sequence
  Description of Artificial Sequence: Synthetic peptide
MGAKFAK

SEQ ID NO: 128 - protein, 7 aa, Artificial Sequence
  Description of Artificial Sequence: Synthetic peptide
MGAKSSK

SEQ ID NO: 129 - protein, 7 aa, Artificial Sequence
  Description of Artificial Sequence: Synthetic peptide
MGAKSAK

SEQ ID NO: 130 - protein, 7 aa, Artificial Sequence
  Description of Artificial Sequence: Synthetic peptide
MGAKQSK

SEQ ID NO: 131 - protein, 7 aa, Artificial Sequence
  Description of Artificial Sequence: Synthetic peptide
MGAKQAK

SEQ ID NO: 132 - protein, 7 aa, Artificial Sequence
  Description of Artificial Sequence: Synthetic peptide
MGAQLSK

SEQ ID NO: 133 - protein, 7 aa, Artificial Sequence
  Description of Artificial Sequence: Synthetic peptide
MGAQLAK

SEQ ID NO: 134 - protein, 7 aa, Artificial Sequence
  Description of Artificial Sequence: Synthetic peptide
MGAQFSK

SEQ ID NO: 135 - protein, 7 aa, Artificial Sequence
  Description of Artificial Sequence: Synthetic peptide
MGAQFAK

SEQ ID NO: 136 - protein, 7 aa, Artificial Sequence
  Description of Artificial Sequence: Synthetic peptide
MGAQSSK

SEQ ID NO: 137 - protein, 7 aa, Artificial Sequence
  Description of Artificial Sequence: Synthetic peptide
MGAQSAK

SEQ ID NO: 138 - protein, 7 aa, Artificial Sequence
  Description of Artificial Sequence: Synthetic peptide
MGAQQSK

SEQ ID NO: 139 - protein, 7 aa, Artificial Sequence
  Description of Artificial Sequence: Synthetic peptide
MGAQQAK

SEQ ID NO: 140 - protein, 7 aa, Artificial Sequence
  Description of Artificial Sequence: Synthetic peptide
MGSKLSK

SEQ ID NO: 141 - protein, 7 aa, Artificial Sequence
  Description of Artificial Sequence: Synthetic peptide
MGSKLAK

SEQ ID NO: 142 - protein, 7 aa, Artificial Sequence
  Description of Artificial Sequence: Synthetic peptide
MGSKFSK

SEQ ID NO: 143 - protein, 7 aa, Artificial Sequence
  Description of Artificial Sequence: Synthetic peptide
MGSKFAK

SEQ ID NO: 144 - protein, 7 aa, Artificial Sequence
  Description of Artificial Sequence: Synthetic peptide
MGSKSSK

SEQ ID NO: 145 - protein, 7 aa, Artificial Sequence
  Description of Artificial Sequence: Synthetic peptide
MGSKSAK

SEQ ID NO: 146 - protein, 7 aa, Artificial Sequence
  Description of Artificial Sequence: Synthetic peptide
MGSKQSK

SEQ ID NO: 147 - protein, 7 aa, Artificial Sequence
  Description of Artificial Sequence: Synthetic peptide
MGSKQAK

SEQ ID NO: 148 - protein, 7 aa, Artificial Sequence
  Description of Artificial Sequence: Synthetic peptide
MGSQLSK

SEQ ID NO: 149 - protein, 7 aa, Artificial Sequence
  Description of Artificial Sequence: Synthetic peptide
MGSQLAK

SEQ ID NO: 150 - protein, 7 aa, Artificial Sequence
  Description of Artificial Sequence: Synthetic peptide
MGSQFSK

SEQ ID NO: 151 - protein, 7 aa, Artificial Sequence
  Description of Artificial Sequence: Synthetic peptide
MGSQFAK

SEQ ID NO: 152 - protein, 7 aa, Artificial Sequence
  Description of Artificial Sequence: Synthetic peptide
MGSQSSK

SEQ ID NO: 153 - protein, 7 aa, Artificial Sequence
  Description of Artificial Sequence: Synthetic peptide
MGSQSAK

SEQ ID NO: 154 - protein, 7 aa, Artificial Sequence
  Description of Artificial Sequence: Synthetic peptide
MGSQQSK

SEQ ID NO: 155 - protein, 7 aa, Artificial Sequence
  Description of Artificial Sequence: Synthetic peptide
MGSQQAK

SEQ ID NO: 156 - protein, 9 aa, Artificial Sequence
  Description of Artificial Sequence: Synthetic peptide
MGAKLSKKK

SEQ ID NO: 157 - protein, 167 aa, Artificial Sequence
  Description of Artificial Sequence: Synthetic polypeptide
MGGKLSKKKKGYNVNDEKAKEKDKKAEGAASGGSGGSDYKDDDDKGGGSGMASNFTQFVLVDNGGTGDVTVAPSNFANGIAEWISSNSRSQAYKVTCSVRQSSAQNRKYTIKVEVPKGAWRSYLNMELTIPIFATNSDCELIVKAMQGLLKDGNPIPSAIAANSGIY

SEQ ID NO: 158 - protein, 167 aa, Artificial Sequence
  Description of Artificial Sequence: Synthetic polypeptide
MGGKLSKKKKGYNVNDEKAKEKDKKAEGAASGGSGGSDYKDDDDKGGGSGMASNFTQFVLVDNGGTGDVTVAPSNFANGIAEWISSNSRSQAYKVTCSVRQSSAQKRKYTIKVEVPKGAWRSYLNMELTIPIFATNSDCELIVKAMQGLLKDGNPIPSAIAANSGIY

SEQ ID NO: 159 - protein, 296 aa, Artificial Sequence
  Description of Artificial Sequence: Synthetic polypeptide
MGGKLSKKKKGYNVNDEKAKEKDKKAEGAASGGSGGSDYKDDDDKGGGSGMASNFTQFVLVDNGGTGDVTVAPSNFANGIAEWISSNSRSQAYKVTCSVRQSSAQNRKYTIKVEVPKGAWRSYLNMELTIPIFATNSDCELIVKAMQGLLKDGNPIPSAIAANSGIYGSGGSGGSGGSGMASNFTQFVLVDNGGTGDVTVAPSNFANGIAEWISSNSRSQAYKVTCSVRQSSAQNRKYTIKVEVPKGAWRSYLNMELTIPIFATNSDCELIVKAMQGLLKDGNPIPSAIAANSGIY

SEQ ID NO: 160 - protein, 296 aa, Artificial Sequence
  Description of Artificial Sequence: Synthetic polypeptide
MGGKLSKKKKGYNVNDEKAKEKDKKAEGAASGGSGGSDYKDDDDKGGGSGMASNFTQFVLVDNGGTGDVTVAPSNFANGIAEWISSNSRSQAYKVTCSVRQSSAQKRKYTIKVEVPKGAWRSYLNMELTIPIFATNSDCELIVKAMQGLLKDGNPIPSAIAANSGIYGSGGSGGSGGSGMASNFTQFVLVDNGGTGDVTVAPSNFANGIAEWISSNSRSQAYKVTCSVRQSSAQKRKYTIKVEVPKGAWRSYLNMELTIPIFATNSDCELIVKAMQGLLKDGNPIPSAIAANSGIY

SEQ ID NO: 161 - RNA, 680 nt, Artificial Sequence
  Description of Artificial Sequence: Synthetic polynucleotide
augaagcccaccgagaacaacgaagacuucaacaucguggccguggccagcaacuucgcgaccacggaucucgaugcugaccgcgggaaguugcccggcaagaagcugccgcuggaggugcucaaagaguuggaagccaaugcccggaaagcuggcugcaccaggggcugucugaucugccugucccacaucaagugcacgcccaagaugaagaaguucaucccaggacgcugccacaccuacgaaggcgacaaagaguccgcacagggcggcauaggcgaggcgaucgucgacauuccugagauuccuggguucaaggacuuggagcccuuggagcaguucaucgcacaggucgaucuguguguggacugcacaacuggcugccucaaagggcuugccaacgugcaguguucugaccugcucaagaaguggcugccgcaacgcugugcgaccuuugccagcaagauccagggccagguggacaagaucaagggggccgguggugacuaaggauccaucgauaagcuucaucgaaacaugaggaucacccauaucugcagucgacaucgaaacaugaggaucacccaugucugcagucgacaucgaaacaugaggaucacccaugucugcagucgacaucgaaacaugaggaucacccaugucugcagucgacaucgaaa

SEQ ID NO: 162 - protein, 9 aa, Artificial Sequence
  Description of Artificial Sequence: Synthetic peptide
  VARIANT (3)..(3): Any Naturally Occurring Amino Acid
MGXKLSKKK

SEQ ID NO: 163 - protein, 9 aa, Artificial Sequence
  Description of Artificial Sequence: Synthetic peptide
  MOD_RES (3)..(3): See specification as filed for detailed description of substitutions and preferred embodiments
MGXKLSKKK

SEQ ID NO: 164 - protein, 8 aa, Artificial Sequence
  Description of Artificial Sequence: Synthetic peptide
  MOD_RES (3)..(3): Gly, Ala, or Ser
  MOD_RES (4)..(4): Lys or Gln
  MOD_RES (5)..(5): Leu, Phe, Ser, or Gln
  MOD_RES (6)..(6): Ser or Ala
  MOD_RES (6)..(6): Ser or Ala, See specification as filed for detailed description of substitutions and preferred embodiments
MGXXXXKK

SEQ ID NO: 165 - DNA, 20 bp, Artificial Sequence
  Description of Artificial Sequence: Synthetic primer
tggaggtgctcaaagagttg

SEQ ID NO: 166 - DNA, 17 bp, Artificial Sequence
  Description of Artificial Sequence: Synthetic primer
ttgggcgtgcacttgat

SEQ ID NO: 167 - DNA, 13 bp, Artificial Sequence
  Description of Artificial Sequence: Synthetic probe
gggcattggcttc

SEQ ID NO: 168 - protein, 60 aa, Artificial Sequence
  Description of Artificial Sequence: Synthetic polypeptide
MGGKLSKKKKGYNVNDEKAKEKDKKAEGAASAGGGGSDYKDDDDKGGGGSVSKGEELFTG

SEQ ID NO: 169 - protein, 60 aa, Artificial Sequence
  Description of Artificial Sequence: Synthetic polypeptide
MAGKLSKKKKGYNVNDEKAKEKDKKAEGAASAGGGGSDYKDDDDKGGGGSVSKGEELFTG

SEQ ID NO: 170 - protein, 60 aa, Artificial Sequence
  Description of Artificial Sequence: Synthetic polypeptide
MGAKLSKKKKGYNVNDEKAKEKDKKAEGAASAGGGGSDYKDDDDKGGGGSVSKGEELFTG

SEQ ID NO: 171 - protein, 60 aa, Artificial Sequence
  Description of Artificial Sequence: Synthetic polypeptide
MAAKLSKKKKGYNVNDEKAKEKDKKAEGAASAGGGGSDYKDDDDKGGGGSVSKGEELFTG

SEQ ID NO: 172 - protein, 57 aa, Artificial Sequence
  Description of Artificial Sequence: Synthetic polypeptide
MGGKLSKKKKGYNVNDEKAKEKDKKAESAGGGGSDYKDDDDKGGGGSVSKGEELFTG

SEQ ID NO: 173 - protein, 54 aa, Artificial Sequence
  Description of Artificial Sequence: Synthetic polypeptide
MGGKLSKKKKGYNVNDEKAKEKDKSAGGGGSDYKDDDDKGGGGSVSKGEELFTG

SEQ ID NO: 174 - protein, 51 aa, Artificial Sequence
  Description of Artificial Sequence: Synthetic polypeptide
MGGKLSKKKKGYNVNDEKAKESAGGGGSDYKDDDDKGGGGSVSKGEELFTG

SEQ ID NO: 175 - protein, 48 aa, Artificial Sequence
  Description of Artificial Sequence: Synthetic polypeptide
MGGKLSKKKKGYNVNDEKSAGGGGSDYKDDDDKGGGGSVSKGEELFTG

SEQ ID NO: 176 - protein, 45 aa, Artificial Sequence
  Description of Artificial Sequence: Synthetic polypeptide
MGGKLSKKKKGYNVNSAGGGGSDYKDDDDKGGGGSVSKGEELFTG

SEQ ID NO: 177 - protein, 42 aa, Artificial Sequence
  Description of Artificial Sequence: Synthetic polypeptide
MGGKLSKKKKGYSAGGGGSDYKDDDDKGGGGSVSKGEELFTG

SEQ ID NO: 178 - protein, 39 aa, Artificial Sequence
  Description of Artificial Sequence: Synthetic polypeptide
MGGKLSKKKSAGGGGSDYKDDDDKGGGGSVSKGEELFTG

SEQ ID NO: 179 - protein, 36 aa, Artificial Sequence
  Description of Artificial Sequence: Synthetic polypeptide
MGGKLSSAGGGGSDYKDDDDKGGGGSVSKGEELFTG

SEQ ID NO: 180 - protein, 33 aa, Artificial Sequence
  Description of Artificial Sequence: Synthetic polypeptide
MGGSAGGGGSDYKDDDDKGGGGSVSKGEELFTG

SEQ ID NO: 181 - protein, 54 aa, Artificial Sequence
  Description of Artificial Sequence: Synthetic polypeptide
MGGKLSKKKKGYNVNDEKAKEKDKKAEGAASAGGGGSDYKDDDDKGGGGSVSKG

SEQ ID NO: 182 - protein, 36 aa, Artificial Sequence
  Description of Artificial Sequence: Synthetic polypeptide
MGGKLSKKKKGYSAGGGGSDYKDDDDKGGGGSVSKG

SEQ ID NO: 183 - protein, 35 aa, Artificial Sequence
  Description of Artificial Sequence: Synthetic polypeptide
MGGKLSKKKKGSAGGGGSDYKDDDDKGGGGSVSKG

SEQ ID NO: 184 - protein, 34 aa, Artificial Sequence
  Description of Artificial Sequence: Synthetic polypeptide
MGGKLSKKKKSAGGGGSDYKDDDDKGGGGSVSKG

SEQ ID NO: 185 - protein, 33 aa, Artificial Sequence
  Description of Artificial Sequence: Synthetic polypeptide
MGGKLSKKKSAGGGGSDYKDDDDKGGGGSVSKG

SEQ ID NO: 186 - protein, 32 aa, Artificial Sequence
  Description of Artificial Sequence: Synthetic polypeptide
MGGKLSKKSAGGGGSDYKDDDDKGGGGSVSKG

SEQ ID NO: 187 - protein, 31 aa, Artificial Sequence
  Description of Artificial Sequence: Synthetic polypeptide
MGGKLSKSAGGGGSDYKDDDDKGGGGSVSKG

SEQ ID NO: 188 - protein, 30 aa, Artificial Sequence
  Description of Artificial Sequence: Synthetic polypeptide
MGGKLSSAGGGGSDYKDDDDKGGGGSVSKG

SEQ ID NO: 189 - protein, 30 aa, Artificial Sequence
  Description of Artificial Sequence: Synthetic polypeptide
MGGKLDKKKKGYNVNDEKAKEKDKKAEGAA

SEQ ID NO: 190 - protein, 30 aa, Artificial Sequence
  Description of Artificial Sequence: Synthetic polypeptide
MGGKLAKKKKGYNVNDEKAKEKDKKAEGAA

SEQ ID NO: 191 - protein, 30 aa, Artificial Sequence
  Description of Artificial Sequence: Synthetic polypeptide
MGGKQSKKKKGYNVNDEKAKEKDKKAEGAA

SEQ ID NO: 192 - protein, 30 aa, Artificial Sequence
  Description of Artificial Sequence: Synthetic polypeptide
MGAKKKKKRFSFKKSFKLSGFSFKKNKKEA

SEQ ID NO: 193 - protein, 30 aa, Artificial Sequence
  Description of Artificial Sequence: Synthetic polypeptide
MAAKKKKKRFSFKKSFKLSGFSFKKNKKEA

SEQ ID NO: 194 - protein, 30 aa, Artificial Sequence
  Description of Artificial Sequence: Synthetic polypeptide
MGAKKSKKRFSFKKSFKLSGFSFKKNKKEA

SEQ ID NO: 195 - protein, 30 aa, Artificial Sequence
  Description of Artificial Sequence: Synthetic polypeptide
MGAKKAKKRFSFKKPFKLSGFSFKKNKKEA

SEQ ID NO: 196 - protein, 153 aa, Artificial Sequence
  Description of Artificial Sequence: Synthetic polypeptide
MGGKLSKKKKSAGGSGGSTSGSGDYKDDDDKGSGFEMDQVQLVESGGALVQPGGSLRLSCAASGFPVNRYSMRWYRQAPGKEREWVAGMSSAGDRSSYEDSVKGRFTISRDDARNTVYLQMNSLKPEDTAVYYCNVNVGFEYWGQGTQVTVSS

SEQ ID NO: 197 - protein, 4 aa, Artificial Sequence
  Peptide Linker
GGGG

SEQ ID NO: 198 - protein, 7 aa, Artificial Sequence
  Peptide Linker
SGGSGGS

SEQ ID NO: 199 - protein, 15 aa, Artificial Sequence
  Peptide Linker
GGSGGSGGSGGSGGG

SEQ ID NO: 200 - protein, 16 aa, Artificial Sequence
  Peptide Linker
GGSGGSGGGGSGGGGS

SEQ ID NO: 201 - protein, 18 aa, Artificial Sequence
  Peptide Linker
GGSGGSGGSGGSGGSGGS

SEQ ID NO: 202 - protein, 15 aa, Artificial Sequence
  Peptide Linker
GGGGSGGGGSGGGGS

SEQ ID NO: 203 - protein, 400 aa, Artificial Sequence
  Peptide Linker
  MISC_FEATURE (1)..(400): This sequence may encompass 1 - 100 “GGGS” repeating units.
GGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGSGGGS

SEQ ID NO: 204 - protein, 800 aa, Artificial Sequence
  Peptide Linker
  MISC_FEATURE (1)..(300): This sequence may encompass 1-100 “GGS” repeating units
  MISC_FEATURE (301)..(800): This sequence may encompass 1-100 “GGGGS” repeating units.
GGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGS

SEQ ID NO: 205 - protein, 4 aa, Artificial Sequence
  Effector Domain Sequence
KKKK

SEQ ID NO: 206 - protein, 5 aa, Artificial Sequence
  Effector Domain Sequence
KKKKK

SEQ ID NO: 207 - protein, 4 aa, Artificial Sequence
  Effector Domain Sequence
RRRR

SEQ ID NO: 208 - protein, 5 aa, Artificial Sequence
  Effector Domain Sequence
RRRRR

SEQ ID NO: 209 - protein, 4 aa, Artificial Sequence
  Effector Domain Sequence
  misc_feature (1)..(4): Xaa can be Lys or Arg
XXXX

SEQ ID NO: 210 - protein, 5 aa, Artificial Sequence
  Effector Domain Sequence
  misc_feature (1)..(5): Xaa can be Lys or Arg
XXXXX

SEQ ID NO: 211 - protein, 7 aa, Artificial Sequence
  N Terminus Domain Sequence
GGKLSKK

SEQ ID NO: 212 - protein, 7 aa, Artificial Sequence
  N Terminus Domain Sequence
GAKLSKK

SEQ ID NO: 213 - protein, 7 aa, Artificial Sequence
  N Terminus Domain Sequence
GGKQSKK

SEQ ID NO: 214 - protein, 7 aa, Artificial Sequence
  N Terminus Domain Sequence
GGKLAKK

SEQ ID NO: 215 - protein, 6 aa, Artificial Sequence
  N Terminus Domain Sequence
GGKLSK

SEQ ID NO: 216 - protein, 6 aa, Artificial Sequence
  N Terminus Domain Sequence
GAKLSK

SEQ ID NO: 217 - protein, 6 aa, Artificial Sequence
  N Terminus Domain Sequence
GGKQSK

SEQ ID NO: 218 - protein, 6 aa, Artificial Sequence
  N Terminus Domain Sequence
GGKLAK

SEQ ID NO: 219 - protein, 4 aa, Artificial Sequence
  N Terminus Domain Sequence
KKKG

SEQ ID NO: 220 - protein, 5 aa, Artificial Sequence
  N Terminus Domain Sequence
KKKGY

SEQ ID NO: 221 - protein, 6 aa, Artificial Sequence
  N Terminus Domain Sequence
KKKGYN

SEQ ID NO: 222 - protein, 7 aa, Artificial Sequence
  N Terminus Domain Sequence
KKKGYNV

SEQ ID NO: 223 - protein, 8 aa, Artificial Sequence
  N Terminus Domain Sequence
KKKGYNVN

SEQ ID NO: 224 - protein, 6 aa, Artificial Sequence
  N Terminus Domain Sequence
KKKGYS

SEQ ID NO: 225 - protein, 6 aa, Artificial Sequence
  N Terminus Domain Sequence
KKKGYG

SEQ ID NO: 226 - protein, 7 aa, Artificial Sequence
  N Terminus Domain Sequence
KKKGYGG

SEQ ID NO: 227 - protein, 5 aa, Artificial Sequence
  N Terminus Domain Sequence
KKKGS

SEQ ID NO: 228 - protein, 6 aa, Artificial Sequence
  N Terminus Domain Sequence
KKKGSG

SEQ ID NO: 229 - protein, 7 aa, Artificial Sequence
  N Terminus Domain Sequence
KKKGSGS

SEQ ID NO: 230 - protein, 4 aa, Artificial Sequence
  N Terminus Domain Sequence
KKKS

SEQ ID NO: 231 - protein, 5 aa, Artificial Sequence
  N Terminus Domain Sequence
KKKSG

SEQ ID NO: 232 - protein, 6 aa, Artificial Sequence
  N Terminus Domain Sequence
KKKSGG

SEQ ID NO: 233 - protein, 7 aa, Artificial Sequence
  N Terminus Domain Sequence
KKKSGGS

SEQ ID NO: 234 - protein, 8 aa, Artificial Sequence
  N Terminus Domain Sequence
KKKSGGSG

SEQ ID NO: 235 - protein, 8 aa, Artificial Sequence
  N Terminus Domain Sequence
KKSGGSGG

SEQ ID NO: 236 - protein, 10 aa, Artificial Sequence
  N Terminus Domain Sequence
KKKSGGSGGS

SEQ ID NO: 237 - protein, 8 aa, Artificial Sequence
  N Terminus Domain Sequence
KRFSFKKS

SEQ ID NO: 238 - protein, 8 aa, Artificial Sequence
  N Terminus Domain Sequence
GGKLSKKK

SEQ ID NO: 239 - protein, 8 aa, Artificial Sequence
  N Terminus Domain Sequence
GGKLSKKS

SEQ ID NO: 240 - protein, 8 aa, Artificial Sequence
  N Terminus Domain Sequence
GAKLSKKK

SEQ ID NO: 241 - protein, 8 aa, Artificial Sequence
  N Terminus Domain Sequence
GAKLSKKS

SEQ ID NO: 242 - protein, 8 aa, Artificial Sequence
  N Terminus Domain Sequence
GGKQSKKK

SEQ ID NO: 243 - protein, 8 aa, Artificial Sequence
  N Terminus Domain Sequence
GGKQSKKS

SEQ ID NO: 244 - protein, 8 aa, Artificial Sequence
  N Terminus Domain Sequence
GGKLAKKK

SEQ ID NO: 245 - protein, 8 aa, Artificial Sequence
  N Terminus Domain Sequence
GGKLAKKS

SEQ ID NO: 246 - protein, 14 aa, Artificial Sequence
  Scaffold Y Sequence
GGKLSKKKKGYNVN

SEQ ID NO: 247 - protein, 14 aa, Artificial Sequence
  Scaffold Y Sequence
GAKLSKKKKGYNVN

SEQ ID NO: 248 - protein, 14 aa, Artificial Sequence
  Scaffold Y Sequence
GGKQSKKKKGYNVN

SEQ ID NO: 249 - protein, 14 aa, Artificial Sequence
  Scaffold Y Sequence
GGKLAKKKKGYNVN

SEQ ID NO: 250 - protein, 14 aa, Artificial Sequence
  Scaffold Y Sequence
GGKLSKKKKGYSGG

SEQ ID NO: 251 - protein, 14 aa, Artificial Sequence
  Scaffold Y Sequence
GGKLSKKKKGSGGS

SEQ ID NO: 252 - protein, 14 aa, Artificial Sequence
  Scaffold Y Sequence
GGKLSKKKKSGGSG

SEQ ID NO: 253 - protein, 14 aa, Artificial Sequence
  Scaffold Y Sequence
GGKLSKKKSGGSGG

SEQ ID NO: 254 - protein, 14 aa, Artificial Sequence
  Scaffold Y Sequence
GGKLSKKSGGSGGS

SEQ ID NO: 255 - protein, 14 aa, Artificial Sequence
  Scaffold Y Sequence
GGKLSKSGGSGGSV

SEQ ID NO: 256 - protein, 14 aa, Artificial Sequence
  Scaffold Y Sequence
GAKKSKKRFSFKKS

SEQ ID NO: 257 - protein, 29 aa, Artificial Sequence
  Scaffold Y Sequence
GGKLSKKKKGYNVNDEKAKEKDKKAEGAA

SEQ ID NO: 258 - protein, 28 aa, Artificial Sequence
  Scaffold Y Sequence
GGKLSKKKKGYNVNDEKAKEKDKKAEGA

SEQ ID NO: 259 - protein, 27 aa, Artificial Sequence
  Scaffold Y Sequence
GGKLSKKKKGYNVNDEKAKEKDKKAEG

SEQ ID NO: 260 - protein, 26 aa, Artificial Sequence
  Scaffold Y Sequence
GGKLSKKKKGYNVNDEKAKEKDKKAE

SEQ ID NO: 261 - protein, 25 aa, Artificial Sequence
  Scaffold Y Sequence
GGKLSKKKKGYNVNDEKAKEKDKKA

SEQ ID NO: 262 - protein, 24 aa, Artificial Sequence
  Scaffold Y Sequence
GGKLSKKKKGYNVNDEKAKEKDKK

SEQ ID NO: 263 - protein, 23 aa, Artificial Sequence
  Scaffold Y Sequence
GGKLSKKKKGYNVNDEKAKEKDK

SEQ ID NO: 264 - protein, 22 aa, Artificial Sequence
  Scaffold Y Sequence
GGKLSKKKKGYNVNDEKAKEKD

SEQ ID NO: 265 - protein, 21 aa, Artificial Sequence
  Scaffold Y Sequence
GGKLSKKKKGYNVNDEKAKEK

SEQ ID NO: 266 - protein, 20 aa, Artificial Sequence
  Scaffold Y Sequence
GGKLSKKKKGYNVNDEKAKE

SEQ ID NO: 267 - protein, 19 aa, Artificial Sequence
  Scaffold Y Sequence
GGKLSKKKKGYNVNDEKAK

SEQ ID NO: 268 - protein, 18 aa, Artificial Sequence
  Scaffold Y Sequence
GGKLSKKKKGYNVNDEKA

SEQ ID NO: 269 - protein, 17 aa, Artificial Sequence
  Scaffold Y Sequence
GGKLSKKKKGYNVNDEK

SEQ ID NO: 270 - protein, 16 aa, Artificial Sequence
  Scaffold Y Sequence
GGKLSKKKKGYNVNDE

SEQ ID NO: 271 - protein, 15 aa, Artificial Sequence
  Scaffold Y Sequence
GGKLSKKKKGYNVND

SEQ ID NO: 272 - protein, 13 aa, Artificial Sequence
  Scaffold Y Sequence
GGKLSKKKKGYNV

SEQ ID NO: 273 - protein, 12 aa, Artificial Sequence
  Scaffold Y Sequence
GGKLSKKKKGYN

SEQ ID NO: 274 - protein, 11 aa, Artificial Sequence
  Scaffold Y Sequence
GGKLSKKKKGY

SEQ ID NO: 275 - protein, 10 aa, Artificial Sequence
  Scaffold Y Sequence
GGKLSKKKKG

SEQ ID NO: 276 - protein, 9 aa, Artificial Sequence
  Scaffold Y Sequence
GGKLSKKKK

SEQ ID NO: 277 - protein, 28 aa, Artificial Sequence
  Scaffold Y Sequence
GAKKSKKRFSFKKSFKLSGFSFKKNKKE

SEQ ID NO: 278 - protein, 27 aa, Artificial Sequence
  Scaffold Y Sequence
GAKKSKKRFSFKKSFKLSGFSFKKNKK

SEQ ID NO: 279 - protein, 26 aa, Artificial Sequence
  Scaffold Y Sequence
GAKKSKKRFSFKKSFKLSGFSFKKNK

SEQ ID NO: 280 - protein, 25 aa, Artificial Sequence
  Scaffold Y Sequence
GAKKSKKRFSFKKSFKLSGFSFKKN

SEQ ID NO: 281 - protein, 24 aa, Artificial Sequence
  Scaffold Y Sequence
GAKKSKKRFSFKKSFKLSGFSFKK

SEQ ID NO: 282 - protein, 23 aa, Artificial Sequence
  Scaffold Y Sequence
GAKKSKKRFSFKKSFKLSGFSFK

SEQ ID NO: 283 - protein, 22 aa, Artificial Sequence
  Scaffold Y Sequence
GAKKSKKRFSFKKSFKLSGFSF

SEQ ID NO: 284 - protein, 21 aa, Artificial Sequence
  Scaffold Y Sequence
GAKKSKKRFSFKKSFKLSGFS

SEQ ID NO: 285 - protein, 20 aa, Artificial Sequence
  Scaffold Y Sequence
GAKKSKKRFSFKKSFKLSGF

SEQ ID NO: 286 - protein, 19 aa, Artificial Sequence
  Scaffold Y Sequence
GAKKSKKRFSFKKSFKLSG

SEQ ID NO: 287 - protein, 18 aa, Artificial Sequence
  Scaffold Y Sequence
GAKKSKKRFSFKKSFKLS

SEQ ID NO: 288 - protein, 17 aa, Artificial Sequence
  Scaffold Y Sequence
GAKKSKKRFSFKKSFKL

SEQ ID NO: 289 - protein, 16 aa, Artificial Sequence
  Scaffold Y Sequence
GAKKSKKRFSFKKSFK

SEQ ID NO: 290 - protein, 15 aa, Artificial Sequence
  Scaffold Y Sequence
GAKKSKKRFSFKKSF

SEQ ID NO: 291 - skipped

SEQ ID NO: 292 - protein, 13 aa, Artificial Sequence
  Scaffold Y Sequence
GAKKSKKRFSFKK

SEQ ID NO: 293 - protein, 12 aa, Artificial Sequence
  Scaffold Y Sequence
GAKKSKKRFSFK

SEQ ID NO: 294 - protein, 11 aa, Artificial Sequence
  Scaffold Y Sequence
GAKKSKKRFSF

SEQ ID NO: 295 - protein, 10 aa, Artificial Sequence
  Scaffold Y Sequence
GAKKSKKRFS

SEQ ID NO: 296 - protein, 9 aa, Artificial Sequence
  Scaffold Y Sequence
GAKKSKKRF

SEQ ID NO: 297 - protein, 8 aa, Artificial Sequence
  Scaffold Y Sequence
GAKKSKKR

SEQ ID NO: 298 - protein, 7 aa, Artificial Sequence
  Scaffold Y Sequence
GAKKSKK

SEQ ID NO: 299 - skipped

SEQ ID NO: 300 - protein, 29 aa, Artificial Sequence
  Scaffold Y Sequence
GAKKSKKRFSFKKSFKLSGFSFKKNKKEA

SEQ ID NO: 301 - protein, 29 aa, Artificial Sequence
  Scaffold Y Sequence
GAKKAKKRFSFKKSFKLSGFSFKKNKKEA

SEQ ID NO: 302 - protein, 28 aa, Artificial Sequence
  Scaffold Y Sequence
GAQESKKKKKKRFSFKKSFKLSGFSFKK

SEQ ID NO: 303 - protein, 27 aa, Artificial Sequence
  Scaffold Y Sequence
GAQESKKKKKKRFSFKKSFKLSGFSFK

SEQ ID NO: 304 - protein, 26 aa, Artificial Sequence
  Scaffold Y Sequence
GAQESKKKKKKRFSFKKSFKLSGFSF

SEQ ID NO: 305 - protein, 25 aa, Artificial Sequence
  Scaffold Y Sequence
GAQESKKKKKKRFSFKKSFKLSGFS

SEQ ID NO: 306 - protein, 24 aa, Artificial Sequence
  Scaffold Y Sequence
GAQESKKKKKKRFSFKKSFKLSGF

SEQ ID NO: 307 - protein, 23 aa, Artificial Sequence
  Scaffold Y Sequence
GAQESKKKKKKRFSFKKSFKLSG

SEQ ID NO: 308 - protein, 22 aa, Artificial Sequence
  Scaffold Y Sequence
GAQESKKKKKKRFSFKKSFKLS

SEQ ID NO: 309 - protein, 21 aa, Artificial Sequence
  Scaffold Y Sequence
GAQESKKKKKKRFSFKKSFKL

SEQ ID NO: 310 - protein, 20 aa, Artificial Sequence
  Scaffold Y Sequence
GAQESKKKKKKRFSFKKSFK

SEQ ID NO: 311 - protein, 19 aa, Artificial Sequence
  Scaffold Y Sequence
GAQESKKKKKKRFSFKKSF

SEQ ID NO: 312 - protein, 18 aa, Artificial Sequence
  Scaffold Y Sequence
GAQESKKKKKKRFSFKKS

SEQ ID NO: 313 - protein, 17 aa, Artificial Sequence
  Scaffold Y Sequence
GAQESKKKKKKRFSFKK

SEQ ID NO: 314 - protein, 16 aa, Artificial Sequence
  Scaffold Y Sequence
GAQESKKKKKKRFSFK

SEQ ID NO: 315 - protein, 15 aa, Artificial Sequence
  Scaffold Y Sequence
GAQESKKKKKKRFSF

SEQ ID NO: 316 - protein, 14 aa, Artificial Sequence
  Scaffold Y Sequence
GAQESKKKKKKRFS

SEQ ID NO: 317 - protein, 13 aa, Artificial Sequence
  Scaffold Y Sequence
GAQESKKKKKKRF

SEQ ID NO: 318 - protein, 12 aa, Artificial Sequence
  Scaffold Y Sequence
GAQESKKKKKKR

SEQ ID NO: 319 - protein, 11 aa, Artificial Sequence
  Scaffold Y Sequence
GAQESKKKKKK

SEQ ID NO: 320 - protein, 10 aa, Artificial Sequence
  Scaffold Y Sequence
GAQESKKKKK

SEQ ID NO: 321 - protein, 9 aa, Artificial Sequence
  Scaffold Y Sequence
GAQESKKKK

SEQ ID NO: 322 - protein, 8 aa, Artificial Sequence
  Scaffold Y Sequence
GAQESKKK

SEQ ID NO: 323 - protein, 7 aa, Artificial Sequence
  Scaffold Y Sequence
GAQESKK

SEQ ID NO: 324 - protein, 30 aa, Artificial Sequence
  Scaffold Y Sequence
GSQSSKKKKKKFSFKKPFKLSGLSFKRNRK

SEQ ID NO: 325 - protein, 29 aa, Artificial Sequence
  Scaffold Y Sequence
GSQSSKKKKKKFSFKKPFKLSGLSFKRNR

SEQ ID NO: 326 - protein, 28 aa, Artificial Sequence
  Scaffold Y Sequence
GSQSSKKKKKKFSFKKPFKLSGLSFKRN

SEQ ID NO: 327 - protein, 27 aa, Artificial Sequence
  Scaffold Y Sequence
GSQSSKKKKKKFSFKKPFKLSGLSFKR

SEQ ID NO: 328 - protein, 26 aa, Artificial Sequence
  Scaffold Y Sequence
GSQSSKKKKKKFSFKKPFKLSGLSFK

SEQ ID NO: 329 - protein, 25 aa, Artificial Sequence
  Scaffold Y Sequence
GSQSSKKKKKKFSFKKPFKLSGLSF

SEQ ID NO: 330 - protein, 24 aa, Artificial Sequence
  Scaffold Y Sequence
GSQSSKKKKKKFSFKKPFKLSGLS

SEQ ID NO: 331 - protein, 23 aa, Artificial Sequence
  Scaffold Y Sequence
GSQSSKKKKKKFSFKKPFKLSGL

SEQ ID NO: 332 - protein, 22 aa, Artificial Sequence
  Scaffold Y Sequence
GSQSSKKKKKKFSFKKPFKLSG

SEQ ID NO: 333 - protein, 21 aa, Artificial Sequence
  Scaffold Y Sequence
GSQSSKKKKKKFSFKKPFKLS

SEQ ID NO: 334 - protein, 20 aa, Artificial Sequence
  Scaffold Y Sequence
GSQSSKKKKKKFSFKKPFKL

SEQ ID NO: 335 - protein, 19 aa, Artificial Sequence
  Scaffold Y Sequence
GSQSSKKKKKKFSFKKPFK

SEQ ID NO: 336 - protein, 18 aa, Artificial Sequence
  Scaffold Y Sequence
GSQSSKKKKKKFSFKKPF

SEQ ID NO: 337 - protein, 17 aa, Artificial Sequence
  Scaffold Y Sequence
GSQSSKKKKKKFSFKKP

SEQ ID NO: 338 - protein, 16 aa, Artificial Sequence
  Scaffold Y Sequence
GSQSSKKKKKKFSFKK

SEQ ID NO: 339 - protein, 15 aa, Artificial Sequence
  Scaffold Y Sequence
GSQSSKKKKKKFSFK

SEQ ID NO: 340 - protein, 14 aa, Artificial Sequence
  Scaffold Y Sequence
GSQSSKKKKKKFSF

SEQ ID NO: 341 - protein, 13 aa, Artificial Sequence
  Scaffold Y Sequence
GSQSSKKKKKKFS

SEQ ID NO: 342 - protein, 12 aa, Artificial Sequence
  Scaffold Y Sequence
GSQSSKKKKKKF

SEQ ID NO: 343 - protein, 11 aa, Artificial Sequence
  Scaffold Y Sequence
GSQSSKKKKKK

SEQ ID NO: 344 - protein, 10 aa, Artificial Sequence
  Scaffold Y Sequence
GSQSSKKKKK

SEQ ID NO: 345 - protein, 9 aa, Artificial Sequence
  Scaffold Y Sequence
GSQSSKKKK

SEQ ID NO: 346 - protein, 8 aa, Artificial Sequence
  Scaffold Y Sequence
GSQSSKKK

SEQ ID NO: 347 - protein, 7 aa, Artificial Sequence
  Scaffold Y Sequence
GSQSSKK

SEQ ID NO: 348 - protein, 28 aa, Artificial Sequence
  Scaffold Y Sequence
GAKKAKKRFSFKKSFKLSGFSFKKNKKE

SEQ ID NO: 349 - protein, 27 aa, Artificial Sequence
  Scaffold Y Sequence
GAKKAKKRFSFKKSFKLSGFSFKKNKK

SEQ ID NO: 350 - protein, 26 aa, Artificial Sequence
  Scaffold Y Sequence
GAKKAKKRFSFKKSFKLSGFSFKKNK

SEQ ID NO: 351 - protein, 25 aa, Artificial Sequence
  Scaffold Y Sequence
GAKKAKKRFSFKKSFKLSGFSFKKN

SEQ ID NO: 352 - protein, 24 aa, Artificial Sequence
  Scaffold Y Sequence
GAKKAKKRFSFKKSFKLSGFSFKK

SEQ ID NO: 353 - protein, 23 aa, Artificial Sequence
  Scaffold Y Sequence
GAKKAKKRFSFKKSFKLSGFSFK

SEQ ID NO: 354 - protein, 22 aa, Artificial Sequence
  Scaffold Y Sequence
GAKKAKKRFSFKKSFKLSGFSF

SEQ ID NO: 355 - protein, 21 aa, Artificial Sequence
  Scaffold Y Sequence
GAKKAKKRFSFKKSFKLSGFS

SEQ ID NO: 356 - protein, 20 aa, Artificial Sequence
  Scaffold Y Sequence
GAKKAKKRFSFKKSFKLSGF

SEQ ID NO: 357 - protein, 19 aa, Artificial Sequence
  Scaffold Y Sequence
GAKKAKKRFSFKKSFKLSG

SEQ ID NO: 358 - protein, 18 aa, Artificial Sequence
  Scaffold Y Sequence
GAKKAKKRFSFKKSFKLS

SEQ ID NO: 359 - protein, 17 aa, Artificial Sequence
  Scaffold Y Sequence
GAKKAKKRFSFKKSFKL

SEQ ID NO: 360 - protein, 16 aa, Artificial Sequence
  Scaffold Y Sequence
GAKKAKKRFSFKKSFK

SEQ ID NO: 361 - protein, 15 aa, Artificial Sequence
  Scaffold Y Sequence
GAKKAKKRFSFKKSF

SEQ ID NO: 362 - protein, 14 aa, Artificial Sequence
  Scaffold Y Sequence
GAKKAKKRFSFKKS

SEQ ID NO: 363 - protein, 13 aa, Artificial Sequence
  Scaffold Y Sequence
GAKKAKKRFSFKK

SEQ ID NO: 364 - protein, 12 aa, Artificial Sequence
  Scaffold Y Sequence
GAKKAKKRFSFK

SEQ ID NO: 365 - protein, 11 aa, Artificial Sequence
  Scaffold Y Sequence
GAKKAKKRFSF

SEQ ID NO: 366 - protein, 10 aa, Artificial Sequence
  Scaffold Y Sequence
GAKKAKKRFS

SEQ ID NO: 367 - protein, 9 aa, Artificial Sequence
  Scaffold Y Sequence
GAKKAKKRF

SEQ ID NO: 368 - protein, 8 aa, Artificial Sequence
  Scaffold Y Sequence
GAKKAKKR

SEQ ID NO: 369 - protein, 7 aa, Artificial Sequence
  Scaffold Y Sequence
GAKKAKK

SEQ ID NO: 370 - protein, 94 aa, Artificial Sequence
  ESAT6 Protein Sequence
MTEQQWNFAGIEAAASAIQGNVTSIHSLDEGKQSLTKLAAAWGGSGSEAYQGVQQKWDATATELNNALQNLARTISEAGQAMASTEGNVTGMFA

SEQ ID NO: 371 - protein, 96 aa, Artificial Sequence
  TB10.4 Protein Sequence
MSQIMYNYPAMLGHAGDMAGYAGTLQSLGAEIAVEQAALQSAWQGDTGITYQAWQAQWNQAMEDLVRAYHAMSSTHEANTMAMMARDTAEAAKWGG

SEQ ID NO: 372 - protein, 8 aa, Artificial Sequence
  Scaffold Y Sequence
  VARIANT (2)..(2): Xaa can be any naturally occurring amino acid
GXKLSKKK

SEQ ID NO: 373 - protein, 400 aa, Artificial Sequence
  Linker
  MISC_FEATURE (1)..(400): This sequence may encompass 1-100 “GGGG” repeating units.
GGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGG

SEQ ID NO: 374 - protein, 10100 aa, Artificial Sequence
  Linker
  misc_Feature (1)..(10100): This sequence may encompass 1-100 “G100-S” repeating units, which then may repeat 1-100 times.
GGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGSGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGS

SEQ ID NO: 375 - protein, 250 aa, Artificial Sequence
  Linker
  MISC_FEATURE (1)..(250): This sequence may encompass 1-50 “G-S” repeating units, where G may repeat 1 to 4 times and S may be present or absent.
GGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGSGGGGS

SEQ ID NO: 376 - protein, 100 aa, Artificial Sequence
  Linker
  misc_feature (1)..(100): This sequence may encompass 1-100 “G” repeating units
GGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGGG

SEQ ID NO: 377 - protein, 200 aa, Artificial Sequence
  Synthetic
  MISC_FEATURE (1)..(200): This sequence may encompass 1-100 “GA” repeating units
GAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGAGA

SEQ ID NO: 378 - protein, 300 aa, Artificial Sequence
  Linker
  misc_feature (1)..(300): This sequence may encompass 1-100 “GGS” repeating units
GGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGSGGS

SEQ ID NO: 379 - protein, 28 aa, Artificial Sequence
  Lama4 Peptide
QKISFFDGFEVGFNFRTLQPNGLLFYYT

SEQ ID NO: 380 - protein, 23 aa, Artificial Sequence
  Itgb1 Peptide
WFYFTYSVNGYNEAIVHVVETPD